(19) United States
(12) Patent Application Publication
(10) Pub. No.: US 2007/0082402 A1
(43) Pub. Date: Apr. 12, 2007

(54) Device and process for the quantitative evaluation of the polypeptides and markers contained in a sample of body fluid for recognizing pathological conditions

(76) Inventors: Harald Mischak, Sehnde (DE); Stefan Wittke, Hannover (DE); Thorsten Kaiser, Hannover (DE)

Correspondence Address: WOOD, HERRON & EVANS, LLP, 2700 CAREW TOWER, 441 VINE STREET, CINCINNATI, OH, 45202, US

(21) Appl. No.: 10/570,708

(22) PCT Filed: Sep. 3, 2004
(86) PCT No.: PCT/EP04/09833

§ 371 Date: Nov. 14, 2006

(30) Foreign Application Priority Data
Sep. 6, 2003 (DE) 103 41 193.3

(51) Int. Cl. G01N 24/00

(52) U.S. Cl. 436/86; 436/173

(57) ABSTRACT

Devices and processes for the quantitative evaluation of the polypeptides contained in a sample of body fluid and markers for recognizing pathological conditions are described. The polypeptides are compared with reference values stored in a data base. These reference values are stored as data records of polypeptides relevant to the condition, which respectively comprise at least some information about the probability of the occurrence and/or the concentration of the polypeptides for a pathological condition in samples of healthy and diseased subjects.

The invention relates to devices and processes for the quantitative evaluation of the polypeptides contained in a sample of body fluid and comparison with reference values stored in a data base as well as of markers for recognizing pathological conditions.

From DE 100 21 737 C2, a process and a device for the qualitative and/or quantitative determination of a protein and/or polypeptide pattern of a liquid sample have been known. Proteins arid/or polypeptides of a liquid sample are separated by means of capillary electrophoresis, then directly ionized and transferred through an interface to an on-line coupled mass spectrometer for detection.

For monitoring the state of a human or animal body over an extended period, reference and sample values describing this state as well as deviations and correspondences derived therefrom are automatically stored in a data base, and when the protein and/or peptide pattern is again determined, a search for optimum correspondence is automatically performed.

It has been found that very reliable statements about conditions of the human and animal body are already possible with the polypeptide patterns acquired to date. They can supplement or replace the previously usual examination and diagnostic methods. Especially for diabetes and diabetic nephropathy, extensive reference and sample values for the determination of polypeptide patterns have been obtained in the meantime.

Diabetes is often a precursor of diabetic nephropathy, which can develop over years and decades. Diabetic nephropathy proceeds through several stages. An early diagnosis of diabetic nephropathy is hardly possible with the presently available means, and it is only possible with great expenditure and only at a relatively late time.

A diagnosis in good time and persistent therapy of manifest nephropathy would not only prevent or delay obligatory dialysis, but also lower the high cardiovascular risk in the patient suffering from diabetes.

It has been found that polypeptide patterns of a liquid sample, e.g., urine, enable a diagnosis already in an early stage of the disease. Further examinations show that the diagnosis of diseases other than the above mentioned diabetes and diabetic nephropathy is also possible through polypeptide patterns.

It is the object of the invention to provide a definition of the polypeptides suitable for computer-aided storage and evaluation in a device and a process for the quantitative evaluation of the polypeptides contained in a sample of body fluid and comparison with reference values stored in a data base.

This object is achieved in a device for the quantitative evaluation of the polypeptides contained in a sample of body fluid and comparison with reference values stored in a data base, characterized in that said reference values are stored as data records of polypeptides relevant to the condition, which respectively comprise at least some information about the probability of the occurrence and/or the concentration of the polypeptides for a pathological condition in samples of healthy and diseased subjects, and in a process for the quantitative evaluation of the polypeptides contained in a sample of body fluid and comparison with reference values stored in a data base, characterized in that said reference values are employed for the comparison as data records of polypeptides relevant to the condition by comparing a value about the probability of the occurrence and/or the concentration of the polypeptides in the sample of body fluid with at least one reference value about the probability of the occurrence and/or the concentration of the polypeptides for a pathological condition in samples of healthy and diseased subjects.

A further object of the invention is to provide a marker for recognizing pathological conditions through a definition of the polypeptides contained which is suitable for storage and evaluation.

This object is achieved with a marker for recognizing pathological conditions, characterized by a plurality of polypeptides relevant to the condition which are respectively linked with a piece of information about the probability of the occurrence and/or the concentration of the polypeptide for a pathological condition in samples of healthy and diseased subjects.

Further developments and advantageous embodiments can be seen from the respective dependent claims.

In the invention, data for those polypeptides whose concentration in the body fluid is clearly changed in a pathological condition as compared to a normal condition are evaluated. In preliminary studies, such polypeptides may be established with a large number of subjects.

Each polypeptide is linked with pieces of information which comprise, for a pathological state, information about the probability of the occurrence and/or the concentration in healthy and diseased subjects.

When the polypeptides from liquid samples are compared with reference values, an assignment is found for each polypeptide compared of the liquid sample in terms of whether its occurrence and/or concentration represents a healthy or disease condition. By comparing a multitude of polypeptides, a bias of the overall result by a few individual deviations from the typical occurrence probability and concentrations can be reduced or avoided.

According to a further embodiment, the polypeptides can also be defined by stating their related mass and their related retention time in capillary electrophoresis.

Thus, the data of capillary electrophoresis and mass spectrometry are directly adopted. These data are different for all polypeptides, but unambiguous, so that the data are sufficient for definition. For example, the retention time in capillary electrophoresis can be determined by capillary electrophoresis using a glass capillary having a length of 90 cm and an inner diameter (ID) of 75 μm and an outer diameter (OD) of 360 μm at a voltage of 30 kV, wherein 30% methanol, 0.5% formic acid in water is used as a solvent for the sample.

For the diagnosis “diabetes” and “kidney damage”, special data records of polypeptides relevant to the condition have been summarized in a data base which was established and confirmed by using urine samples from a multitude of subjects. Individual polypeptides, a combination of polypeptides or all polypeptides can be compared.

Since the representativeness of many polypeptides for a healthy and pathological condition is redundant, a comparison of only one of these polypeptides could be sufficient in the simplest case. However, in order to eliminate errors from statistical uncertainties or individual deviations, the comparison of a combination of the polypeptides relevant to the condition is to be sought. An optimum result is achieved if all the polypeptides listed are compared.

These polypeptides serving as markers may also potentially be therapeutic targets. Thus, it is possible to develop therapeutical agents of which these polypeptides are either the basis or the target structure. Thus, the occurrence and/or the concentration of the polypeptides are respectively changed by supplementation and/or antibodies in the body in such a way that their concentration in the body fluid examined again takes normal values.

In the following, the invention is illustrated by means of the drawings in which:

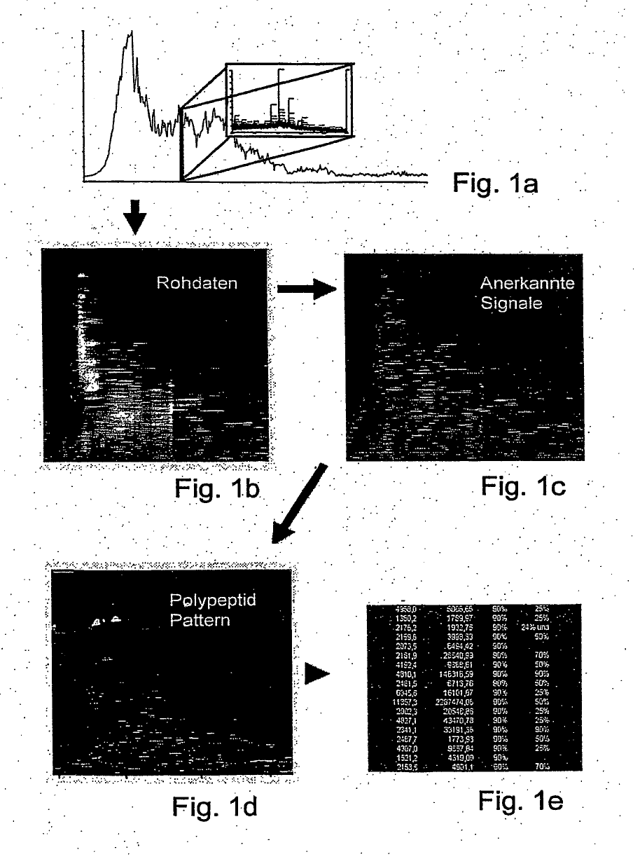

FIG. 1 shows graphical representations of individual intermediate steps in the data acquisition for defining the polypeptide patterns;

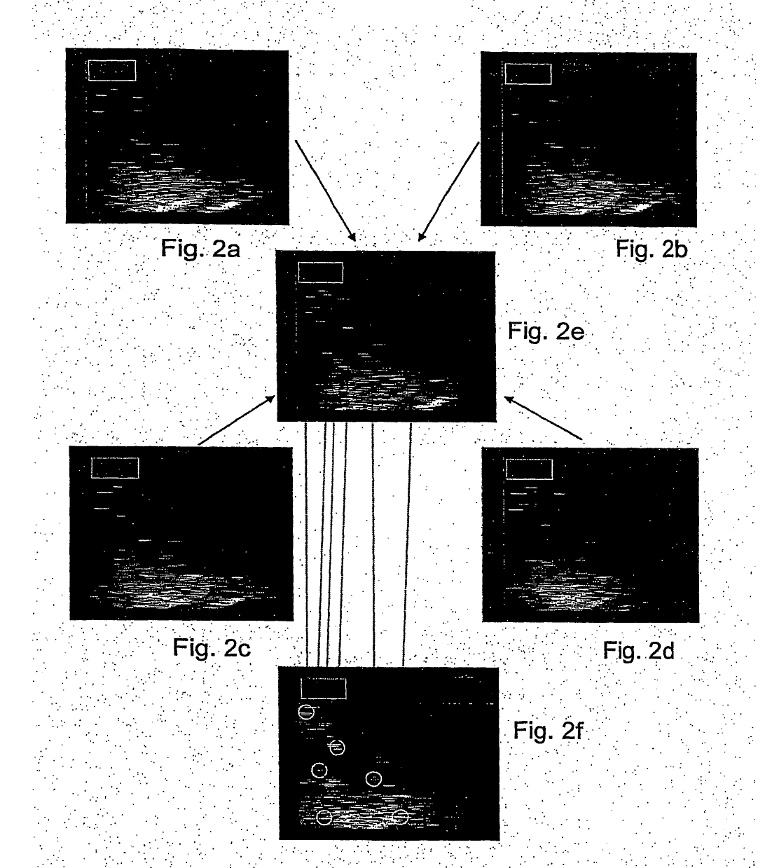

FIG. 2 shows graphical representations of polypeptide patterns and their interrelationship.

In the Example of the invention, the presence as well as the concentration of a large number of polypeptides in the urine are analyzed. Currently, this is done by using capillary electrophoresis coupled to a mass spectrometer (CE-MS), but may also be done selectively by other methods.

The results of the CE-MS measurement symbolized by the graph in FIG. 1a lead to a polypeptide pattern of typically 500-1500 polypeptides after preparing a three-dimensional representation by plotting the retention time on the x axis, the mass on the y axis and the signal amplitude on the z axis. FIG. 1b shows the representation of the “raw data” from which relevant signals, referred to as “acknowledged signals” in FIG. 1c, are first filtered out by means of a filtering and evaluation software, followed by calculating a polypeptide pattern, referred to as “polypeptide pattern” in FIG. 1d. The polypeptides are annotated/identified in the CE by their mass and retention time. Their concentration is calculated through the amplitude of the signal.

The data forming the polypeptide pattern are filed in a data base. The pieces of information necessary for the unambiguous identification are stored in a separate data record for each relevant polypeptide. FIG. 1e symbolically shows a screen display of several data records.

To recognize the essential polypeptides, urine from patients with and without diagnosed diabetic nephropathy or with and without diagnosed diabetes is examined by means of CE-MS.

From the data base comparison of over 50 measurements, a typical polypeptide pattern of subjects with healthy kidneys could be established. With the same technology, urine samples from over 200 patients with diabetes type I and type II were measured. These patients represent collectives of different stages of kidney diseases, from completely non-pathological to values of over 3 g of protein/day in the urine.

For analyzing the data, the patients were divided into four groups as shown in the following Table.

| | Number of | | Classification | Classification |
|---|---|---|---|---|
| Group | subjects | Type | diabetes | nephropathy |
| K0 | 60 | healthy subjects, no diabetes | “healthy” | “healthy” |
| | | diagnosed, no proteinuria | | |
| P0 | 120 | diagnosed diabetes, no proteinuria | “diseased” | |
| P1 | 61 | diagnosed diabetes, increased | | “diseased” |
| | | protein content in the urine | | |
| P2 | 23 | diagnosed diabetes, highly | | |
| | | increased protein content in the | | |
| | | urine (signs of nephropathy) | | |

From the collected polypeptide patterns of an examination group, a group-specific polypeptide pattern is developed. The thus obtained polypeptide patterns show typical deviations from the normal samples, i.e., changes in individual polypeptides. For illustration, graphical representations of the group-specific polypeptide patterns according to the Table are shown in FIG. 2.

The polypeptide patterns of groups K0, P0, P1 and P2 are represented in FIGS. 2a, 2b, 2c and 2d, respectively. From the polypeptide patterns of groups K0, P0, P1 and P2, a synthetic overall picture is composed, which is then used for establishing a polypeptide pattern according to FIG. 2e as a marker profile.

For searching for relevant markers, only those polypeptides are recurred to which could be found in at least one of the groups in a relevant number, of more then 40% in this case. Subsequently, those polypeptides were considered which enabled a distinction to be made between the classes “healthy” and “diseased”. It was taken care that there was a consistent development over the groups.

The changes in the polypeptide pattern are in part due to the basic disease diabetes and thus can be found uniformly in all diabetes patients, and in part due to or even the cause of a beginning/progressing nephropathy. Thus, these polypeptides can be employed as markers for the diagnosis of diabetes or diabetic nephropathy.

The polypeptides present therein are subsequently searched for in the examined patient samples, whereupon their presence or absence is used for making a diagnosis as shown in FIG. 2f.

The following Table summarizes the particularly relevant marker polypeptides as found within the scope of the recognition of a diabetic nephropathy. The polypeptides mentioned here serve for the recognition of the disease in an early stage and can be used singly, in subsets or in a complete combination.

The list contains 380 polypeptides defined by their mass and their retention time in capillary electrophoresis. The continuous numbers from 1 to 157 represent the marker peptides used for the diagnosis “diabetes”. The continuous numbers from 158 to 380 include the marker peptides employed for the diagnosis “kidney damage”. Within these two groups, the polypeptides are sorted first by the criterion of whether it is a “positive” polypeptide, i.e., one which is increased in the case of disease, or a “negative” one. Subsequently, the polypeptides are sorted by their masses in ascending order.

In the following Table, the individual columns have the following meanings:

| | |
|---|---|
| No. | continuous number |
| ID | internal identification number |
| Time | CE time in minutes and standard deviation |
| Mass | Polypeptide mass in Daltons and standard deviation |
| % healthy | percent occurrence in the “healthy” class |
| % diseased | percent occurrence in the “diseased” class |
| Type | Behavior of the marker in a pathological state: |
| | positive: The marker occurs with a higher probability in the |
| | “diseased” condition as compared to the “healthy” |
| | condition. |
| | negative: The marker occurs with a lower probability in the |
| | “diseased” condition as compared to the “healthy” |
| | condition. |

| No. | ID | Time [min] | Mass [Da] | % healthy | % diseased | Type |
|---|---|---|---|---|---|---|
| 1 | 36 | 22.9 ± 3.05 | 834.5 ± 0.10 | 3% | 54% | Diabetes positive |
| 2 | 73 | 22.9 ± 3.03 | 869.4 ± 0.17 | 14% | 63% | Diabetes positive |
| 3 | 2295 | 24.2 ± 1.89 | 874.5 ± 0.09 | 28% | 66% | Diabetes positive |
| 4 | 109 | 22.2 ± 2.19 | 907.5 ± 0.13 | 0% | 41% | Diabetes positive |
| 5 | 122 | 29.0 ± 2.35 | 910.5 ± 0.09 | 15% | 47% | Diabetes positive |
| 6 | 150 | 22.9 ± 3.18 | 947.6 ± 0.22 | 17% | 51% | Diabetes positive |
| 7 | 165 | 26.8 ± 2.98 | 950.5 ± 0.12 | 0% | 24% | Diabetes positive |
| 8 | 215 | 23.2 ± 4.87 | 995.6 ± 0.14 | 23% | 50% | Diabetes positive |
| 9 | 287 | 27.4 ± 3.59 | 1082.6 ± 0.16 | 0% | 44% | Diabetes positive |
| 10 | 301 | 32.3 ± 1.99 | 1096.5 ± 0.14 | 10% | 51% | Diabetes positive |
| 11 | 381 | 26.8 ± 3.85 | 1176.6 ± 0.13 | 21% | 59% | Diabetes positive |
| 12 | 2598 | 22.3 ± 3.45 | 1222.8 ± 0.22 | 17% | 56% | Diabetes positive |
| 13 | 438 | 30.6 ± 3.31 | 1236.6 ± 0.11 | 24% | 59% | Diabetes positive |
| 14 | 4246 | 52.6 ± 4.80 | 1285.0 ± 0.09 | 14% | 54% | Diabetes positive |
| 15 | 543 | 28.8 ± 3.98 | 1332.7 ± 0.20 | 23% | 55% | Diabetes positive |
| 16 | 4694 | 49.8 ± 4.72 | 1332.8 ± 0.16 | 8% | 38% | Diabetes positive |
| 17 | 544 | 26.7 ± 2.79 | 1355.8 ± 0.15 | 17% | 56% | Diabetes positive |
| 18 | 589 | 24.6 ± 2.84 | 1386.8 ± 0.14 | 53% | 77% | Diabetes positive |
| 19 | 602 | 26.8 ± 3.26 | 1403.7 ± 0.21 | 8% | 46% | Diabetes positive |
| 20 | 584 | 17.8 ± 4.12 | 1405.9 ± 0.15 | 14% | 56% | Diabetes positive |
| 21 | 635 | 31.5 ± 3.71 | 1442.7 ± 0.27 | 15% | 55% | Diabetes positive |
| 22 | 618 | 32.1 ± 3.38 | 1449.8 ± 0.14 | 41% | 85% | Diabetes positive |
| 23 | 722 | 31.3 ± 5.27 | 1592.4 ± 0.38 | 3% | 46% | Diabetes positive |
| 24 | 3234 | 43.4 ± 4.41 | 1783.4 ± 0.30 | 33% | 63% | Diabetes positive |
| 25 | 858 | 29.4 ± 3.08 | 1789.2 ± 0.39 | 28% | 75% | Diabetes positive |
| 26 | 3259 | 38.4 ± 1.09 | 1818.9 ± 0.21 | 28% | 67% | Diabetes positive |
| 27 | 3058 | 37.7 ± 1.04 | 1821.4 ± 0.39 | 14% | 56% | Diabetes positive |
| 28 | 882 | 24.4 ± 2.55 | 1829.2 ± 0.23 | 45% | 81% | Diabetes positive |
| 29 | 5462 | 51.1 ± 4.11 | 1854.7 ± 0.41 | 14% | 54% | Diabetes positive |
| 30 | 3281 | 37.6 ± 3.30 | 1856.8 ± 0.48 | 33% | 56% | Diabetes positive |
| 31 | 906 | 24.7 ± 2.63 | 1872.9 ± 0.35 | 43% | 72% | Diabetes positive |
| 32 | 930 | 28.3 ± 3.47 | 1949.5 ± 0.32 | 17% | 73% | Diabetes positive |
| 33 | 949 | 31.6 ± 2.90 | 1955.1 ± 0.32 | 55% | 79% | Diabetes positive |
| 34 | 957 | 31.3 ± 3.00 | 1971.0 ± 0.45 | 20% | 54% | Diabetes positive |
| 35 | 988 | 37.8 ± 2.40 | 2032.0 ± 0.30 | 25% | 60% | Diabetes positive |
| 36 | 1001 | 30.9 ± 4.69 | 2061.4 ± 0.58 | 10% | 38% | Diabetes positive |
| 37 | 1016 | 33.8 ± 3.76 | 2092.2 ± 0.46 | 18% | 45% | Diabetes positive |
| 38 | 1059 | 27.7 ± 4.43 | 2185.6 ± 0.46 | 10% | 36% | Diabetes positive |
| 39 | 3271 | 32.9 ± 1.48 | 2189.4 ± 0.34 | 14% | 54% | Diabetes positive |
| 40 | 3492 | 39.6 ± 5.31 | 2229.4 ± 0.48 | 5% | 39% | Diabetes positive |
| 41 | 1078 | 24.5 ± 5.14 | 2229.9 ± 0.33 | 25% | 63% | Diabetes positive |
| 42 | 1197 | 28.3 ± 3.30 | 2502.9 ± 0.56 | 20% | 48% | Diabetes positive |
| 43 | 1243 | 24.9 ± 4.84 | 2621.6 ± 0.97 | 20% | 45% | Diabetes positive |
| 44 | 3710 | 37.5 ± 4.52 | 2669.8 ± 0.39 | 23% | 67% | Diabetes positive |
| 45 | 5507 | 20.8 ± 4.47 | 2752.2 ± 0.76 | 35% | 64% | Diabetes positive |
| 46 | 1304 | 24.9 ± 4.31 | 2795.7 ± 0.96 | 13% | 40% | Diabetes positive |
| 47 | 5687 | 48.2 ± 3.61 | 3246.1 ± 0.43 | 0% | 30% | Diabetes positive |
| 48 | 1629 | 20.9 ± 3.33 | 3844.0 ± 0.52 | 3% | 54% | Diabetes positive |
| 49 | 1869 | 21.9 ± 2.62 | 4961.5 ± 0.89 | 10% | 40% | Diabetes positive |
| 50 | 1950 | 18.6 ± 2.91 | 5497.0 ± 0.66 | 18% | 42% | Diabetes positive |
| 51 | 12 | 20.4 ± 2.20 | 808.4 ± 0.10 | 58% | 9% | Diabetes negative |
| 52 | 108 | 45.3 ± 2.03 | 897.5 ± 0.09 | 48% | 7% | Diabetes negative |
| 53 | 143 | 31.4 ± 1.08 | 929.5 ± 0.11 | 98% | 46% | Diabetes negative |
| 54 | 2533 | 41.2 ± 1.41 | 946.4 ± 0.10 | 85% | 36% | Diabetes negative |
| 55 | 2565 | 28.0 ± 1.04 | 980.5 ± 0.07 | 85% | 31% | Diabetes negative |
| 56 | 220 | 26.7 ± 2.26 | 1000.5 ± 0.09 | 83% | 41% | Diabetes negative |
| 57 | 228 | 27.8 ± 1.51 | 1008.5 ± 0.10 | 95% | 41% | Diabetes negative |
| 58 | 232 | 29.3 ± 2.55 | 1012.5 ± 0.10 | 63% | 17% | Diabetes negative |
| 59 | 2627 | 43.6 ± 2.03 | 1047.5 ± 0.11 | 90% | 26% | Diabetes negative |
| 60 | 5947 | 25.0 ± 3.91 | 1052.6 ± 0.08 | 45% | 4% | Diabetes negative |
| 61 | 286 | 37.4 ± 5.63 | 1066.5 ± 0.14 | 58% | 13% | Diabetes negative |
| 62 | 295 | 22.8 ± 1.78 | 1075.5 ± 0.13 | 68% | 26% | Diabetes negative |
| 63 | 309 | 28.9 ± 3.89 | 1088.6 ± 0.15 | 65% | 21% | Diabetes negative |
| 64 | 2681 | 44.4 ± 2.06 | 1106.5 ± 0.11 | 80% | 18% | Diabetes negative |
| 65 | 328 | 34.1 ± 1.80 | 1107.5 ± 0.10 | 88% | 35% | Diabetes negative |
| 66 | 342 | 42.8 ± 3.26 | 1120.5 ± 0.06 | 60% | 14% | Diabetes negative |
| 67 | 356 | 29.1 ± 2.26 | 1134.6 ± 0.10 | 95% | 49% | Diabetes negative |
| 68 | 359 | 28.2 ± 3.00 | 1137.7 ± 0.11 | 70% | 24% | Diabetes negative |
| 69 | 344 | 45.5 ± 2.34 | 1139.5 ± 0.20 | 83% | 22% | Diabetes negative |
| 70 | 381 | 32.9 ± 1.25 | 1159.6 ± 0.11 | 80% | 27% | Diabetes negative |
| 71 | 401 | 23.3 ± 4.17 | 1180.5 ± 0.16 | 50% | 9% | Diabetes negative |
| 72 | 421 | 43.8 ± 2.08 | 1200.6 ± 0.11 | 95% | 50% | Diabetes negative |
| 73 | 425 | 27.2 ± 3.22 | 1204.6 ± 0.17 | 60% | 17% | Diabetes negative |
| 74 | 6860 | 44.9 ± 2.53 | 1209.5 ± 0.09 | 83% | 17% | Diabetes negative |
| 75 | 2793 | 47.8 ± 2.73 | 1224.6 ± 0.12 | 75% | 19% | Diabetes negative |
| 76 | 464 | 25.6 ± 2.43 | 1246.7 ± 0.15 | 73% | 30% | Diabetes negative |
| 77 | 2833 | 47.9 ± 2.66 | 1268.6 ± 0.09 | 68% | 25% | Diabetes negative |
| 78 | 2840 | 43.9 ± 1.80 | 1277.5 ± 0.10 | 70% | 28% | Diabetes negative |
| 79 | 2841 | 46.0 ± 2.69 | 1278.5 ± 0.09 | 58% | 10% | Diabetes negative |
| 80 | 2651 | 33.1 ± 1.82 | 1282.6 ± 0.13 | 62% | 7% | Diabetes negative |
| 81 | 2893 | 29.3 ± 3.88 | 1331.7 ± 0.18 | 65% | 12% | Diabetes negative |
| 82 | 2959 | 45.9 ± 4.78 | 1405.5 ± 0.33 | 93% | 45% | Diabetes negative |
| 83 | 620 | 44.4 ± 3.90 | 1423.6 ± 0.16 | 60% | 20% | Diabetes negative |
| 84 | 663 | 19.2 ± 3.40 | 1484.8 ± 0.19 | 68% | 13% | Diabetes negative |
| 85 | 3114 | 36.9 ± 2.02 | 1609.6 ± 0.13 | 85% | 13% | Diabetes negative |
| 86 | 3136 | 38.9 ± 3.78 | 1639.7 ± 0.27 | 63% | 19% | Diabetes negative |
| 87 | 769 | 33.2 ± 3.34 | 1662.9 ± 0.21 | 62% | 5% | Diabetes negative |
| 88 | 770 | 35.8 ± 2.19 | 1664.6 ± 0.29 | 66% | 10% | Diabetes negative |
| 89 | 785 | 36.2 ± 4.78 | 1666.6 ± 0.34 | 75% | 29% | Diabetes negative |
| 90 | 3165 | 35.9 ± 2.98 | 1678.1 ± 0.44 | 60% | 18% | Diabetes negative |
| 91 | 3192 | 37.3 ± 2.99 | 1716.8 ± 0.23 | 73% | 19% | Diabetes negative |
| 92 | 2988 | 46.5 ± 4.38 | 1717.5 ± 0.37 | 79% | 15% | Diabetes negative |
| 93 | 832 | 37.9 ± 4.18 | 1746.0 ± 0.33 | 83% | 34% | Diabetes negative |
| 94 | 3258 | 25.1 ± 2.25 | 1817.6 ± 0.27 | 65% | 8% | Diabetes negative |
| 95 | 878 | 34.2 ± 3.95 | 1823.4 ± 0.47 | 73% | 30% | Diabetes negative |
| 96 | 894 | 29.1 ± 3.59 | 1849.8 ± 0.30 | 100% | 56% | Diabetes negative |
| 97 | 3314 | 49.3 ± 4.49 | 1914.1 ± 0.36 | 88% | 38% | Diabetes negative |
| 98 | 3117 | 44.2 ± 4.23 | 1916.7 ± 0.33 | 69% | 10% | Diabetes negative |
| 99 | 3383 | 39.8 ± 2.19 | 2030.8 ± 0.35 | 93% | 38% | Diabetes negative |
| 100 | 5215 | 31.9 ± 1.61 | 2118.9 ± 0.21 | 73% | 14% | Diabetes negative |
| 101 | 1056 | 41.2 ± 2.45 | 2179.3 ± 0.42 | 58% | 17% | Diabetes negative |
| 102 | 5269 | 20.1 ± 2.78 | 2219.0 ± 0.26 | 53% | 13% | Diabetes negative |
| 103 | 1090 | 25.8 ± 2.70 | 2256.9 ± 0.47 | 85% | 26% | Diabetes negative |
| 104 | 3314 | 45.1 ± 5.23 | 2273.4 ± 0.42 | 79% | 22% | Diabetes negative |
| 105 | 3317 | 40.7 ± 1.90 | 2279.0 ± 0.33 | 90% | 20% | Diabetes negative |
| 106 | 1117 | 26.8 ± 3.73 | 2320.2 ± 0.55 | 78% | 34% | Diabetes negative |
| 107 | 1123 | 23.6 ± 3.10 | 2332.2 ± 0.35 | 53% | 11% | Diabetes negative |
| 108 | 1129 | 44.5 ± 3.08 | 2345.6 ± 0.46 | 75% | 34% | Diabetes negative |
| 109 | 1146 | 25.7 ± 5.16 | 2384.5 ± 0.63 | 65% | 21% | Diabetes negative |
| 110 | 3592 | 38.5 ± 3.62 | 2423.9 ± 0.41 | 88% | 29% | Diabetes negative |
| 111 | 3595 | 34.2 ± 2.92 | 2429.9 ± 0.51 | 65% | 18% | Diabetes negative |
| 112 | 3398 | 23.3 ± 2.54 | 2443.3 ± 0.46 | 66% | 5% | Diabetes negative |
| 113 | 3446 | 41.7 ± 3.72 | 2548.1 ± 0.57 | 69% | 15% | Diabetes negative |
| 114 | 1215 | 27.3 ± 4.77 | 2548.3 ± 0.66 | 83% | 35% | Diabetes negative |
| 115 | 5421 | 43.6 ± 2.08 | 2548.3 ± 0.23 | 95% | 41% | Diabetes negative |
| 116 | 1227 | 24.0 ± 3.11 | 2581.5 ± 0.47 | 60% | 13% | Diabetes negative |
| 117 | 1230 | 24.0 ± 2.70 | 2587.4 ± 0.40 | 80% | 26% | Diabetes negative |
| 118 | 1238 | 41.7 ± 3.06 | 2606.8 ± 0.55 | 78% | 35% | Diabetes negative |
| 119 | 1237 | 31.3 ± 4.92 | 2636.4 ± 0.48 | 72% | 12% | Diabetes negative |
| 120 | 1253 | 25.5 ± 3.62 | 2644.2 ± 0.41 | 88% | 33% | Diabetes negative |
| 121 | 1244 | 29.2 ± 1.07 | 2654.0 ± 0.37 | 66% | 0% | Diabetes negative |
| 122 | 1272 | 29.8 ± 3.50 | 2698.2 ± 0.63 | 90% | 29% | Diabetes negative |
| 123 | 1266 | 43.0 ± 2.26 | 2710.5 ± 0.37 | 79% | 5% | Diabetes negative |
| 124 | 3749 | 25.1 ± 1.64 | 2761.3 ± 0.35 | 88% | 44% | Diabetes negative |
| 125 | 1301 | 31.3 ± 2.79 | 2808.5 ± 0.56 | 79% | 22% | Diabetes negative |
| 126 | 1326 | 42.0 ± 3.22 | 2876.5 ± 0.48 | 62% | 7% | Diabetes negative |
| 127 | 1342 | 33.7 ± 3.34 | 2898.7 ± 0.50 | 85% | 43% | Diabetes negative |
| 128 | 3595 | 42.2 ± 2.68 | 2908.1 ± 0.53 | 72% | 17% | Diabetes negative |
| 129 | 3598 | 35.4 ± 2.63 | 2917.6 ± 0.58 | 72% | 12% | Diabetes negative |
| 130 | 3843 | 35.4 ± 0.77 | 2978.1 ± 0.49 | 85% | 35% | Diabetes negative |
| 131 | 3849 | 36.1 ± 1.42 | 2994.6 ± 0.80 | 83% | 24% | Diabetes negative |
| 132 | 1380 | 43.5 ± 2.99 | 3023.4 ± 0.65 | 93% | 34% | Diabetes negative |
| 133 | 1388 | 44.4 ± 3.35 | 3045.2 ± 0.61 | 69% | 12% | Diabetes negative |
| 134 | 1398 | 22.9 ± 3.47 | 3076.4 ± 0.96 | 66% | 7% | Diabetes negative |
| 135 | 1404 | 35.7 ± 1.99 | 3082.3 ± 0.43 | 73% | 22% | Diabetes negative |
| 136 | 1419 | 33.6 ± 3.53 | 3136.8 ± 0.61 | 95% | 47% | Diabetes negative |
| 137 | 1425 | 21.7 ± 3.14 | 3154.8 ± 0.44 | 55% | 10% | Diabetes negative |
| 138 | 1437 | 26.5 ± 1.92 | 3193.7 ± 0.53 | 78% | 32% | Diabetes negative |
| 139 | 1441 | 24.4 ± 3.02 | 3206.3 ± 0.72 | 66% | 7% | Diabetes negative |
| 140 | 1454 | 28.2 ± 2.80 | 3250.9 ± 0.71 | 63% | 18% | Diabetes negative |
| 141 | 1469 | 48.2 ± 3.46 | 3293.2 ± 0.74 | 93% | 39% | Diabetes negative |
| 142 | 1467 | 31.4 ± 1.60 | 3295.7 ± 0.33 | 95% | 40% | Diabetes negative |
| 143 | 1479 | 27.2 ± 3.58 | 3338.4 ± 0.79 | 80% | 34% | Diabetes negative |
| 144 | 1495 | 37.3 ± 2.11 | 3381.6 ± 0.63 | 78% | 26% | Diabetes negative |
| 145 | 1517 | 27.6 ± 2.49 | 3452.1 ± 0.49 | 58% | 15% | Diabetes negative |
| 146 | 1523 | 37.3 ± 1.50 | 3463.0 ± 0.83 | 72% | 15% | Diabetes negative |
| 147 | 1556 | 19.6 ± 2.89 | 3583.4 ± 0.75 | 79% | 20% | Diabetes negative |
| 148 | 1571 | 34.0 ± 2.55 | 3634.4 ± 0.74 | 86% | 29% | Diabetes negative |
| 149 | 4086 | 37.7 ± 2.61 | 3681.8 ± 1.38 | 55% | 14% | Diabetes negative |
| 150 | 1586 | 25.5 ± 2.25 | 3686.2 ± 0.60 | 86% | 20% | Diabetes negative |
| 151 | 1602 | 36.0 ± 3.89 | 3735.7 ± 0.57 | 70% | 28% | Diabetes negative |
| 152 | 1634 | 30.3 ± 1.58 | 3852.3 ± 0.56 | 83% | 41% | Diabetes negative |
| 153 | 3920 | 29.6 ± 1.46 | 4098.4 ± 0.59 | 93% | 20% | Diabetes negative |
| 154 | 1942 | 28.8 ± 1.18 | 5428.8 ± 0.67 | 70% | 19% | Diabetes negative |
| 155 | 1995 | 33.1 ± 0.69 | 6187.5 ± 1.13 | 83% | 10% | Diabetes negative |
| 156 | 4309 | 26.0 ± 4.82 | 6212.0 ± 1.41 | 75% | 26% | Diabetes negative |
| 157 | 2160 | 23.3 ± 2.19 | 9868.8 ± 1.33 | 66% | 0% | Diabetes negative |
| 158 | 32 | 21.7 ± 5.12 | 830.5 ± 0.11 | 4% | 40% | Nephropathy positive |
| 159 | 69 | 32.4 ± 1.83 | 866.4 ± 0.11 | 0% | 40% | Nephropathy positive |
| 160 | 111 | 30.6 ± 3.07 | 909.5 ± 0.13 | 11% | 40% | Nephropathy positive |
| 161 | 152 | 32.8 ± 3.14 | 937.5 ± 0.11 | 14% | 73% | Nephropathy positive |
| 162 | 155 | 24.9 ± 2.97 | 952.5 ± 0.16 | 11% | 40% | Nephropathy positive |
| 163 | 238 | 32.1 ± 2.44 | 1033.5 ± 0.11 | 5% | 40% | Nephropathy positive |
| 164 | 280 | 24.4 ± 2.87 | 1060.6 ± 0.16 | 17% | 68% | Nephropathy positive |
| 165 | 353 | 27.5 ± 2.86 | 1131.6 ± 0.16 | 20% | 68% | Nephropathy positive |
| 166 | 402 | 33.4 ± 3.48 | 1181.6 ± 0.15 | 22% | 73% | Nephropathy positive |
| 167 | 424 | 33.0 ± 2.52 | 1203.6 ± 0.14 | 9% | 50% | Nephropathy positive |
| 168 | 2586 | 26.5 ± 3.68 | 1211.6 ± 0.14 | 14% | 40% | Nephropathy positive |
| 169 | 2595 | 33.1 ± 0.91 | 1219.6 ± 0.15 | 18% | 40% | Nephropathy positive |
| 170 | 2601 | 32.8 ± 3.30 | 1225.6 ± 0.13 | 12% | 40% | Nephropathy positive |
| 171 | 510 | 30.7 ± 3.18 | 1297.7 ± 0.20 | 31% | 82% | Nephropathy positive |
| 172 | 526 | 34.1 ± 2.05 | 1333.7 ± 0.23 | 9% | 40% | Nephropathy positive |
| 173 | 2898 | 44.7 ± 4.06 | 1337.5 ± 0.20 | 19% | 59% | Nephropathy positive |
| 174 | 2955 | 27.9 ± 4.19 | 1398.8 ± 0.36 | 29% | 77% | Nephropathy positive |
| 175 | 2975 | 21.3 ± 5.08 | 1423.7 ± 0.49 | 6% | 50% | Nephropathy positive |
| 176 | 633 | 28.1 ± 4.95 | 1439.8 ± 0.19 | 19% | 68% | Nephropathy positive |
| 177 | 651 | 24.5 ± 2.42 | 1466.0 ± 0.27 | 9% | 77% | Nephropathy positive |
| 178 | 641 | 27.5 ± 4.93 | 1482.0 ± 0.42 | 33% | 40% | Nephropathy positive |
| 179 | 642 | 29.8 ± 4.43 | 1482.9 ± 0.28 | 18% | 40% | Nephropathy positive |
| 180 | 662 | 24.3 ± 2.65 | 1483.7 ± 0.28 | 26% | 91% | Nephropathy positive |
| 181 | 675 | 24.6 ± 1.98 | 1500.0 ± 0.20 | 38% | 86% | Nephropathy positive |
| 182 | 711 | 24.6 ± 2.90 | 1553.1 ± 0.28 | 14% | 64% | Nephropathy positive |
| 183 | 713 | 29.0 ± 4.83 | 1556.7 ± 0.45 | 26% | 73% | Nephropathy positive |
| 184 | 720 | 24.2 ± 2.48 | 1567.0 ± 0.22 | 26% | 86% | Nephropathy positive |
| 185 | 740 | 28.8 ± 4.53 | 1596.9 ± 0.31 | 21% | 86% | Nephropathy positive |
| 186 | 777 | 24.5 ± 2.43 | 1652.8 ± 0.25 | 14% | 59% | Nephropathy positive |
| 187 | 787 | 26.3 ± 2.63 | 1669.8 ± 0.37 | 20% | 64% | Nephropathy positive |
| 188 | 3200 | 33.1 ± 3.22 | 1729.2 ± 0.36 | 6% | 45% | Nephropathy positive |
| 189 | 3210 | 30.5 ± 4.11 | 1744.4 ± 0.46 | 16% | 59% | Nephropathy positive |
| 190 | 6963 | 25.1 ± 3.42 | 1754.4 ± 0.41 | 53% | 95% | Nephropathy positive |
| 191 | 3230 | 24.2 ± 1.56 | 1776.0 ± 0.27 | 9% | 50% | Nephropathy positive |
| 192 | 3036 | 18.5 ± 3.55 | 1791.0 ± 0.38 | 7% | 40% | Nephropathy positive |
| 193 | 843 | 32.2 ± 5.38 | 1792.9 ± 0.31 | 28% | 40% | Nephropathy positive |
| 194 | 3043 | 9.7 ± 2.54 | 1799.8 ± 0.29 | 0% | 40% | Nephropathy positive |
| 195 | 870 | 25.3 ± 2.89 | 1810.9 ± 0.38 | 43% | 91% | Nephropathy positive |
| 196 | 895 | 24.6 ± 2.34 | 1851.1 ± 0.21 | 43% | 95% | Nephropathy positive |
| 197 | 903 | 27.2 ± 4.46 | 1867.3 ± 0.42 | 38% | 91% | Nephropathy positive |
| 198 | 939 | 25.0 ± 3.97 | 1966.0 ± 0.53 | 16% | 40% | Nephropathy positive |
| 199 | 947 | 28.7 ± 3.08 | 1982.8 ± 0.57 | 11% | 40% | Nephropathy positive |
| 200 | 965 | 29.5 ± 5.53 | 1986.3 ± 0.36 | 15% | 64% | Nephropathy positive |
| 201 | 979 | 23.3 ± 4.46 | 2045.9 ± 0.32 | 32% | 40% | Nephropathy positive |
| 202 | 1013 | 33.7 ± 3.16 | 2115.1 ± 0.53 | 30% | 40% | Nephropathy positive |
| 203 | 3263 | 20.5 ± 2.78 | 2177.1 ± 0.37 | 9% | 40% | Nephropathy positive |
| 204 | 1083 | 18.1 ± 4.24 | 2241.6 ± 0.41 | 9% | 59% | Nephropathy positive |
| 205 | 1087 | 21.2 ± 2.49 | 2250.7 ± 0.38 | 23% | 64% | Nephropathy positive |
| 206 | 1091 | 27.5 ± 2.53 | 2258.7 ± 0.49 | 9% | 59% | Nephropathy positive |
| 207 | 1135 | 20.0 ± 3.30 | 2356.4 ± 0.41 | 13% | 59% | Nephropathy positive |
| 208 | 1149 | 28.1 ± 3.95 | 2391.4 ± 0.42 | 13% | 64% | Nephropathy positive |
| 209 | 1156 | 25.7 ± 4.85 | 2406.1 ± 0.57 | 20% | 77% | Nephropathy positive |
| 210 | 1163 | 22.8 ± 4.28 | 2423.2 ± 0.53 | 14% | 64% | Nephropathy positive |
| 211 | 1165 | 21.9 ± 4.45 | 2427.3 ± 0.40 | 31% | 91% | Nephropathy positive |
| 212 | 1182 | 19.2 ± 4.24 | 2465.1 ± 0.62 | 9% | 77% | Nephropathy positive |
| 213 | 5398 | 25.4 ± 5.25 | 2493.0 ± 0.38 | 9% | 50% | Nephropathy positive |
| 214 | 3627 | 19.5 ± 4.66 | 2494.0 ± 0.66 | 12% | 77% | Nephropathy positive |
| 215 | 5610 | 23.7 ± 4.27 | 2494.9 ± 0.49 | 7% | 40% | Nephropathy positive |
| 216 | 3640 | 24.4 ± 5.51 | 2522.0 ± 0.67 | 17% | 82% | Nephropathy positive |
| 217 | 1212 | 20.1 ± 3.61 | 2540.5 ± 0.54 | 14% | 68% | Nephropathy positive |
| 218 | 3673 | 22.3 ± 4.72 | 2593.5 ± 0.30 | 7% | 55% | Nephropathy positive |
| 219 | 1241 | 20.0 ± 4.87 | 2613.9 ± 0.83 | 14% | 55% | Nephropathy positive |
| 220 | 1272 | 35.1 ± 1.62 | 2726.5 ± 0.67 | 61% | 20% | Nephropathy positive |
| 221 | 1289 | 25.0 ± 4.39 | 2775.1 ± 0.56 | 12% | 40% | Nephropathy positive |
| 222 | 1303 | 21.8 ± 3.78 | 2790.7 ± 0.55 | 19% | 86% | Nephropathy positive |
| 223 | 1339 | 25.9 ± 3.30 | 2892.2 ± 0.50 | 9% | 50% | Nephropathy positive |
| 224 | 3819 | 16.8 ± 2.72 | 2919.0 ± 0.26 | 2% | 50% | Nephropathy positive |
| 225 | 1355 | 21.9 ± 3.23 | 2937.0 ± 0.49 | 13% | 86% | Nephropathy positive |
| 226 | 1362 | 20.0 ± 4.81 | 2958.8 ± 0.80 | 5% | 59% | Nephropathy positive |
| 227 | 1358 | 34.4 ± 2.72 | 2962.0 ± 0.54 | 12% | 20% | Nephropathy positive |
| 228 | 1393 | 28.9 ± 3.56 | 3059.7 ± 0.78 | 30% | 40% | Nephropathy positive |
| 229 | 1402 | 28.3 ± 5.96 | 3088.0 ± 0.79 | 7% | 20% | Nephropathy positive |
| 230 | 1494 | 26.1 ± 2.72 | 3369.2 ± 0.73 | 21% | 40% | Nephropathy positive |
| 231 | 1528 | 26.0 ± 2.89 | 3483.4 ± 0.95 | 30% | 40% | Nephropathy positive |
| 232 | 1719 | 24.5 ± 3.92 | 4183.3 ± 1.44 | 4% | 40% | Nephropathy positive |
| 233 | 1734 | 21.0 ± 5.35 | 4241.0 ± 0.62 | 29% | 73% | Nephropathy positive |
| 234 | 1761 | 23.4 ± 4.09 | 4370.2 ± 1.01 | 11% | 40% | Nephropathy positive |
| 235 | 1793 | 22.8 ± 2.94 | 4527.6 ± 0.67 | 1% | 45% | Nephropathy positive |
| 236 | 1825 | 21.7 ± 3.00 | 4713.6 ± 0.44 | 7% | 64% | Nephropathy positive |
| 237 | 2060 | 24.6 ± 3.73 | 7556.6 ± 1.55 | 2% | 40% | Nephropathy positive |
| 238 | 3994 | 16.7 ± 5.54 | 8055.1 ± 2.10 | 12% | 40% | Nephropathy positive |
| 239 | 2229 | 13.2 ± 5.19 | 8765.8 ± 0.96 | 37% | 82% | Nephropathy positive |
| 240 | 2252 | 15.3 ± 4.97 | 9181.0 ± 1.28 | 10% | 64% | Nephropathy positive |
| 241 | 2302 | 14.0 ± 4.20 | 10046.1 ± 0.96 | 21% | 77% | Nephropathy positive |
| 242 | 2180 | 18.7 ± 5.50 | 10208.0 ± 1.24 | 2% | 40% | Nephropathy positive |
| 243 | 2323 | 17.4 ± 4.02 | 10518.2 ± 1.10 | 23% | 64% | Nephropathy positive |
| 244 | 138 | 35.3 ± 5.04 | 924.5 ± 0.12 | 50% | 0% | Nephropathy negative |
| 245 | 142 | 43.1 ± 2.61 | 928.4 ± 0.08 | 65% | 14% | Nephropathy negative |
| 246 | 2541 | 45.7 ± 2.25 | 955.5 ± 0.14 | 60% | 5% | Nephropathy negative |
| 247 | 2594 | 23.8 ± 2.94 | 1010.6 ± 0.09 | 67% | 5% | Nephropathy negative |
| 248 | 248 | 31.2 ± 1.53 | 1028.5 ± 0.09 | 84% | 32% | Nephropathy negative |
| 249 | 2622 | 45.9 ± 2.27 | 1041.4 ± 0.10 | 57% | 0% | Nephropathy negative |
| 250 | 266 | 31.5 ± 1.98 | 1046.5 ± 0.09 | 87% | 32% | Nephropathy negative |
| 251 | 2440 | 43.4 ± 2.24 | 1047.5 ± 0.12 | 68% | 0% | Nephropathy negative |
| 252 | 2442 | 18.1 ± 4.34 | 1050.7 ± 0.12 | 60% | 0% | Nephropathy negative |
| 253 | 304 | 32.9 ± 3.03 | 1084.4 ± 0.11 | 69% | 18% | Nephropathy negative |
| 254 | 347 | 46.7 ± 2.63 | 1125.5 ± 0.12 | 63% | 9% | Nephropathy negative |
| 255 | 2731 | 46.3 ± 2.70 | 1157.5 ± 0.10 | 83% | 32% | Nephropathy negative |
| 256 | 2733 | 43.7 ± 1.70 | 1160.5 ± 0.07 | 72% | 18% | Nephropathy negative |
| 257 | 400 | 44.5 ± 3.67 | 1179.5 ± 0.09 | 97% | 36% | Nephropathy negative |
| 258 | 412 | 45.0 ± 2.24 | 1191.6 ± 0.09 | 60% | 9% | Nephropathy negative |
| 259 | 416 | 46.2 ± 2.59 | 1195.5 ± 0.10 | 98% | 32% | Nephropathy negative |
| 260 | 2575 | 44.2 ± 1.83 | 1200.6 ± 0.13 | 86% | 0% | Nephropathy negative |
| 261 | 442 | 45.9 ± 2.04 | 1223.5 ± 0.10 | 80% | 9% | Nephropathy negative |
| 262 | 441 | 44.5 ± 2.15 | 1239.6 ± 0.08 | 89% | 0% | Nephropathy negative |
| 263 | 2814 | 47.8 ± 3.08 | 1246.6 ± 0.11 | 60% | 5% | Nephropathy negative |
| 264 | 2821 | 46.8 ± 2.20 | 1254.7 ± 0.19 | 56% | 5% | Nephropathy negative |
| 265 | 478 | 43.2 ± 2.90 | 1261.5 ± 0.16 | 91% | 36% | Nephropathy negative |
| 266 | 479 | 48.6 ± 2.90 | 1262.5 ± 0.09 | 65% | 0% | Nephropathy negative |
| 267 | 476 | 43.9 ± 2.16 | 1277.6 ± 0.11 | 67% | 0% | Nephropathy negative |
| 268 | 502 | 36.7 ± 3.04 | 1288.7 ± 0.18 | 72% | 23% | Nephropathy negative |
| 269 | 2856 | 47.2 ± 3.17 | 1292.5 ± 0.14 | 67% | 18% | Nephropathy negative |
| 270 | 521 | 47.8 ± 2.58 | 1308.5 ± 0.09 | 66% | 0% | Nephropathy negative |
| 271 | 4687 | 48.2 ± 2.67 | 1321.6 ± 0.11 | 53% | 0% | Nephropathy negative |
| 272 | 533 | 34.8 ± 1.81 | 1321.7 ± 0.23 | 98% | 41% | Nephropathy negative |
| 273 | 559 | 46.0 ± 4.93 | 1351.7 ± 0.15 | 63% | 9% | Nephropathy negative |
| 274 | 2925 | 47.7 ± 2.99 | 1367.6 ± 0.14 | 97% | 23% | Nephropathy negative |
| 275 | 582 | 37.8 ± 2.93 | 1378.6 ± 0.16 | 87% | 36% | Nephropathy negative |
| 276 | 2946 | 47.5 ± 2.59 | 1389.7 ± 0.15 | 86% | 18% | Nephropathy negative |
| 277 | 2961 | 46.5 ± 2.28 | 1407.8 ± 0.20 | 79% | 9% | Nephropathy negative |
| 278 | 2768 | 44.6 ± 4.84 | 1422.1 ± 0.33 | 70% | 0% | Nephropathy negative |
| 279 | 598 | 45.4 ± 3.62 | 1423.8 ± 0.19 | 75% | 0% | Nephropathy negative |
| 280 | 2976 | 48.0 ± 2.97 | 1424.7 ± 0.16 | 95% | 18% | Nephropathy negative |
| 281 | 638 | 47.6 ± 3.40 | 1446.7 ± 0.16 | 92% | 23% | Nephropathy negative |
| 282 | 2998 | 46.5 ± 2.95 | 1450.4 ± 0.25 | 62% | 9% | Nephropathy negative |
| 283 | 3008 | 48.0 ± 2.95 | 1462.6 ± 0.17 | 97% | 9% | Nephropathy negative |
| 284 | 665 | 35.7 ± 1.90 | 1487.7 ± 0.15 | 70% | 18% | Nephropathy negative |
| 285 | 3031 | 47.8 ± 2.35 | 1490.6 ± 0.12 | 72% | 9% | Nephropathy negative |
| 286 | 3032 | 49.2 ± 2.77 | 1491.7 ± 0.12 | 81% | 14% | Nephropathy negative |
| 287 | 3043 | 49.0 ± 3.14 | 1507.8 ± 0.17 | 99% | 32% | Nephropathy negative |
| 288 | 3055 | 49.2 ± 2.86 | 1523.7 ± 0.11 | 97% | 18% | Nephropathy negative |
| 289 | 3059 | 48.6 ± 2.70 | 1529.7 ± 0.19 | 83% | 9% | Nephropathy negative |
| 290 | 3065 | 49.2 ± 3.26 | 1539.7 ± 0.19 | 98% | 23% | Nephropathy negative |
| 291 | 3070 | 49.0 ± 3.19 | 1545.7 ± 0.13 | 99% | 23% | Nephropathy negative |
| 292 | 3081 | 49.8 ± 2.76 | 1561.6 ± 0.19 | 90% | 18% | Nephropathy negative |
| 293 | 3085 | 48.4 ± 3.12 | 1567.7 ± 0.20 | 65% | 9% | Nephropathy negative |
| 294 | 3089 | 48.1 ± 2.66 | 1573.7 ± 0.27 | 63% | 5% | Nephropathy negative |
| 295 | 3092 | 48.5 ± 4.03 | 1577.8 ± 0.35 | 94% | 9% | Nephropathy negative |
| 296 | 2900 | 50.6 ± 3.40 | 1587.1 ± 0.34 | 65% | 0% | Nephropathy negative |
| 297 | 735 | 48.6 ± 2.68 | 1589.7 ± 0.14 | 86% | 18% | Nephropathy negative |
| 298 | 736 | 45.9 ± 3.83 | 1591.7 ± 0.30 | 79% | 18% | Nephropathy negative |
| 299 | 3105 | 49.3 ± 3.22 | 1594.8 ± 0.14 | 88% | 14% | Nephropathy negative |
| 300 | 3111 | 48.8 ± 2.78 | 1605.7 ± 0.13 | 73% | 18% | Nephropathy negative |
| 301 | 750 | 48.5 ± 2.81 | 1611.7 ± 0.14 | 73% | 5% | Nephropathy negative |
| 302 | 3134 | 46.3 ± 5.12 | 1636.4 ± 0.39 | 79% | 23% | Nephropathy negative |
| 303 | 3145 | 49.5 ± 3.37 | 1651.8 ± 0.19 | 99% | 23% | Nephropathy negative |
| 304 | 780 | 45.2 ± 5.96 | 1657.7 ± 0.23 | 60% | 5% | Nephropathy negative |
| 305 | 790 | 49.5 ± 3.33 | 1673.8 ± 0.14 | 95% | 23% | Nephropathy negative |
| 306 | 2969 | 49.6 ± 3.05 | 1689.8 ± 0.18 | 86% | 0% | Nephropathy negative |
| 307 | 810 | 26.9 ± 3.18 | 1706.8 ± 0.30 | 78% | 27% | Nephropathy negative |
| 308 | 3203 | 49.4 ± 2.84 | 1734.4 ± 0.40 | 65% | 5% | Nephropathy negative |
| 309 | 4983 | 49.2 ± 3.17 | 1739.7 ± 0.22 | 59% | 5% | Nephropathy negative |
| 310 | 3212 | 45.1 ± 4.21 | 1748.0 ± 0.28 | 55% | 5% | Nephropathy negative |
| 311 | 5032 | 44.2 ± 4.71 | 1813.6 ± 0.38 | 58% | 5% | Nephropathy negative |
| 312 | 874 | 39.1 ± 3.48 | 1817.0 ± 0.29 | 85% | 18% | Nephropathy negative |
| 313 | 3272 | 51.7 ± 3.48 | 1841.0 ± 0.23 | 59% | 9% | Nephropathy negative |
| 314 | 3277 | 50.4 ± 4.56 | 1848.2 ± 0.43 | 58% | 0% | Nephropathy negative |
| 315 | 5059 | 51.5 ± 2.94 | 1856.8 ± 0.24 | 59% | 5% | Nephropathy negative |
| 316 | 3285 | 52.7 ± 4.24 | 1863.8 ± 0.31 | 88% | 14% | Nephropathy negative |
| 317 | 914 | 52.7 ± 3.92 | 1885.8 ± 0.20 | 70% | 5% | Nephropathy negative |
| 318 | 3108 | 47.7 ± 4.69 | 1902.1 ± 0.33 | 75% | 0% | Nephropathy negative |
| 319 | 3120 | 50.6 ± 3.95 | 1924.0 ± 0.48 | 68% | 0% | Nephropathy negative |
| 320 | 981 | 26.6 ± 1.76 | 2048.5 ± 0.44 | 86% | 20% | Nephropathy negative |
| 321 | 3415 | 25.8 ± 1.39 | 2085.9 ± 0.24 | 83% | 32% | Nephropathy negative |
| 322 | 3416 | 39.9 ± 1.45 | 2087.8 ± 0.34 | 72% | 23% | Nephropathy negative |
| 323 | 5214 | 52.8 ± 4.09 | 2117.1 ± 0.17 | 78% | 9% | Nephropathy negative |
| 324 | 1020 | 28.3 ± 3.90 | 2129.7 ± 0.42 | 63% | 0% | Nephropathy negative |
| 325 | 3456 | 40.4 ± 1.53 | 2158.9 ± 0.26 | 86% | 32% | Nephropathy negative |
| 326 | 3465 | 39.7 ± 1.71 | 2174.9 ± 0.36 | 97% | 45% | Nephropathy negative |
| 327 | 3491 | 32.6 ± 1.79 | 2227.1 ± 0.41 | 81% | 23% | Nephropathy negative |
| 328 | 1086 | 29.3 ± 3.50 | 2249.0 ± 0.41 | 92% | 41% | Nephropathy negative |
| 329 | 3506 | 40.6 ± 1.25 | 2257.1 ± 0.35 | 94% | 45% | Nephropathy negative |
| 330 | 1097 | 46.2 ± 5.11 | 2273.5 ± 0.38 | 71% | 18% | Nephropathy negative |
| 331 | 1094 | 40.8 ± 2.66 | 2296.0 ± 0.40 | 63% | 20% | Nephropathy negative |
| 332 | 1121 | 40.9 ± 3.32 | 2327.6 ± 0.52 | 85% | 36% | Nephropathy negative |
| 333 | 3551 | 41.8 ± 2.45 | 2343.3 ± 0.43 | 77% | 27% | Nephropathy negative |
| 334 | 3574 | 40.8 ± 1.31 | 2385.3 ± 0.32 | 95% | 45% | Nephropathy negative |
| 335 | 1185 | 40.9 ± 2.68 | 2471.5 ± 0.52 | 69% | 14% | Nephropathy negative |
| 336 | 1193 | 41.5 ± 2.64 | 2493.5 ± 0.48 | 74% | 18% | Nephropathy negative |
| 337 | 5432 | 52.9 ± 3.98 | 2570.4 ± 0.27 | 71% | 5% | Nephropathy negative |
| 338 | 3697 | 34.1 ± 0.72 | 2642.8 ± 0.40 | 86% | 36% | Nephropathy negative |
| 339 | 1268 | 36.1 ± 2.56 | 2687.1 ± 0.49 | 84% | 23% | Nephropathy negative |
| 340 | 1276 | 42.8 ± 2.33 | 2710.6 ± 0.46 | 88% | 18% | Nephropathy negative |
| 341 | 5506 | 50.6 ± 4.73 | 2748.6 ± 0.36 | 64% | 0% | Nephropathy negative |
| 342 | 1371 | 37.8 ± 1.92 | 2986.6 ± 0.55 | 74% | 23% | Nephropathy negative |
| 343 | 1379 | 23.3 ± 2.07 | 3007.4 ± 0.50 | 65% | 9% | Nephropathy negative |
| 344 | 1385 | 25.9 ± 2.35 | 3038.3 ± 0.70 | 46% | 0% | Nephropathy negative |
| 345 | 3868 | 46.0 ± 2.91 | 3045.4 ± 0.36 | 59% | 5% | Nephropathy negative |
| 346 | 5624 | 53.3 ± 4.05 | 3057.2 ± 0.64 | 76% | 9% | Nephropathy negative |
| 347 | 1411 | 38.9 ± 2.57 | 3109.0 ± 0.57 | 88% | 14% | Nephropathy negative |
| 348 | 1435 | 41.9 ± 3.55 | 3187.6 ± 0.47 | 71% | 14% | Nephropathy negative |
| 349 | 1437 | 26.6 ± 1.15 | 3193.6 ± 0.41 | 61% | 0% | Nephropathy negative |
| 350 | 5681 | 48.3 ± 3.69 | 3223.8 ± 0.41 | 88% | 18% | Nephropathy negative |
| 351 | 1458 | 31.7 ± 3.65 | 3265.1 ± 0.64 | 93% | 41% | Nephropathy negative |
| 352 | 1465 | 29.5 ± 1.76 | 3291.0 ± 0.52 | 81% | 23% | Nephropathy negative |
| 353 | 1466 | 49.2 ± 3.70 | 3293.1 ± 0.43 | 91% | 14% | Nephropathy negative |
| 354 | 3968 | 49.9 ± 3.57 | 3315.0 ± 0.45 | 67% | 5% | Nephropathy negative |
| 355 | 3969 | 43.3 ± 2.04 | 3319.9 ± 0.66 | 86% | 23% | Nephropathy negative |
| 356 | 3976 | 49.1 ± 3.35 | 3336.7 ± 0.38 | 63% | 9% | Nephropathy negative |
| 357 | 1486 | 38.5 ± 2.05 | 3359.9 ± 0.42 | 98% | 41% | Nephropathy negative |
| 358 | 1491 | 38.5 ± 1.92 | 3360.1 ± 0.65 | 98% | 20% | Nephropathy negative |
| 359 | 1505 | 38.5 ± 2.03 | 3417.1 ± 0.48 | 95% | 45% | Nephropathy negative |
| 360 | 1510 | 38.5 ± 1.09 | 3433.3 ± 0.43 | 92% | 41% | Nephropathy negative |
| 361 | 1525 | 51.6 ± 3.50 | 3478.9 ± 0.48 | 74% | 5% | Nephropathy negative |
| 362 | 1558 | 31.7 ± 2.29 | 3589.7 ± 0.48 | 73% | 18% | Nephropathy negative |
| 363 | 1570 | 33.2 ± 3.71 | 3633.4 ± 0.95 | 80% | 18% | Nephropathy negative |
| 364 | 1571 | 36.0 ± 3.18 | 3636.6 ± 0.73 | 58% | 0% | Nephropathy negative |
| 365 | 1597 | 37.9 ± 2.69 | 3719.5 ± 0.61 | 67% | 9% | Nephropathy negative |
| 366 | 1603 | 42.0 ± 3.21 | 3739.7 ± 0.99 | 73% | 14% | Nephropathy negative |
| 367 | 1659 | 25.8 ± 1.20 | 3947.3 ± 0.67 | 92% | 32% | Nephropathy negative |
| 368 | 4169 | 39.4 ± 1.13 | 4006.6 ± 0.49 | 62% | 5% | Nephropathy negative |
| 369 | 1685 | 26.0 ± 3.97 | 4044.9 ± 0.56 | 78% | 14% | Nephropathy negative |
| 370 | 1693 | 30.5 ± 2.17 | 4070.4 ± 0.48 | 57% | 5% | Nephropathy negative |
| 371 | 1701 | 29.5 ± 0.93 | 4098.6 ± 0.52 | 86% | 32% | Nephropathy negative |
| 372 | 1702 | 34.3 ± 2.08 | 4102.5 ± 0.50 | 77% | 14% | Nephropathy negative |
| 373 | 1747 | 34.7 ± 0.63 | 4290.7 ± 0.52 | 76% | 18% | Nephropathy negative |
| 374 | 1771 | 23.5 ± 1.61 | 4405.8 ± 0.54 | 51% | 0% | Nephropathy negative |
| 375 | 1841 | 30.4 ± 1.31 | 4801.5 ± 1.06 | 65% | 0% | Nephropathy negative |
| 376 | 1856 | 32.4 ± 1.31 | 4863.8 ± 0.64 | 67% | 5% | Nephropathy negative |
| 377 | 1909 | 29.5 ± 2.25 | 5214.0 ± 1.29 | 51% | 0% | Nephropathy negative |
| 378 | 1994 | 33.0 ± 0.99 | 6172.0 ± 1.57 | 65% | 0% | Nephropathy negative |
| 379 | 2039 | 33.2 ± 0.75 | 6187.8 ± 0.75 | 95% | 45% | Nephropathy negative |
| 380 | 2292 | 23.8 ± 1.86 | 9869.7 ± 1.06 | 69% | 14% | Nephropathy negative |

In a preferred embodiment of the invention, the device according to the invention or the process according to the invention are additionally characterized in that the polypeptides are defined by stating their related mass and their related retention time in capillary electrophoresis as can be established in capillary electrophoresis coupled to a mass spectrometer. In a further preferred embodiment, the data base for the diagnosis “diabetes” includes at least one, a subset or all data records of polypeptides Nos. 1 to 157 of the above Table. In another further preferred embodiment, the data base for the diagnosis “kidney damage” includes at least one, a subset or all data records of polypeptides Nos. 158 to 380 of the above Table.

In a preferred embodiment of the invention, the marker according to the invention is additionally characterized in that the polypeptides are defined by stating their related mass and their related retention time in capillary electrophoresis as can be established in capillary electrophoresis coupled to a mass spectrometer. In particular, the marker is characterized in that at least one, a subset or all polypeptides Nos. 1 to 157 of the above Table are contained for the diagnosis “diabetes”, and at least one, a subset or all polypeptides Nos. 158 to 380 of the above Table are contained for the diagnosis “kidney damage”.

In a particularly preferred embodiment of the invention, particularly preferred polypeptide combinations can be employed for the device, the process or the marker.

As diabetes “positive” polypeptides, the polypeptides Nos. 32 (A), 1 (B), 48 (C), 2 (D), 44 (E), 22 (F), 9 (G), 23 (H) and 20 (I) and their combinations, especially as stated below, are preferred.

As diabetes “negative” polypeptides, the polypeptides Nos. 123 (A), 153 (B), 155 (C), 105 (D), 150 (E), 121 (F), 157 (G), 92 (H) and 69 (I) and their combinations, especially as stated below, are preferred.

As nephropathy “positive” polypeptides, the polypeptides Nos. 225 (A), 208 (B), 164 (C), 166 (D), 171 (E), 204 (F), 206 (G), 182 (H) and 210 (I) and their combinations, especially as stated below, are preferred.

As nephropathy “negative” polypeptides, the polypeptides Nos. 262 (A), 260 (B), 306 (C), 358 (D), 279 (E), 318 (F), 305 (G), 261 (H) and 278 (I) and their combinations, especially as stated below, are preferred.

In a still further preferred embodiment of the invention, two each of the above mentioned preferred polypeptides A, B, C, D, E, F, G, H and I are used as diabetes “negative”, as diabetes “positive”, as nephropathy “negative” or as nephropathy “positive” polypeptides. In particular, these are the combinations of the polypeptides:
A and B, A and C, A and D, A and E, A and F, A and G, A and H, A and I,
B and C, B and D, B and E, B and F, B and G, B and H, B and I,
C and D, C and E, C and F, C and G, C and H, C and I,
D and E, D and F, D and G, D and H, D and I,
E and F, E and G, E and H, E and I,
F and G, F and H, F and I,
G and H, G and I, or
H and I.

In another further preferred embodiment of the invention, three of the above mentioned preferred polypeptides A, B, C, D, E, F, G, H and I are used as diabetes “negative”, as diabetes “positive”, as nephropathy “negative” or as nephropathy “positive” polypeptides. In particular, these are the combinations of the polypeptides:
A and B in combination with one of the polypeptides C, D, E, F, G, H or I,
A and C in combination with one of the polypeptides D, E, F, G, H or I,
A and D in combination with one of the polypeptides E, F, G, H or I,
A and E in combination with one of the polypeptides F, G, H or I,
A and F in combination with one of the polypeptides G, H or I,
A and G in combination with one of the polypeptides H or I,
A and H in combination with polypeptide I,
B and C in combination with one of the polypeptides D, E, F, G, H or I,
B and D in combination with one of the polypeptides E, F, G, H or I,
B and E in combination with one of the polypeptides F, G, H or I,
B and F in combination with one of the polypeptides G, H or I,
B and G in combination with one of the polypeptides H or I,
B and H in combination with I,
C and D in combination with one of the polypeptides E, F, G, H or I,
C and E in combination with one of the polypeptides F, G, H or I,
C and F in combination with one of the polypeptides G, H or I,
C and G in combination with one of the polypeptides H or I,
C and H in combination with I,
D and E in combination with one of the polypeptides F, G, H or I,
D and F in combination with one of the polypeptides G, H or I,
D and G in combination with one of the polypeptides H or I,
D and H in combination with I,
E and F in combination with one of the polypeptides G, H or I,
E and G in combination with one of the polypeptides H or I,
E and H in combination with I,
F and G in combination with H or I,
F and H in combination with I or
G and H in combination with I.

In another further preferred embodiment of the invention, four of the above mentioned preferred polypeptides A, B, C, D, E, F, G, H and I are used as diabetes “negative”, as diabetes “positive”, as nephropathy “negative” or as nephropathy “positive” polypeptides. In particular, these are the combinations of the polypeptides:
A, B and C in combination with one of the polypeptides D, E, F, G, H or I,
A, B and D in combination with one of the polypeptides E, F, G, H or I,
A, B and E in combination with one of the polypeptides F, G, H or I,
A, B and F in combination with one of the polypeptides G, H or I,
A, B and G in combination with one of the polypeptides H or I,
A, B and H in combination with I,
A, C and D in combination with one of the polypeptides E, F, G, H or I,
A, C and E in combination with one of the polypeptides F, G, H or I,
A, C and F in combination with one of the polypeptides G, H or I,
A, C and G in combination with one of the polypeptides H or I,
A, C and H in combination with I,
A, D and E in combination with one of the polypeptides F, G, H or I,
A, D and F in combination with one of the polypeptides G, H or I,
A, D and G in combination with one of the polypeptides H or I,
A, D and H in combination with I,
A, E and F in combination with one of the polypeptides G, H or I,
A, E and G in combination with one of the polypeptides H or I,
A, E and H in combination with I,
A, F and G in combination with one of the polypeptides H or I,
A, F and H in combination with I,
A, G and H in combination with I,
B, C and D in combination with one of the polypeptides E, F, G, H or I,
B, C and E in combination with one of the polypeptides F, G, H or I,
B, C and F in combination with one of the polypeptides G, H or I,
B, C and G in combination with one of the polypeptides H or I,
B, C and H in combination with I,
B, D and E in combination with one of the polypeptides F, G, H or I,
B, D and F in combination with one of the polypeptides G, H or I,
B, D and G in combination with one of the polypeptides H or I,
B, D and H in combination with I,
B, E and F in combination with one of the polypeptides G, H or I,
B, E and G in combination with one of the polypeptides H or I,
B, E and H in combination with I,
B, F and G in combination with one of the polypeptides H or I,
B, F and H in combination with I,
B, G and H in combination with I,
C, D and E in combination with one of the polypeptides F, G, H or I,
C, D and F in combination with one of the polypeptides G, H or I,
C, D and G in combination with one of the polypeptides H or I,
C, D and H in combination with I,
C, E and F in combination with one of the polypeptides G, H or I,
C, E and G in combination with one of the polypeptides H or I,
C, E and H in combination with I,
C, F and G in combination with one of the polypeptides H or I,
C, F and H in combination with I,
C, G and H in combination with I,
D, E and F in combination with one of the polypeptides G, H or I,
D, E and G in combination with one of the polypeptides H or I,
D, E and H in combination with I,
D, F and G in combination with one of the polypeptides H or I,
D, F and H in combination with I,
D, G and H in combination with I,
E, F and G in combination with one of the polypeptides H or I,
E, F and H in combination with I,
E, G and H in combination with I, or
F, G and H in combination with I.

In another further preferred embodiment of the invention, five of the above mentioned preferred polypeptides A, B, C, D, E, F, G, H and I are used as diabetes “negative”, as diabetes “positive”, as nephropathy “negative” or as nephropathy “positive” polypeptides. In particular, these are the combinations of the polypeptides:
A, B, C and D in combination with one of the polypeptides E, F, G, H or I,
A, B, C and E in combination with one of the polypeptides F, G, H or I,
A, B, C and F in combination with one of the polypeptides G, H or I,
A, B, C and G in combination with one of the polypeptides H or I,
A, B, C and H in combination with polypeptide I,
A, B, D and E in combination with one of the polypeptides F, G, H or I,
A, B, D and F in combination with one of the polypeptides G, H or I,
A, B, D and G in combination with one of the polypeptides H or I,
A, B, D and H in combination with polypeptide I,
A, B, E and F in combination with one of the polypeptides G, H or I,
A, B, E and G in combination with one of the polypeptides H or I,
A, B, E and H in combination with polypeptide I,
A, B, F and G in combination with one of the polypeptides H or I,
A, B, F and H in combination with polypeptide I,
A, B, G and H in combination with polypeptide I,
A, C, D and E in combination with one of the polypeptides F, G, H or I,
A, C, D and F in combination with one of the polypeptides G, H or I,
A, C, D and G in combination with one of the polypeptides H or I,
A, C, D and H in combination with polypeptide I,
A, C, E and F in combination with one of the polypeptides G, H or I,
A, C, E and G in combination with one of the polypeptides H or I,
A, C, E and H in combination with polypeptide I,
A, C, F and G in combination with one of the polypeptides H or I,
A, C, F and H in combination with polypeptide I,
A, C, G and H in combination with polypeptide I,
A, D, E and F in combination with one of the polypeptides G, H or I,
A, D, E and G in combination with one of the polypeptides H or I,
A, D, E and H in combination with polypeptide I,
A, D, F and G in combination with one of the polypeptides H or I,
A, D, F and H in combination with polypeptide I,
A, D, G and H in combination with polypeptide I,
A, E, F and G in combination with one of the polypeptides H or I,
A, E, F and H in combination with polypeptide I,
A, E, G and H in combination with polypeptide I,
A, F, G and H in combination with polypeptide I,
B, C, D and E in combination with one of the polypeptides F, G, H or I,
B, C, D and F in combination with one of the polypeptides G, H or I,
B, C, D and G in combination with one of the polypeptides H or I,
B, C, D and H in combination with polypeptide I,
B, C, E and F in combination with one of the polypeptides G, H or I,
B, C, E and G in combination with one of the polypeptides H or I,
B, C, E and H in combination with polypeptide I,
B, C, F and G in combination with one of the polypeptides H or I,
B, C, F and H in combination with polypeptide I,
B, C, G and H in combination with polypeptide I,
B, D, E and F in combination with one of the polypeptides G, H or I,
B, D, E and G in combination with one of the polypeptides H or I,
B, D, E and H in combination with polypeptide I,
B, D, F and G in combination with one of the polypeptides H or I,
B, D, F and H in combination with polypeptide I,
B, D, G and H in combination with polypeptide I,
B, E, F and G in combination with one of the polypeptides H or I,
B, E, F and H in combination with polypeptide I,
B, E, G and H in combination with polypeptide I,
B, F, G and H in combination with polypeptide I,
C, D, E and F in combination with one of the polypeptides G, H or I,
C, D, E and G in combination with one of the polypeptides H or I,
C, D, E and H in combination with polypeptide I,
C, D, F and G in combination with one of the polypeptides H or I,
C, D, F and H in combination with polypeptide I,
C, D, G and H in combination with polypeptide I,
C, E, F and G in combination with one of the polypeptides H or I,
C, E, F and H in combination with polypeptide I,
C, E, G and H in combination with polypeptide I,
C, F, G and H in combination with polypeptide I,
D, E, F and G in combination with one of the polypeptides H or I,
D, E, F and H in combination with polypeptide I,
D, E, G and H in combination with polypeptide I,
D, F, G and H in combination with polypeptide I or
E, F, G and H in combination with polypeptide I.

In another further preferred embodiment of the invention, six of the above mentioned preferred polypeptides A, B, C, D, E, F, G, H and I are used as diabetes “negative”, as diabetes “positive”, as nephropathy “negative” or as nephropathy “positive” polypeptides. In particular, these are the combinations of the polypeptides:
A, B, C, D and E in combination with one of the polypeptides F, G, H or I,
A, B, C, D and F in combination with one of the polypeptides G, H or I,
A, B, C, D and G in combination with one of the polypeptides H or I,
A, B, C, D and H in combination with polypeptide I,
A, B, C, E and F in combination with one of the polypeptides G, H or I,
A, B, C, E and G in combination with one of the polypeptides H or I,
A, B, C, E and H in combination with polypeptide I,
A, B, C, F and G in combination with one of the polypeptides H or I,
A, B, C, F and H in combination with polypeptide I,
A, B, C, G and H in combination with polypeptide I,
A, B, D, E and F in combination with one of the polypeptides G, H or I,
A, B, D, E and G in combination with one of the polypeptides H or I,
A, B, D, E and H in combination with polypeptide I,
A, B, D, F and G in combination with one of the polypeptides H or I,
A, B, D, F and H in combination with polypeptide I,
A, B, D, G and H in combination with polypeptide I,
A, B, E, F and G in combination with one of the polypeptides H or I,
A, B, E, F and H in combination with polypeptide I,
A, B, E, G and H in combination with polypeptide I,
A, B, F, G and H in combination with polypeptide I,
A, C, D, E and F in combination with one of the polypeptides G, H or I,
A, C, D, E and G in combination with one of the polypeptides H or I,
A, C, D, E and H in combination with polypeptide I,
A, C, D, F and G in combination with one of the polypeptides H or I,
A, C, D, F and H in combination with polypeptide I,
A, C, D, G and H in combination with polypeptide I,
A, C, E, F and G in combination with one of the polypeptides H or I,
A, C, E, F and H in combination with polypeptide I,
A, C, E, G and H in combination with polypeptide I,
A, C, F, G and H in combination with polypeptide I,
A, D, E, F and G in combination with one of the polypeptides H or I,
A, D, E, F and H in combination with polypeptide I,
A, D, E, G and H in combination with polypeptide I,
A, D, F, G and H in combination with polypeptide I,
A, E, F, G and H in combination with polypeptide I,
B, C, D, E and F in combination with one of the polypeptides G, H or I,
B, C, D, E and G in combination with one of the polypeptides H or I,
B, C, D, E and H in combination with polypeptide I,
B, C, D, F and G in combination with one of the polypeptides H or I,
B, C, D, F and H in combination with polypeptide I,
B, C, D, G and H in combination with polypeptide I,
B, C, E, F and G in combination with one of the polypeptides H or I,
B, C, E, F and H in combination with polypeptide I,
B, C, E, G and H in combination with polypeptide I,
B, C, F, G and H in combination with polypeptide I,
B, D, E, F and G in combination with one of the polypeptides H or I,
B, D, E, F and H in combination with polypeptide I,
B, D, E, G and H in combination with polypeptide I,
B, D, F, G and H in combination with polypeptide I,
B, E, F, G and H in combination with polypeptide I,
C, D, E, F and G in combination with one of the polypeptides H or I,
C, D, E, F and H in combination with polypeptide I,
C, D, E, G and H in combination with polypeptide I,
C, D, F, G and H in combination with polypeptide I,
C, E, F, G and H in combination with polypeptide I, or
D, E, F, G and H in combination with polypeptide I.

In another further preferred embodiment of the invention, seven of the above mentioned preferred polypeptides A, B, C, D, E, F, G, H and I are used as diabetes “negative”, as diabetes “positive”, as nephropathy “negative” or as nephropathy “positive” polypeptides. In particular, these are the combinations of the polypeptides:
A, B, C, D, E and F in combination with one of the polypeptides G, H or I,
A, B, C, D, E and G in combination with one of the polypeptides H or I,
A, B, C, D, E and H in combination with polypeptide I,
A, B, C, D, F and G in combination with one of the polypeptides H or I,
A, B, C, D, F and H in combination with polypeptide I,
A, B, C, D, G and H in combination with polypeptide I,
A, B, C, E, F and G in combination with one of the polypeptides H or I,
A, B, C, E, F and H in combination with polypeptide I,
A, B, C, E, G and H in combination with polypeptide I,
A, B, C, F, G and H in combination with polypeptide I,
A, B, D, E, F and G in combination with one of the polypeptides H or I,
A, B, D, E, F and H in combination with polypeptide I,
A, B, D, E, G and H in combination with polypeptide I,
A, B, D, F, G and H in combination with polypeptide I,
A, B, E, F, G and H in combination with polypeptide I,
A, C, D, E, F and G in combination with one of the polypeptides H or I,
A, C, D, E, F and H in combination with polypeptide I,
A, C, D, E, G and H in combination with polypeptide I,
A, C, D, F, G and H in combination with polypeptide I,
A, C, E, F, G and H in combination with polypeptide I,
A, D, E, F, G and H in combination with polypeptide I,
B, C, D, E, F and G in combination with one of the polypeptides H or I,
B, C, D, E, F and H in combination with polypeptide I,
B, C, D, E, G and H in combination with polypeptide I,
B, C, D, F, G and H in combination with polypeptide I,
B, C, E, F, G and H in combination with polypeptide I,
B, D, E, F, G and H in combination with polypeptide I, or
C, D, E, F, G and H in combination with polypeptide I.

In another further preferred embodiment of the invention, eight of the above mentioned preferred polypeptides A, B, C, D, E, F, G, H and I are used as diabetes “negative”, as diabetes “positive”, as nephropathy “negative” or as nephropathy “positive” polypeptides. In particular, these are the combinations of the polypeptides:
A, B, C, D, E, F, G and H,
A, B, C, D, E, F, G and I,
A, B, C, D, E, F, H and I,
A, B, C, D, E, G, H and I,
A, B, C, D, F, G, H and I,
A, B, C, E, F, G, H and I,
A, B, D, E, F, G, H and I,
A, C, D, E, F, G, H and I, or
B, C, D, E, F, G, H and I.

In another further preferred embodiment of the invention, all nine of the above mentioned preferred polypeptides A, B, C, D, E, F, G, H and I are used as diabetes “negative”, as diabetes “positive”, as nephropathy “negative” or as nephropathy “positive” polypeptides. In particular, these are the combinations of the polypeptides:
A, B, C, D, E, F, G, H and I.

1-12. (canceled)

13. A device for the quantitative evaluation of polypeptides contained in a sample of a body fluid and comparison with reference values stored in a data base, wherein said reference values are stored as data records of polypeptides relevant to a condition, said data records comprising at least information about the probability of the occurrence and/or the concentration of polypeptides for a pathological condition in samples of healthy and diseased subjects.

14. The device according to claim 13, wherein the polypeptides are defined by stating their related mass and their related retention time in capillary electrophoresis as can be established by capillary electrophoresis coupled to a mass spectrometer.

15. The device according to claim 14, wherein the data base for the diagnosis “diabetes” includes at least one, a subset or all data records of the polypeptides according to the following Table:

| No. | ID | Time [min] | Mass [Da] | % healthy | % diseased | Type |
|---|---|---|---|---|---|---|
| 1 | 36 | 22.9 ± 3.05 | 834.5 ± 0.10 | 3% | 54% | Diabetes positive |
| 2 | 73 | 22.9 ± 3.03 | 869.4 ± 0.17 | 14% | 63% | Diabetes positive |
| 3 | 2295 | 24.2 ± 1.89 | 874.5 ± 0.09 | 28% | 66% | Diabetes positive |
| 4 | 109 | 22.2 ± 2.19 | 907.5 ± 0.13 | 0% | 41% | Diabetes positive |
| 5 | 122 | 29.0 ± 2.35 | 910.5 ± 0.09 | 15% | 47% | Diabetes positive |
| 6 | 150 | 22.9 ± 3.18 | 947.6 ± 0.22 | 17% | 51% | Diabetes positive |
| 7 | 165 | 26.8 ± 2.98 | 950.5 ± 0.12 | 0% | 24% | Diabetes positive |
| 8 | 215 | 23.2 ± 4.87 | 995.6 ± 0.14 | 23% | 50% | Diabetes positive |
| 9 | 287 | 27.4 ± 3.59 | 1082.6 ± 0.16 | 0% | 44% | Diabetes positive |
| 10 | 301 | 32.3 ± 1.99 | 1096.5 ± 0.14 | 10% | 51% | Diabetes positive |
| 11 | 381 | 26.8 ± 3.85 | 1176.6 ± 0.13 | 21% | 59% | Diabetes positive |
| 12 | 2598 | 22.3 ± 3.45 | 1222.8 ± 0.22 | 17% | 56% | Diabetes positive |
| 13 | 438 | 30.6 ± 3.31 | 1236.6 ± 0.11 | 24% | 59% | Diabetes positive |
| 14 | 4246 | 52.6 ± 4.80 | 1285.0 ± 0.09 | 14% | 54% | Diabetes positive |
| 15 | 543 | 28.8 ± 3.98 | 1332.7 ± 0.20 | 23% | 55% | Diabetes positive |
| 16 | 4694 | 49.8 ± 4.72 | 1332.8 ± 0.16 | 8% | 38% | Diabetes positive |
| 17 | 544 | 26.7 ± 2.79 | 1355.8 ± 0.15 | 17% | 56% | Diabetes positive |
| 18 | 589 | 24.6 ± 2.84 | 1386.8 ± 0.14 | 53% | 77% | Diabetes positive |
| 19 | 602 | 26.8 ± 3.26 | 1403.7 ± 0.21 | 8% | 46% | Diabetes positive |
| 20 | 584 | 17.8 ± 4.12 | 1405.9 ± 0.15 | 14% | 56% | Diabetes positive |
| 21 | 635 | 31.5 ± 3.71 | 1442.7 ± 0.27 | 15% | 55% | Diabetes positive |
| 22 | 618 | 32.1 ± 3.38 | 1449.8 ± 0.14 | 41% | 85% | Diabetes positive |
| 23 | 722 | 31.3 ± 5.27 | 1592.4 ± 0.38 | 3% | 46% | Diabetes positive |
| 24 | 3234 | 43.4 ± 4.41 | 1783.4 ± 0.30 | 33% | 63% | Diabetes positive |
| 25 | 858 | 29.4 ± 3.08 | 1789.2 ± 0.39 | 28% | 75% | Diabetes positive |
| 26 | 3259 | 38.4 ± 1.09 | 1818.9 ± 0.21 | 28% | 67% | Diabetes positive |
| 27 | 3058 | 37.7 ± 1.04 | 1821.4 ± 0.39 | 14% | 56% | Diabetes positive |
| 28 | 882 | 24.4 ± 2.55 | 1829.2 ± 0.23 | 45% | 81% | Diabetes positive |
| 29 | 5462 | 51.1 ± 4.11 | 1854.7 ± 0.41 | 14% | 54% | Diabetes positive |
| 30 | 3281 | 37.6 ± 3.30 | 1856.8 ± 0.48 | 33% | 56% | Diabetes positive |
| 31 | 906 | 24.7 ± 2.63 | 1872.9 ± 0.35 | 43% | 72% | Diabetes positive |
| 32 | 930 | 28.3 ± 3.47 | 1949.5 ± 0.32 | 17% | 73% | Diabetes positive |
| 33 | 949 | 31.6 ± 2.90 | 1955.1 ± 0.32 | 55% | 79% | Diabetes positive |
| 34 | 957 | 31.3 ± 3.00 | 1971.0 ± 0.45 | 20% | 54% | Diabetes positive |
| 35 | 988 | 37.8 ± 2.40 | 2032.0 ± 0.30 | 25% | 60% | Diabetes positive |
| 36 | 1001 | 30.9 ± 4.69 | 2061.4 ± 0.58 | 10% | 38% | Diabetes positive |
| 37 | 1016 | 33.8 ± 3.76 | 2092.2 ± 0.46 | 18% | 45% | Diabetes positive |
| 38 | 1059 | 27.7 ± 4.43 | 2185.6 ± 0.46 | 10% | 36% | Diabetes positive |
| 39 | 3271 | 32.9 ± 1.48 | 2189.4 ± 0.34 | 14% | 54% | Diabetes positive |
| 40 | 3492 | 39.6 ± 5.31 | 2229.4 ± 0.48 | 5% | 39% | Diabetes positive |
| 41 | 1078 | 24.5 ± 5.14 | 2229.9 ± 0.33 | 25% | 63% | Diabetes positive |
| 42 | 1197 | 28.3 ± 3.30 | 2502.9 ± 0.56 | 20% | 48% | Diabetes positive |
| 43 | 1243 | 24.9 ± 4.84 | 2621.6 ± 0.97 | 20% | 45% | Diabetes positive |
| 44 | 3710 | 37.5 ± 4.52 | 2669.8 ± 0.39 | 23% | 67% | Diabetes positive |
| 45 | 5507 | 20.8 ± 4.47 | 2752.2 ± 0.76 | 35% | 64% | Diabetes positive |
| 46 | 1304 | 24.9 ± 4.31 | 2795.7 ± 0.96 | 13% | 40% | Diabetes positive |
| 47 | 5687 | 48.2 ± 3.61 | 3246.1 ± 0.43 | 0% | 30% | Diabetes positive |
| 48 | 1629 | 20.9 ± 3.33 | 3844.0 ± 0.52 | 3% | 54% | Diabetes positive |
| 49 | 1869 | 21.9 ± 2.62 | 4961.5 ± 0.89 | 10% | 40% | Diabetes positive |
| 50 | 1950 | 18.6 ± 2.91 | 5497.0 ± 0.66 | 18% | 42% | Diabetes positive |
| 51 | 12 | 20.4 ± 2.20 | 808.4 ± 0.10 | 58% | 9% | Diabetes negative |
| 52 | 108 | 45.3 ± 2.03 | 897.5 ± 0.09 | 48% | 7% | Diabetes negative |
| 53 | 143 | 31.4 ± 1.08 | 929.5 ± 0.11 | 98% | 46% | Diabetes negative |
| 54 | 2533 | 41.2 ± 1.41 | 946.4 ± 0.10 | 85% | 36% | Diabetes negative |
| 55 | 2565 | 28.0 ± 1.04 | 980.5 ± 0.07 | 85% | 31% | Diabetes negative |
| 56 | 220 | 26.7 ± 2.26 | 1000.5 ± 0.09 | 83% | 41% | Diabetes negative |
| 57 | 228 | 27.8 ± 1.51 | 1008.5 ± 0.10 | 95% | 41% | Diabetes negative |
| 58 | 232 | 29.3 ± 2.55 | 1012.5 ± 0.10 | 63% | 17% | Diabetes negative |
| 59 | 2627 | 43.6 ± 2.03 | 1047.5 ± 0.11 | 90% | 26% | Diabetes negative |
| 60 | 5947 | 25.0 ± 3.91 | 1052.6 ± 0.08 | 45% | 4% | Diabetes negative |
| 61 | 286 | 37.4 ± 5.63 | 1066.5 ± 0.14 | 58% | 13% | Diabetes negative |
| 62 | 295 | 22.8 ± 1.78 | 1075.5 ± 0.13 | 68% | 26% | Diabetes negative |
| 63 | 309 | 28.9 ± 3.89 | 1088.6 ± 0.15 | 65% | 21% | Diabetes negative |
| 64 | 2681 | 44.4 ± 2.06 | 1106.5 ± 0.11 | 80% | 18% | Diabetes negative |
| 65 | 328 | 34.1 ± 1.80 | 1107.5 ± 0.10 | 88% | 35% | Diabetes negative |
| 66 | 342 | 42.8 ± 3.26 | 1120.5 ± 0.06 | 60% | 14% | Diabetes negative |
| 67 | 356 | 29.1 ± 2.26 | 1134.6 ± 0.10 | 95% | 49% | Diabetes negative |
| 68 | 359 | 28.2 ± 3.00 | 1137.7 ± 0.11 | 70% | 24% | Diabetes negative |
| 69 | 344 | 45.5 ± 2.34 | 1139.5 ± 0.20 | 83% | 22% | Diabetes negative |
| 70 | 381 | 32.9 ± 1.25 | 1159.6 ± 0.11 | 80% | 27% | Diabetes negative |
| 71 | 401 | 23.3 ± 4.17 | 1180.5 ± 0.16 | 50% | 9% | Diabetes negative |
| 72 | 421 | 43.8 ± 2.08 | 1200.6 ± 0.11 | 95% | 50% | Diabetes negative |
| 73 | 425 | 27.2 ± 3.22 | 1204.6 ± 0.17 | 60% | 17% | Diabetes negative |
| 74 | 6860 | 44.9 ± 2.53 | 1209.5 ± 0.09 | 83% | 17% | Diabetes negative |
| 75 | 2793 | 47.8 ± 2.73 | 1224.6 ± 0.12 | 75% | 19% | Diabetes negative |
| 76 | 464 | 25.6 ± 2.43 | 1246.7 ± 0.15 | 73% | 30% | Diabetes negative |
| 77 | 2833 | 47.9 ± 2.66 | 1268.6 ± 0.09 | 68% | 25% | Diabetes negative |
| 78 | 2840 | 43.9 ± 1.80 | 1277.5 ± 0.10 | 70% | 28% | Diabetes negative |
| 79 | 2841 | 46.0 ± 2.69 | 1278.5 ± 0.09 | 58% | 10% | Diabetes negative |
| 80 | 2651 | 33.1 ± 1.82 | 1282.6 ± 0.13 | 62% | 7% | Diabetes negative |
| 81 | 2893 | 29.3 ± 3.88 | 1331.7 ± 0.18 | 65% | 12% | Diabetes negative |
| 82 | 2959 | 45.9 ± 4.78 | 1405.5 ± 0.33 | 93% | 45% | Diabetes negative |
| 83 | 620 | 44.4 ± 3.90 | 1423.6 ± 0.16 | 60% | 20% | Diabetes negative |
| 84 | 663 | 19.2 ± 3.40 | 1484.8 ± 0.19 | 68% | 13% | Diabetes negative |
| 85 | 3114 | 36.9 ± 2.02 | 1609.6 ± 0.13 | 85% | 13% | Diabetes negative |
| 86 | 3136 | 38.9 ± 3.78 | 1639.7 ± 0.27 | 63% | 19% | Diabetes negative |
| 87 | 769 | 33.2 ± 3.34 | 1662.9 ± 0.21 | 62% | 5% | Diabetes negative |
| 88 | 770 | 35.8 ± 2.19 | 1664.6 ± 0.29 | 66% | 10% | Diabetes negative |
| 89 | 785 | 36.2 ± 4.78 | 1666.6 ± 0.34 | 75% | 29% | Diabetes negative |
| 90 | 3165 | 35.9 ± 2.98 | 1678.1 ± 0.44 | 60% | 18% | Diabetes negative |
| 91 | 3192 | 37.3 ± 2.99 | 1716.8 ± 0.23 | 73% | 19% | Diabetes negative |
| 92 | 2988 | 46.5 ± 4.38 | 1717.5 ± 0.37 | 79% | 15% | Diabetes negative |
| 93 | 832 | 37.9 ± 4.18 | 1746.0 ± 0.33 | 83% | 34% | Diabetes negative |
| 94 | 3258 | 25.1 ± 2.25 | 1817.6 ± 0.27 | 65% | 8% | Diabetes negative |
| 95 | 878 | 34.2 ± 3.95 | 1823.4 ± 0.47 | 73% | 30% | Diabetes negative |
| 96 | 894 | 29.1 ± 3.59 | 1849.8 ± 0.30 | 100% | 56% | Diabetes negative |
| 97 | 3314 | 49.3 ± 4.49 | 1914.1 ± 0.36 | 88% | 38% | Diabetes negative |
| 98 | 3117 | 44.2 ± 4.23 | 1916.7 ± 0.33 | 69% | 10% | Diabetes negative |
| 99 | 3383 | 39.8 ± 2.19 | 2030.8 ± 0.35 | 93% | 38% | Diabetes negative |
| 100 | 5215 | 31.9 ± 1.61 | 2118.9 ± 0.21 | 73% | 14% | Diabetes negative |
| 101 | 1056 | 41.2 ± 2.45 | 2179.3 ± 0.42 | 58% | 17% | Diabetes negative |
| 102 | 5269 | 20.1 ± 2.78 | 2219.0 ± 0.26 | 53% | 13% | Diabetes negative |
| 103 | 1090 | 25.8 ± 2.70 | 2256.9 ± 0.47 | 85% | 26% | Diabetes negative |
| 104 | 3314 | 45.1 ± 5.23 | 2273.4 ± 0.42 | 79% | 22% | Diabetes negative |
| 105 | 3317 | 40.7 ± 1.90 | 2279.0 ± 0.33 | 90% | 20% | Diabetes negative |
| 106 | 1117 | 26.8 ± 3.73 | 2320.2 ± 0.55 | 78% | 34% | Diabetes negative |
| 107 | 1123 | 23.6 ± 3.10 | 2332.2 ± 0.35 | 53% | 11% | Diabetes negative |
| 108 | 1129 | 44.5 ± 3.08 | 2345.6 ± 0.46 | 75% | 34% | Diabetes negative |
| 109 | 1146 | 25.7 ± 5.16 | 2384.5 ± 0.63 | 65% | 21% | Diabetes negative |
| 110 | 3592 | 38.5 ± 3.62 | 2423.9 ± 0.41 | 88% | 29% | Diabetes negative |
| 111 | 3595 | 34.2 ± 2.92 | 2429.9 ± 0.51 | 65% | 18% | Diabetes negative |
| 112 | 3398 | 23.3 ± 2.54 | 2443.3 ± 0.46 | 66% | 5% | Diabetes negative |
| 113 | 3446 | 41.7 ± 3.72 | 2548.1 ± 0.57 | 69% | 15% | Diabetes negative |
| 114 | 1215 | 27.3 ± 4.77 | 2548.3 ± 0.66 | 83% | 35% | Diabetes negative |
| 115 | 5421 | 43.6 ± 2.08 | 2548.3 ± 0.23 | 95% | 41% | Diabetes negative |
| 116 | 1227 | 24.0 ± 3.11 | 2581.5 ± 0.47 | 60% | 13% | Diabetes negative |
| 117 | 1230 | 24.0 ± 2.70 | 2587.4 ± 0.40 | 80% | 26% | Diabetes negative |
| 118 | 1238 | 41.7 ± 3.06 | 2606.8 ± 0.55 | 78% | 35% | Diabetes negative |
| 119 | 1237 | 31.3 ± 4.92 | 2636.4 ± 0.48 | 72% | 12% | Diabetes negative |
| 120 | 1253 | 25.5 ± 3.62 | 2644.2 ± 0.41 | 88% | 33% | Diabetes negative |
| 121 | 1244 | 29.2 ± 1.07 | 2654.0 ± 0.37 | 66% | 0% | Diabetes negative |
| 122 | 1272 | 29.8 ± 3.50 | 2698.2 ± 0.63 | 90% | 29% | Diabetes negative |
| 123 | 1266 | 43.0 ± 2.26 | 2710.5 ± 0.37 | 79% | 5% | Diabetes negative |
| 124 | 3749 | 25.1 ± 1.64 | 2761.3 ± 0.35 | 88% | 44% | Diabetes negative |
| 125 | 1301 | 31.3 ± 2.79 | 2808.5 ± 0.56 | 79% | 22% | Diabetes negative |
| 126 | 1326 | 42.0 ± 3.22 | 2876.5 ± 0.48 | 62% | 7% | Diabetes negative |
| 127 | 1342 | 33.7 ± 3.34 | 2898.7 ± 0.50 | 85% | 43% | Diabetes negative |
| 128 | 3595 | 42.2 ± 2.68 | 2908.1 ± 0.53 | 72% | 17% | Diabetes negative |
| 129 | 3598 | 35.4 ± 2.63 | 2917.6 ± 0.58 | 72% | 12% | Diabetes negative |
| 130 | 3843 | 35.4 ± 0.77 | 2978.1 ± 0.49 | 85% | 35% | Diabetes negative |
| 131 | 3849 | 36.1 ± 1.42 | 2994.6 ± 0.80 | 83% | 24% | Diabetes negative |
| 132 | 1380 | 43.5 ± 2.99 | 3023.4 ± 0.65 | 93% | 34% | Diabetes negative |
| 133 | 1388 | 44.4 ± 3.35 | 3045.2 ± 0.61 | 69% | 12% | Diabetes negative |
| 134 | 1398 | 22.9 ± 3.47 | 3076.4 ± 0.96 | 66% | 7% | Diabetes negative |
| 135 | 1404 | 35.7 ± 1.99 | 3082.3 ± 0.43 | 73% | 22% | Diabetes negative |
| 136 | 1419 | 33.6 ± 3.53 | 3136.8 ± 0.61 | 95% | 47% | Diabetes negative |
| 137 | 1425 | 21.7 ± 3.14 | 3154.8 ± 0.44 | 55% | 10% | Diabetes negative |
| 138 | 1437 | 26.5 ± 1.92 | 3193.7 ± 0.53 | 78% | 32% | Diabetes negative |
| 139 | 1441 | 24.4 ± 3.02 | 3206.3 ± 0.72 | 66% | 7% | Diabetes negative |
| 140 | 1454 | 28.2 ± 2.80 | 3250.9 ± 0.71 | 63% | 18% | Diabetes negative |
| 141 | 1469 | 48.2 ± 3.46 | 3293.2 ± 0.74 | 93% | 39% | Diabetes negative |
| 142 | 1467 | 31.4 ± 1.60 | 3295.7 ± 0.33 | 95% | 40% | Diabetes negative |
| 143 | 1479 | 27.2 ± 3.58 | 3338.4 ± 0.79 | 80% | 34% | Diabetes negative |
| 144 | 1495 | 37.3 ± 2.11 | 3381.6 ± 0.63 | 78% | 26% | Diabetes negative |
| 145 | 1517 | 27.6 ± 2.49 | 3452.1 ± 0.49 | 58% | 15% | Diabetes negative |
| 146 | 1523 | 37.3 ± 1.50 | 3463.0 ± 0.83 | 72% | 15% | Diabetes negative |
| 147 | 1556 | 19.6 ± 2.89 | 3583.4 ± 0.75 | 79% | 20% | Diabetes negative |
| 148 | 1571 | 34.0 ± 2.55 | 3634.4 ± 0.74 | 86% | 29% | Diabetes negative |
| 149 | 4086 | 37.7 ± 2.61 | 3681.8 ± 1.38 | 55% | 14% | Diabetes negative |
| 150 | 1586 | 25.5 ± 2.25 | 3686.2 ± 0.60 | 86% | 20% | Diabetes negative |
| 151 | 1602 | 36.0 ± 3.89 | 3735.7 ± 0.57 | 70% | 28% | Diabetes negative |
| 152 | 1634 | 30.3 ± 1.58 | 3852.3 ± 0.56 | 83% | 41% | Diabetes negative |
| 153 | 3920 | 29.6 ± 1.46 | 4098.4 ± 0.59 | 93% | 20% | Diabetes negative |
| 154 | 1942 | 28.8 ± 1.18 | 5428.8 ± 0.67 | 70% | 19% | Diabetes negative |
| 155 | 1995 | 33.1 ± 0.69 | 6187.5 ± 1.13 | 83% | 10% | Diabetes negative |
| 156 | 4309 | 26.0 ± 4.82 | 6212.0 ± 1.41 | 75% | 26% | Diabetes negative |
| 157 | 2160 | 23.3 ± 2.19 | 9868.8 ± 1.33 | 66% | 0% | Diabetes negative |

16. The device according to claim 14, wherein the data base for the diagnosis “kidney damage” includes at least one, a subset, or all data records of the polypeptides according to the following Table:

| No. | ID | Time [min] | Mass [Da] | % healthy | % diseased | Type |
|---|---|---|---|---|---|---|
| 158 | 32 | 21.7 ± 5.12 | 830.5 ± 0.11 | 4% | 40% | Nephropathy positive |
| 159 | 69 | 32.4 ± 1.83 | 866.4 ± 0.11 | 0% | 40% | Nephropathy positive |
| 160 | 111 | 30.6 ± 3.07 | 909.5 ± 0.13 | 11% | 40% | Nephropathy positive |
| 161 | 152 | 32.8 ± 3.14 | 937.5 ± 0.11 | 14% | 73% | Nephropathy positive |
| 162 | 155 | 24.9 ± 2.97 | 952.5 ± 0.16 | 11% | 40% | Nephropathy positive |
| 163 | 238 | 32.1 ± 2.44 | 1033.5 ± 0.11 | 5% | 40% | Nephropathy positive |
| 164 | 280 | 24.4 ± 2.87 | 1060.6 ± 0.16 | 17% | 68% | Nephropathy positive |
| 165 | 353 | 27.5 ± 2.86 | 1131.6 ± 0.16 | 20% | 68% | Nephropathy positive |
| 166 | 402 | 33.4 ± 3.48 | 1181.6 ± 0.15 | 22% | 73% | Nephropathy positive |
| 167 | 424 | 33.0 ± 2.52 | 1203.6 ± 0.14 | 9% | 50% | Nephropathy positive |
| 168 | 2586 | 26.5 ± 3.68 | 1211.6 ± 0.14 | 14% | 40% | Nephropathy positive |
| 169 | 2595 | 33.1 ± 0.91 | 1219.6 ± 0.15 | 18% | 40% | Nephropathy positive |
| 170 | 2601 | 32.8 ± 3.30 | 1225.6 ± 0.13 | 12% | 40% | Nephropathy positive |
| 171 | 510 | 30.7 ± 3.18 | 1297.7 ± 0.20 | 31% | 82% | Nephropathy positive |
| 172 | 526 | 34.1 ± 2.05 | 1333.7 ± 0.23 | 9% | 40% | Nephropathy positive |
| 173 | 2898 | 44.7 ± 4.06 | 1337.5 ± 0.20 | 19% | 59% | Nephropathy positive |
| 174 | 2955 | 27.9 ± 4.19 | 1398.8 ± 0.36 | 29% | 77% | Nephropathy positive |
| 175 | 2975 | 21.3 ± 5.08 | 1423.7 ± 0.49 | 6% | 50% | Nephropathy positive |
| 176 | 633 | 28.1 ± 4.95 | 1439.8 ± 0.19 | 19% | 68% | Nephropathy positive |
| 177 | 651 | 24.5 ± 2.42 | 1466.0 ± 0.27 | 9% | 77% | Nephropathy positive |
| 178 | 641 | 27.5 ± 4.93 | 1482.0 ± 0.42 | 33% | 40% | Nephropathy positive |
| 179 | 642 | 29.8 ± 4.43 | 1482.9 ± 0.28 | 18% | 40% | Nephropathy positive |
| 180 | 662 | 24.3 ± 2.65 | 1483.7 ± 0.28 | 26% | 91% | Nephropathy positive |
| 181 | 675 | 24.6 ± 1.98 | 1500.0 ± 0.20 | 38% | 86% | Nephropathy positive |
| 182 | 711 | 24.6 ± 2.90 | 1553.1 ± 0.28 | 14% | 64% | Nephropathy positive |
| 183 | 713 | 29.0 ± 4.83 | 1556.7 ± 0.45 | 26% | 73% | Nephropathy positive |
| 184 | 720 | 24.2 ± 2.48 | 1567.0 ± 0.22 | 26% | 86% | Nephropathy positive |
| 185 | 740 | 28.8 ± 4.53 | 1596.9 ± 0.31 | 21% | 86% | Nephropathy positive |
| 186 | 777 | 24.5 ± 2.43 | 1652.8 ± 0.25 | 14% | 59% | Nephropathy positive |
| 187 | 787 | 26.3 ± 2.63 | 1669.8 ± 0.37 | 20% | 64% | Nephropathy positive |
| 188 | 3200 | 33.1 ± 3.22 | 1729.2 ± 0.36 | 6% | 45% | Nephropathy positive |
| 189 | 3210 | 30.5 ± 4.11 | 1744.4 ± 0.46 | 16% | 59% | Nephropathy positive |
| 190 | 6963 | 25.1 ± 3.42 | 1754.4 ± 0.41 | 53% | 95% | Nephropathy positive |
| 191 | 3230 | 24.2 ± 1.56 | 1776.0 ± 0.27 | 9% | 50% | Nephropathy positive |
| 192 | 3036 | 18.5 ± 3.55 | 1791.0 ± 0.38 | 7% | 40% | Nephropathy positive |
| 193 | 843 | 32.2 ± 5.38 | 1792.9 ± 0.31 | 28% | 40% | Nephropathy positive |
| 194 | 3043 | 9.7 ± 2.54 | 1799.8 ± 0.29 | 0% | 40% | Nephropathy positive |
| 195 | 870 | 25.3 ± 2.89 | 1810.9 ± 0.38 | 43% | 91% | Nephropathy positive |
| 196 | 895 | 24.6 ± 2.34 | 1851.1 ± 0.21 | 43% | 95% | Nephropathy positive |
| 197 | 903 | 27.2 ± 4.46 | 1867.3 ± 0.42 | 38% | 91% | Nephropathy positive |
| 198 | 939 | 25.0 ± 3.97 | 1966.0 ± 0.53 | 16% | 40% | Nephropathy positive |
| 199 | 947 | 28.7 ± 3.08 | 1982.8 ± 0.57 | 11% | 40% | Nephropathy positive |
| 200 | 965 | 29.5 ± 5.53 | 1986.3 ± 0.36 | 15% | 64% | Nephropathy positive |
| 201 | 979 | 23.3 ± 4.46 | 2045.9 ± 0.32 | 32% | 40% | Nephropathy positive |
| 202 | 1013 | 33.7 ± 3.16 | 2115.1 ± 0.53 | 30% | 40% | Nephropathy positive |
| 203 | 3263 | 20.5 ± 2.78 | 2177.1 ± 0.37 | 9% | 40% | Nephropathy positive |
| 204 | 1083 | 18.1 ± 4.24 | 2241.6 ± 0.41 | 9% | 59% | Nephropathy positive |
| 205 | 1087 | 21.2 ± 2.49 | 2250.7 ± 0.38 | 23% | 64% | Nephropathy positive |
| 206 | 1091 | 27.5 ± 2.53 | 2258.7 ± 0.49 | 9% | 59% | Nephropathy positive |
| 207 | 1135 | 20.0 ± 3.30 | 2356.4 ± 0.41 | 13% | 59% | Nephropathy positive |
| 208 | 1149 | 28.1 ± 3.95 | 2391.4 ± 0.42 | 13% | 64% | Nephropathy positive |
| 209 | 1156 | 25.7 ± 4.85 | 2406.1 ± 0.57 | 20% | 77% | Nephropathy positive |
| 210 | 1163 | 22.8 ± 4.28 | 2423.2 ± 0.53 | 14% | 64% | Nephropathy positive |
| 211 | 1165 | 21.9 ± 4.45 | 2427.3 ± 0.40 | 31% | 91% | Nephropathy positive |
| 212 | 1182 | 19.2 ± 4.24 | 2465.1 ± 0.62 | 9% | 77% | Nephropathy positive |
| 213 | 5398 | 25.4 ± 5.25 | 2493.0 ± 0.38 | 9% | 50% | Nephropathy positive |
| 214 | 3627 | 19.5 ± 4.66 | 2494.0 ± 0.66 | 12% | 77% | Nephropathy positive |
| 215 | 5610 | 23.7 ± 4.27 | 2494.9 ± 0.49 | 7% | 40% | Nephropathy positive |
| 216 | 3640 | 24.4 ± 5.51 | 2522.0 ± 0.67 | 17% | 82% | Nephropathy positive |
| 217 | 1212 | 20.1 ± 3.61 | 2540.5 ± 0.54 | 14% | 68% | Nephropathy positive |
| 218 | 3673 | 22.3 ± 4.72 | 2593.5 ± 0.30 | 7% | 55% | Nephropathy positive |
| 219 | 1241 | 20.0 ± 4.87 | 2613.9 ± 0.83 | 14% | 55% | Nephropathy positive |
| 220 | 1272 | 35.1 ± 1.62 | 2726.5 ± 0.67 | 61% | 20% | Nephropathy positive |
| 221 | 1289 | 25.0 ± 4.39 | 2775.1 ± 0.56 | 12% | 40% | Nephropathy positive |
| 222 | 1303 | 21.8 ± 3.78 | 2790.7 ± 0.55 | 19% | 86% | Nephropathy positive |
| 223 | 1339 | 25.9 ± 3.30 | 2892.2 ± 0.50 | 9% | 50% | Nephropathy positive |
| 224 | 3819 | 16.8 ± 2.72 | 2919.0 ± 0.26 | 2% | 50% | Nephropathy positive |
| 225 | 1355 | 21.9 ± 3.23 | 2937.0 ± 0.49 | 13% | 86% | Nephropathy positive |
| 226 | 1362 | 20.0 ± 4.81 | 2958.8 ± 0.80 | 5% | 59% | Nephropathy positive |
| 227 | 1358 | 34.4 ± 2.72 | 2962.0 ± 0.54 | 12% | 20% | Nephropathy positive |
| 228 | 1393 | 28.9 ± 3.56 | 3059.7 ± 0.78 | 30% | 40% | Nephropathy positive |
| 229 | 1402 | 28.3 ± 5.96 | 3088.0 ± 0.79 | 7% | 20% | Nephropathy positive |
| 230 | 1494 | 26.1 ± 2.72 | 3369.2 ± 0.73 | 21% | 40% | Nephropathy positive |
| 231 | 1528 | 26.0 ± 2.89 | 3483.4 ± 0.95 | 30% | 40% | Nephropathy positive |
| 232 | 1719 | 24.5 ± 3.92 | 4183.3 ± 1.44 | 4% | 40% | Nephropathy positive |
| 233 | 1734 | 21.0 ± 5.35 | 4241.0 ± 0.62 | 29% | 73% | Nephropathy positive |
| 234 | 1761 | 23.4 ± 4.09 | 4370.2 ± 1.01 | 11% | 40% | Nephropathy positive |
| 235 | 1793 | 22.8 ± 2.94 | 4527.6 ± 0.67 | 1% | 45% | Nephropathy positive |
| 236 | 1825 | 21.7 ± 3.00 | 4713.6 ± 0.44 | 7% | 64% | Nephropathy positive |
| 237 | 2060 | 24.6 ± 3.73 | 7556.6 ± 1.55 | 2% | 40% | Nephropathy positive |
| 238 | 3994 | 16.7 ± 5.54 | 8055.1 ± 2.10 | 12% | 40% | Nephropathy positive |
| 239 | 2229 | 13.2 ± 5.19 | 8765.8 ± 0.96 | 37% | 82% | Nephropathy positive |
| 240 | 2252 | 15.3 ± 4.97 | 9181.0 ± 1.28 | 10% | 64% | Nephropathy positive |
| 241 | 2302 | 14.0 ± 4.20 | 10046.1 ± 0.96 | 21% | 77% | Nephropathy positive |
| 242 | 2180 | 18.7 ± 5.50 | 10208.0 ± 1.24 | 2% | 40% | Nephropathy positive |
| 243 | 2323 | 17.4 ± 4.02 | 10518.2 ± 1.10 | 23% | 64% | Nephropathy positive |
| 244 | 138 | 35.3 ± 5.04 | 924.5 ± 0.12 | 50% | 0% | Nephropathy negative |
| 245 | 142 | 43.1 ± 2.61 | 928.4 ± 0.08 | 65% | 14% | Nephropathy negative |
| 246 | 2541 | 45.7 ± 2.25 | 955.5 ± 0.14 | 60% | 5% | Nephropathy negative |
| 247 | 2594 | 23.8 ± 2.94 | 1010.6 ± 0.09 | 67% | 5% | Nephropathy negative |
| 248 | 248 | 31.2 ± 1.53 | 1028.5 ± 0.09 | 84% | 32% | Nephropathy negative |
| 249 | 2622 | 45.9 ± 2.27 | 1041.4 ± 0.10 | 57% | 0% | Nephropathy negative |
| 250 | 266 | 31.5 ± 1.98 | 1046.5 ± 0.09 | 87% | 32% | Nephropathy negative |
| 251 | 2440 | 43.4 ± 2.24 | 1047.5 ± 0.12 | 68% | 0% | Nephropathy negative |
| 252 | 2442 | 18.1 ± 4.34 | 1050.7 ± 0.12 | 60% | 0% | Nephropathy negative |
| 253 | 304 | 32.9 ± 3.03 | 1084.4 ± 0.11 | 69% | 18% | Nephropathy negative |
| 254 | 347 | 46.7 ± 2.63 | 1125.5 ± 0.12 | 63% | 9% | Nephropathy negative |
| 255 | 2731 | 46.3 ± 2.70 | 1157.5 ± 0.10 | 83% | 32% | Nephropathy negative |
| 256 | 2733 | 43.7 ± 1.70 | 1160.5 ± 0.07 | 72% | 18% | Nephropathy negative |
| 257 | 400 | 44.5 ± 3.67 | 1179.5 ± 0.09 | 97% | 36% | Nephropathy negative |
| 258 | 412 | 45.0 ± 2.24 | 1191.6 ± 0.09 | 60% | 9% | Nephropathy negative |
| 259 | 416 | 46.2 ± 2.59 | 1195.5 ± 0.10 | 98% | 32% | Nephropathy negative |
| 260 | 2575 | 44.2 ± 1.83 | 1200.6 ± 0.13 | 86% | 0% | Nephropathy negative |
| 261 | 442 | 45.9 ± 2.04 | 1223.5 ± 0.10 | 80% | 9% | Nephropathy negative |
| 262 | 441 | 44.5 ± 2.15 | 1239.6 ± 0.08 | 89% | 0% | Nephropathy negative |
| 263 | 2814 | 47.8 ± 3.08 | 1246.6 ± 0.11 | 60% | 5% | Nephropathy negative |
| 264 | 2821 | 46.8 ± 2.20 | 1254.7 ± 0.19 | 56% | 5% | Nephropathy negative |
| 265 | 478 | 43.2 ± 2.90 | 1261.5 ± 0.16 | 91% | 36% | Nephropathy negative |
| 266 | 479 | 48.6 ± 2.90 | 1262.5 ± 0.09 | 65% | 0% | Nephropathy negative |
| 267 | 476 | 43.9 ± 2.16 | 1277.6 ± 0.11 | 67% | 0% | Nephropathy negative |
| 268 | 502 | 36.7 ± 3.04 | 1288.7 ± 0.18 | 72% | 23% | Nephropathy negative |
| 269 | 2856 | 47.2 ± 3.17 | 1292.5 ± 0.14 | 67% | 18% | Nephropathy negative |
| 270 | 521 | 47.8 ± 2.58 | 1308.5 ± 0.09 | 66% | 0% | Nephropathy negative |
| 271 | 4687 | 48.2 ± 2.67 | 1321.6 ± 0.11 | 53% | 0% | Nephropathy negative |
| 272 | 533 | 34.8 ± 1.81 | 1321.7 ± 0.23 | 98% | 41% | Nephropathy negative |
| 273 | 559 | 46.0 ± 4.93 | 1351.7 ± 0.15 | 63% | 9% | Nephropathy negative |
| 274 | 2925 | 47.7 ± 2.99 | 1367.6 ± 0.14 | 97% | 23% | Nephropathy negative |
| 275 | 582 | 37.8 ± 2.93 | 1378.6 ± 0.16 | 87% | 36% | Nephropathy negative |
| 276 | 2946 | 47.5 ± 2.59 | 1389.7 ± 0.15 | 86% | 18% | Nephropathy negative |
| 277 | 2961 | 46.5 ± 2.28 | 1407.8 ± 0.20 | 79% | 9% | Nephropathy negative |
| 278 | 2768 | 44.6 ± 4.84 | 1422.1 ± 0.33 | 70% | 0% | Nephropathy negative |
| 279 | 598 | 45.4 ± 3.62 | 1423.8 ± 0.19 | 75% | 0% | Nephropathy negative |
| 280 | 2976 | 48.0 ± 2.97 | 1424.7 ± 0.16 | 95% | 18% | Nephropathy negative |
| 281 | 638 | 47.6 ± 3.40 | 1446.7 ± 0.16 | 92% | 23% | Nephropathy negative |
| 282 | 2998 | 46.5 ± 2.95 | 1450.4 ± 0.25 | 62% | 9% | Nephropathy negative |
| 283 | 3008 | 48.0 ± 2.95 | 1462.6 ± 0.17 | 97% | 9% | Nephropathy negative |
| 284 | 665 | 35.7 ± 1.90 | 1487.7 ± 0.15 | 70% | 18% | Nephropathy negative |
| 285 | 3031 | 47.8 ± 2.35 | 1490.6 ± 0.12 | 72% | 9% | Nephropathy negative |
| 286 | 3032 | 49.2 ± 2.77 | 1491.7 ± 0.12 | 81% | 14% | Nephropathy negative |
| 287 | 3043 | 49.0 ± 3.14 | 1507.8 ± 0.17 | 99% | 32% | Nephropathy negative |
| 288 | 3055 | 49.2 ± 2.86 | 1523.7 ± 0.11 | 97% | 18% | Nephropathy negative |
| 289 | 3059 | 48.6 ± 2.70 | 1529.7 ± 0.19 | 83% | 9% | Nephropathy negative |
| 290 | 3065 | 49.2 ± 3.26 | 1539.7 ± 0.19 | 98% | 23% | Nephropathy negative |
| 291 | 3070 | 49.0 ± 3.19 | 1545.7 ± 0.13 | 99% | 23% | Nephropathy negative |
| 292 | 3081 | 49.8 ± 2.76 | 1561.6 ± 0.19 | 90% | 18% | Nephropathy negative |
| 293 | 3085 | 48.4 ± 3.12 | 1567.7 ± 0.20 | 65% | 9% | Nephropathy negative |
| 294 | 3089 | 48.1 ± 2.66 | 1573.7 ± 0.27 | 63% | 5% | Nephropathy negative |
| 295 | 3092 | 48.5 ± 4.03 | 1577.8 ± 0.35 | 94% | 9% | Nephropathy negative |
| 296 | 2900 | 50.6 ± 3.40 | 1587.1 ± 0.34 | 65% | 0% | Nephropathy negative |
| 297 | 735 | 48.6 ± 2.68 | 1589.7 ± 0.14 | 86% | 18% | Nephropathy negative |
| 298 | 736 | 45.9 ± 3.83 | 1591.7 ± 0.30 | 79% | 18% | Nephropathy negative |
| 299 | 3105 | 49.3 ± 3.22 | 1594.8 ± 0.14 | 88% | 14% | Nephropathy negative |
| 300 | 3111 | 48.8 ± 2.78 | 1605.7 ± 0.13 | 73% | 18% | Nephropathy negative |
| 301 | 750 | 48.5 ± 2.81 | 1611.7 ± 0.14 | 73% | 5% | Nephropathy negative |
| 302 | 3134 | 46.3 ± 5.12 | 1636.4 ± 0.39 | 79% | 23% | Nephropathy negative |
| 303 | 3145 | 49.5 ± 3.37 | 1651.8 ± 0.19 | 99% | 23% | Nephropathy negative |
| 304 | 780 | 45.2 ± 5.96 | 1657.7 ± 0.23 | 60% | 5% | Nephropathy negative |
| 305 | 790 | 49.5 ± 3.33 | 1673.8 ± 0.14 | 95% | 23% | Nephropathy negative |
| 306 | 2969 | 49.6 ± 3.05 | 1689.8 ± 0.18 | 86% | 0% | Nephropathy negative |
| 307 | 810 | 26.9 ± 3.18 | 1706.8 ± 0.30 | 78% | 27% | Nephropathy negative |
| 308 | 3203 | 49.4 ± 2.84 | 1734.4 ± 0.40 | 65% | 5% | Nephropathy negative |
| 309 | 4983 | 49.2 ± 3.17 | 1739.7 ± 0.22 | 59% | 5% | Nephropathy negative |
| 310 | 3212 | 45.1 ± 4.21 | 1748.0 ± 0.28 | 55% | 5% | Nephropathy negative |
| 311 | 5032 | 44.2 ± 4.71 | 1813.6 ± 0.38 | 58% | 5% | Nephropathy negative |
| 312 | 874 | 39.1 ± 3.48 | 1817.0 ± 0.29 | 85% | 18% | Nephropathy negative |
| 313 | 3272 | 51.7 ± 3.48 | 1841.0 ± 0.23 | 59% | 9% | Nephropathy negative |
| 314 | 3277 | 50.4 ± 4.56 | 1848.2 ± 0.43 | 58% | 0% | Nephropathy negative |
| 315 | 5059 | 51.5 ± 2.94 | 1856.8 ± 0.24 | 59% | 5% | Nephropathy negative |
| 316 | 3285 | 52.7 ± 4.24 | 1863.8 ± 0.31 | 88% | 14% | Nephropathy negative |
| 317 | 914 | 52.7 ± 3.92 | 1885.8 ± 0.20 | 70% | 5% | Nephropathy negative |
| 318 | 3108 | 47.7 ± 4.69 | 1902.1 ± 0.33 | 75% | 0% | Nephropathy negative |
| 319 | 3120 | 50.6 ± 3.95 | 1924.0 ± 0.48 | 68% | 0% | Nephropathy negative |
| 320 | 981 | 26.6 ± 1.76 | 2048.5 ± 0.44 | 86% | 20% | Nephropathy negative |
| 321 | 3415 | 25.8 ± 1.39 | 2085.9 ± 0.24 | 83% | 32% | Nephropathy negative |
| 322 | 3416 | 39.9 ± 1.45 | 2087.8 ± 0.34 | 72% | 23% | Nephropathy negative |
| 323 | 5214 | 52.8 ± 4.09 | 2117.1 ± 0.17 | 78% | 9% | Nephropathy negative |
| 324 | 1020 | 28.3 ± 3.90 | 2129.7 ± 0.42 | 63% | 0% | Nephropathy negative |
| 325 | 3456 | 40.4 ± 1.53 | 2158.9 ± 0.26 | 86% | 32% | Nephropathy negative |
| 326 | 3465 | 39.7 ± 1.71 | 2174.9 ± 0.36 | 97% | 45% | Nephropathy negative |
| 327 | 3491 | 32.6 ± 1.79 | 2227.1 ± 0.41 | 81% | 23% | Nephropathy negative |
| 328 | 1086 | 29.3 ± 3.50 | 2249.0 ± 0.41 | 92% | 41% | Nephropathy negative |
| 329 | 3506 | 40.6 ± 1.25 | 2257.1 ± 0.35 | 94% | 45% | Nephropathy negative |
| 330 | 1097 | 46.2 ± 5.11 | 2273.5 ± 0.38 | 71% | 18% | Nephropathy negative |
| 331 | 1094 | 40.8 ± 2.66 | 2296.0 ± 0.40 | 63% | 20% | Nephropathy negative |
| 332 | 1121 | 40.9 ± 3.32 | 2327.6 ± 0.52 | 85% | 36% | Nephropathy negative |
| 333 | 3551 | 41.8 ± 2.45 | 2343.3 ± 0.43 | 77% | 27% | Nephropathy negative |
| 334 | 3574 | 40.8 ± 1.31 | 2385.3 ± 0.32 | 95% | 45% | Nephropathy negative |
| 335 | 1185 | 40.9 ± 2.68 | 2471.5 ± 0.52 | 69% | 14% | Nephropathy negative |
| 336 | 1193 | 41.5 ± 2.64 | 2493.5 ± 0.48 | 74% | 18% | Nephropathy negative |
| 337 | 5432 | 52.9 ± 3.98 | 2570.4 ± 0.27 | 71% | 5% | Nephropathy negative |
| 338 | 3697 | 34.1 ± 0.72 | 2642.8 ± 0.40 | 86% | 36% | Nephropathy negative |
| 339 | 1268 | 36.1 ± 2.56 | 2687.1 ± 0.49 | 84% | 23% | Nephropathy negative |
| 340 | 1276 | 42.8 ± 2.33 | 2710.6 ± 0.46 | 88% | 18% | Nephropathy negative |
| 341 | 5506 | 50.6 ± 4.73 | 2748.6 ± 0.36 | 64% | 0% | Nephropathy negative |
| 342 | 1371 | 37.8 ± 1.92 | 2986.6 ± 0.55 | 74% | 23% | Nephropathy negative |
| 343 | 1379 | 23.3 ± 2.07 | 3007.4 ± 0.50 | 65% | 9% | Nephropathy negative |
| 344 | 1385 | 25.9 ± 2.35 | 3038.3 ± 0.70 | 46% | 0% | Nephropathy negative |
| 345 | 3868 | 46.0 ± 2.91 | 3045.4 ± 0.36 | 59% | 5% | Nephropathy negative |
| 346 | 5624 | 53.3 ± 4.05 | 3057.2 ± 0.64 | 76% | 9% | Nephropathy negative |
| 347 | 1411 | 38.9 ± 2.57 | 3109.0 ± 0.57 | 88% | 14% | Nephropathy negative |
| 348 | 1435 | 41.9 ± 3.55 | 3187.6 ± 0.47 | 71% | 14% | Nephropathy negative |
| 349 | 1437 | 26.6 ± 1.15 | 3193.6 ± 0.41 | 61% | 0% | Nephropathy negative |
| 350 | 5681 | 48.3 ± 3.69 | 3223.8 ± 0.41 | 88% | 18% | Nephropathy negative |
| 351 | 1458 | 31.7 ± 3.65 | 3265.1 ± 0.64 | 93% | 41% | Nephropathy negative |
| 352 | 1465 | 29.5 ± 1.76 | 3291.0 ± 0.52 | 81% | 23% | Nephropathy negative |
| 353 | 1466 | 49.2 ± 3.70 | 3293.1 ± 0.43 | 91% | 14% | Nephropathy negative |
| 354 | 3968 | 49.9 ± 3.57 | 3315.0 ± 0.45 | 67% | 5% | Nephropathy negative |
| 355 | 3969 | 43.3 ± 2.04 | 3319.9 ± 0.66 | 86% | 23% | Nephropathy negative |
| 356 | 3976 | 49.1 ± 3.35 | 3336.7 ± 0.38 | 63% | 9% | Nephropathy negative |
| 357 | 1486 | 38.5 ± 2.05 | 3359.9 ± 0.42 | 98% | 41% | Nephropathy negative |
| 358 | 1491 | 38.5 ± 1.92 | 3360.1 ± 0.65 | 98% | 20% | Nephropathy negative |
| 359 | 1505 | 38.5 ± 2.03 | 3417.1 ± 0.48 | 95% | 45% | Nephropathy negative |
| 360 | 1510 | 38.5 ± 1.09 | 3433.3 ± 0.43 | 92% | 41% | Nephropathy negative |
| 361 | 1525 | 51.6 ± 3.50 | 3478.9 ± 0.48 | 74% | 5% | Nephropathy negative |
| 362 | 1558 | 31.7 ± 2.29 | 3589.7 ± 0.48 | 73% | 18% | Nephropathy negative |
| 363 | 1570 | 33.2 ± 3.71 | 3633.4 ± 0.95 | 80% | 18% | Nephropathy negative |
| 364 | 1571 | 36.0 ± 3.18 | 3636.6 ± 0.73 | 58% | 0% | Nephropathy negative |
| 365 | 1597 | 37.9 ± 2.69 | 3719.5 ± 0.61 | 67% | 9% | Nephropathy negative |
| 366 | 1603 | 42.0 ± 3.21 | 3739.7 ± 0.99 | 73% | 14% | Nephropathy negative |
| 367 | 1659 | 25.8 ± 1.20 | 3947.3 ± 0.67 | 92% | 32% | Nephropathy negative |
| 368 | 4169 | 39.4 ± 1.13 | 4006.6 ± 0.49 | 62% | 5% | Nephropathy negative |
| 369 | 1685 | 26.0 ± 3.97 | 4044.9 ± 0.56 | 78% | 14% | Nephropathy negative |
| 370 | 1693 | 30.5 ± 2.17 | 4070.4 ± 0.48 | 57% | 5% | Nephropathy negative |
| 371 | 1701 | 29.5 ± 0.93 | 4098.6 ± 0.52 | 86% | 32% | Nephropathy negative |
| 372 | 1702 | 34.3 ± 2.08 | 4102.5 ± 0.50 | 77% | 14% | Nephropathy negative |
| 373 | 1747 | 34.7 ± 0.63 | 4290.7 ± 0.52 | 76% | 18% | Nephropathy negative |
| 374 | 1771 | 23.5 ± 1.61 | 4405.8 ± 0.54 | 51% | 0% | Nephropathy negative |
| 375 | 1841 | 30.4 ± 1.31 | 4801.5 ± 1.06 | 65% | 0% | Nephropathy negative |
| 376 | 1856 | 32.4 ± 1.31 | 4863.8 ± 0.64 | 67% | 5% | Nephropathy negative |
| 377 | 1909 | 29.5 ± 2.25 | 5214.0 ± 1.29 | 51% | 0% | Nephropathy negative |
| 378 | 1994 | 33.0 ± 0.99 | 6172.0 ± 1.57 | 65% | 0% | Nephropathy negative |
| 379 | 2039 | 33.2 ± 0.75 | 6187.8 ± 0.75 | 95% | 45% | Nephropathy negative |
| 380 | 2292 | 23.8 ± 1.86 | 9869.7 ± 1.06 | 69% | 14% | Nephropathy negative |

17. A process for the quantitative evaluation of polypeptides contained in a sample of a body fluid, wherein reference values stored in a data base are data records of polypeptides relevant to a condition, said data records comprising at least information about the probability of the occurrence and/or the concentration of the polypeptides for a pathological condition in samples of healthy and diseased subjects and comparing the occurrence and/or the concentration of the polypeptides in the sample of the body fluid with at least one reference value.

18. The process according to claim 17, wherein the polypeptides are defined by stating their related mass and their related retention time in capillary electrophoresis as can be established in capillary electrophoresis coupled to a mass spectrometer.

19. The process according to claim 18, wherein for the diagnosis “diabetes” at least one, a subset, or all data records of the polypeptides according to the following Table are used for comparison:

| No. | ID | Time [min] | Mass [Da] | % healthy | % diseased | Type |
|---|---|---|---|---|---|---|
| 1 | 36 | 22.9 ± 3.05 | 834.5 ± 0.10 | 3% | 54% | Diabetes positive |
| 2 | 73 | 22.9 ± 3.03 | 869.4 ± 0.17 | 14% | 63% | Diabetes positive |
| 3 | 2295 | 24.2 ± 1.89 | 874.5 ± 0.09 | 28% | 66% | Diabetes positive |
| 4 | 109 | 22.2 ± 2.19 | 907.5 ± 0.13 | 0% | 41% | Diabetes positive |
| 5 | 122 | 29.0 ± 2.35 | 910.5 ± 0.09 | 15% | 47% | Diabetes positive |
| 6 | 150 | 22.9 ± 3.18 | 947.6 ± 0.22 | 17% | 51% | Diabetes positive |
| 7 | 165 | 26.8 ± 2.98 | 950.5 ± 0.12 | 0% | 24% | Diabetes positive |
| 8 | 215 | 23.2 ± 4.87 | 995.6 ± 0.14 | 23% | 50% | Diabetes positive |
| 9 | 287 | 27.4 ± 3.59 | 1082.6 ± 0.16 | 0% | 44% | Diabetes positive |
| 10 | 301 | 32.3 ± 1.99 | 1096.5 ± 0.14 | 10% | 51% | Diabetes positive |
| 11 | 381 | 26.8 ± 3.85 | 1176.6 ± 0.13 | 21% | 59% | Diabetes positive |
| 12 | 2598 | 22.3 ± 3.45 | 1222.8 ± 0.22 | 17% | 56% | Diabetes positive |
| 13 | 438 | 30.6 ± 3.31 | 1236.6 ± 0.11 | 24% | 59% | Diabetes positive |
| 14 | 4246 | 52.6 ± 4.80 | 1285.0 ± 0.09 | 14% | 54% | Diabetes positive |
| 15 | 543 | 28.8 ± 3.98 | 1332.7 ± 0.20 | 23% | 55% | Diabetes positive |
| 16 | 4694 | 49.8 ± 4.72 | 1332.8 ± 0.16 | 8% | 38% | Diabetes positive |
| 17 | 544 | 26.7 ± 2.79 | 1355.8 ± 0.15 | 17% | 56% | Diabetes positive |
| 18 | 589 | 24.6 ± 2.84 | 1386.8 ± 0.14 | 53% | 77% | Diabetes positive |
| 19 | 602 | 26.8 ± 3.26 | 1403.7 ± 0.21 | 8% | 46% | Diabetes positive |
| 20 | 584 | 17.8 ± 4.12 | 1405.9 ± 0.15 | 14% | 56% | Diabetes positive |
| 21 | 635 | 31.5 ± 3.71 | 1442.7 ± 0.27 | 15% | 55% | Diabetes positive |
| 22 | 618 | 32.1 ± 3.38 | 1449.8 ± 0.14 | 41% | 85% | Diabetes positive |
| 23 | 722 | 31.3 ± 5.27 | 1592.4 ± 0.38 | 3% | 46% | Diabetes positive |
| 24 | 3234 | 43.4 ± 4.41 | 1783.4 ± 0.30 | 33% | 63% | Diabetes positive |
| 25 | 858 | 29.4 ± 3.08 | 1789.2 ± 0.39 | 28% | 75% | Diabetes positive |
| 26 | 3259 | 38.4 ± 1.09 | 1818.9 ± 0.21 | 28% | 67% | Diabetes positive |
| 27 | 3058 | 37.7 ± 1.04 | 1821.4 ± 0.39 | 14% | 56% | Diabetes positive |
| 28 | 882 | 24.4 ± 2.55 | 1829.2 ± 0.23 | 45% | 81% | Diabetes positive |
| 29 | 5462 | 51.1 ± 4.11 | 1854.7 ± 0.41 | 14% | 54% | Diabetes positive |
| 30 | 3281 | 37.6 ± 3.30 | 1856.8 ± 0.48 | 33% | 56% | Diabetes positive |
| 31 | 906 | 24.7 ± 2.63 | 1872.9 ± 0.35 | 43% | 72% | Diabetes positive |
| 32 | 930 | 28.3 ± 3.47 | 1949.5 ± 0.32 | 17% | 73% | Diabetes positive |
| 33 | 949 | 31.6 ± 2.90 | 1955.1 ± 0.32 | 55% | 79% | Diabetes positive |
| 34 | 957 | 31.3 ± 3.00 | 1971.0 ± 0.45 | 20% | 54% | Diabetes positive |
| 35 | 988 | 37.8 ± 2.40 | 2032.0 ± 0.30 | 25% | 60% | Diabetes positive |
| 36 | 1001 | 30.9 ± 4.69 | 2061.4 ± 0.58 | 10% | 38% | Diabetes positive |
| 37 | 1016 | 33.8 ± 3.76 | 2092.2 ± 0.46 | 18% | 45% | Diabetes positive |
| 38 | 1059 | 27.7 ± 4.43 | 2185.6 ± 0.46 | 10% | 36% | Diabetes positive |
| 39 | 3271 | 32.9 ± 1.48 | 2189.4 ± 0.34 | 14% | 54% | Diabetes positive |
| 40 | 3492 | 39.6 ± 5.31 | 2229.4 ± 0.48 | 5% | 39% | Diabetes positive |
| 41 | 1078 | 24.5 ± 5.14 | 2229.9 ± 0.33 | 25% | 63% | Diabetes positive |
| 42 | 1197 | 28.3 ± 3.30 | 2502.9 ± 0.56 | 20% | 48% | Diabetes positive |
| 43 | 1243 | 24.9 ± 4.84 | 2621.6 ± 0.97 | 20% | 45% | Diabetes positive |
| 44 | 3710 | 37.5 ± 4.52 | 2669.8 ± 0.39 | 23% | 67% | Diabetes positive |
| 45 | 5507 | 20.8 ± 4.47 | 2752.2 ± 0.76 | 35% | 64% | Diabetes positive |
| 46 | 1304 | 24.9 ± 4.31 | 2795.7 ± 0.96 | 13% | 40% | Diabetes positive |
| 47 | 5687 | 48.2 ± 3.61 | 3246.1 ± 0.43 | 0% | 30% | Diabetes positive |
| 48 | 1629 | 20.9 ± 3.33 | 3844.0 ± 0.52 | 3% | 54% | Diabetes positive |
| 49 | 1869 | 21.9 ± 2.62 | 4961.5 ± 0.89 | 10% | 40% | Diabetes positive |
| 50 | 1950 | 18.6 ± 2.91 | 5497.0 ± 0.66 | 18% | 42% | Diabetes positive |
| 51 | 12 | 20.4 ± 2.20 | 808.4 ± 0.10 | 58% | 9% | Diabetes negative |
| 52 | 108 | 45.3 ± 2.03 | 897.5 ± 0.09 | 48% | 7% | Diabetes negative |
| 53 | 143 | 31.4 ± 1.08 | 929.5 ± 0.11 | 98% | 46% | Diabetes negative |
| 54 | 2533 | 41.2 ± 1.41 | 946.4 ± 0.10 | 85% | 36% | Diabetes negative |
| 55 | 2565 | 28.0 ± 1.04 | 980.5 ± 0.07 | 85% | 31% | Diabetes negative |
| 56 | 220 | 26.7 ± 2.26 | 1000.5 ± 0.09 | 83% | 41% | Diabetes negative |
| 57 | 228 | 27.8 ± 1.51 | 1008.5 ± 0.10 | 95% | 41% | Diabetes negative |
| 58 | 232 | 29.3 ± 2.55 | 1012.5 ± 0.10 | 63% | 17% | Diabetes negative |
| 59 | 2627 | 43.6 ± 2.03 | 1047.5 ± 0.11 | 90% | 26% | Diabetes negative |
| 60 | 5947 | 25.0 ± 3.91 | 1052.6 ± 0.08 | 45% | 4% | Diabetes negative |
| 61 | 286 | 37.4 ± 5.63 | 1066.5 ± 0.14 | 58% | 13% | Diabetes negative |
| 62 | 295 | 22.8 ± 1.78 | 1075.5 ± 0.13 | 68% | 26% | Diabetes negative |
| 63 | 309 | 28.9 ± 3.89 | 1088.6 ± 0.15 | 65% | 21% | Diabetes negative |
| 64 | 2681 | 44.4 ± 2.06 | 1106.5 ± 0.11 | 80% | 18% | Diabetes negative |
| 65 | 328 | 34.1 ± 1.80 | 1107.5 ± 0.10 | 88% | 35% | Diabetes negative |
| 66 | 342 | 42.8 ± 3.26 | 1120.5 ± 0.06 | 60% | 14% | Diabetes negative |
| 67 | 356 | 29.1 ± 2.26 | 1134.6 ± 0.10 | 95% | 49% | Diabetes negative |
| 68 | 359 | 28.2 ± 3.00 | 1137.7 ± 0.11 | 70% | 24% | Diabetes negative |
| 69 | 344 | 45.5 ± 2.34 | 1139.5 ± 0.20 | 83% | 22% | Diabetes negative |
| 70 | 381 | 32.9 ± 1.25 | 1159.6 ± 0.11 | 80% | 27% | Diabetes negative |
| 71 | 401 | 23.3 ± 4.17 | 1180.5 ± 0.16 | 50% | 9% | Diabetes negative |
| 72 | 421 | 43.8 ± 2.08 | 1200.6 ± 0.11 | 95% | 50% | Diabetes negative |
| 73 | 425 | 27.2 ± 3.22 | 1204.6 ± 0.17 | 60% | 17% | Diabetes negative |
| 74 | 6860 | 44.9 ± 2.53 | 1209.5 ± 0.09 | 83% | 17% | Diabetes negative |
| 75 | 2793 | 47.8 ± 2.73 | 1224.6 ± 0.12 | 75% | 19% | Diabetes negative |
| 76 | 464 | 25.6 ± 2.43 | 1246.7 ± 0.15 | 73% | 30% | Diabetes negative |
| 77 | 2833 | 47.9 ± 2.66 | 1268.6 ± 0.09 | 68% | 25% | Diabetes negative |
| 78 | 2840 | 43.9 ± 1.80 | 1277.5 ± 0.10 | 70% | 28% | Diabetes negative |
| 79 | 2841 | 46.0 ± 2.69 | 1278.5 ± 0.09 | 58% | 10% | Diabetes negative |
| 80 | 2651 | 33.1 ± 1.82 | 1282.6 ± 0.13 | 62% | 7% | Diabetes negative |
| 81 | 2893 | 29.3 ± 3.88 | 1331.7 ± 0.18 | 65% | 12% | Diabetes negative |
| 82 | 2959 | 45.9 ± 4.78 | 1405.5 ± 0.33 | 93% | 45% | Diabetes negative |
| 83 | 620 | 44.4 ± 3.90 | 1423.6 ± 0.16 | 60% | 20% | Diabetes negative |
| 84 | 663 | 19.2 ± 3.40 | 1484.8 ± 0.19 | 68% | 13% | Diabetes negative |
| 85 | 3114 | 36.9 ± 2.02 | 1609.6 ± 0.13 | 85% | 13% | Diabetes negative |
| 86 | 3136 | 38.9 ± 3.78 | 1639.7 ± 0.27 | 63% | 19% | Diabetes negative |
| 87 | 769 | 33.2 ± 3.34 | 1662.9 ± 0.21 | 62% | 5% | Diabetes negative |
| 88 | 770 | 35.8 ± 2.19 | 1664.6 ± 0.29 | 66% | 10% | Diabetes negative |
| 89 | 785 | 36.2 ± 4.78 | 1666.6 ± 0.34 | 75% | 29% | Diabetes negative |
| 90 | 3165 | 35.9 ± 2.98 | 1678.1 ± 0.44 | 60% | 18% | Diabetes negative |
| 91 | 3192 | 37.3 ± 2.99 | 1716.8 ± 0.23 | 73% | 19% | Diabetes negative |
| 92 | 2988 | 46.5 ± 4.38 | 1717.5 ± 0.37 | 79% | 15% | Diabetes negative |
| 93 | 832 | 37.9 ± 4.18 | 1746.0 ± 0.33 | 83% | 34% | Diabetes negative |
| 94 | 3258 | 25.1 ± 2.25 | 1817.6 ± 0.27 | 65% | 8% | Diabetes negative |
| 95 | 878 | 34.2 ± 3.95 | 1823.4 ± 0.47 | 73% | 30% | Diabetes negative |
| 96 | 894 | 29.1 ± 3.59 | 1849.8 ± 0.30 | 100% | 56% | Diabetes negative |
| 97 | 3314 | 49.3 ± 4.49 | 1914.1 ± 0.36 | 88% | 38% | Diabetes negative |
| 98 | 3117 | 44.2 ± 4.23 | 1916.7 ± 0.33 | 69% | 10% | Diabetes negative |
| 99 | 3383 | 39.8 ± 2.19 | 2030.8 ± 0.35 | 93% | 38% | Diabetes negative |
| 100 | 5215 | 31.9 ± 1.61 | 2118.9 ± 0.21 | 73% | 14% | Diabetes negative |
| 101 | 1056 | 41.2 ± 2.45 | 2179.3 ± 0.42 | 58% | 17% | Diabetes negative |
| 102 | 5269 | 20.1 ± 2.78 | 2219.0 ± 0.26 | 53% | 13% | Diabetes negative |
| 103 | 1090 | 25.8 ± 2.70 | 2256.9 ± 0.47 | 85% | 26% | Diabetes negative |
| 104 | 3314 | 45.1 ± 5.23 | 2273.4 ± 0.42 | 79% | 22% | Diabetes negative |
| 105 | 3317 | 40.7 ± 1.90 | 2279.0 ± 0.33 | 90% | 20% | Diabetes negative |
| 106 | 1117 | 26.8 ± 3.73 | 2320.2 ± 0.55 | 78% | 34% | Diabetes negative |
| 107 | 1123 | 23.6 ± 3.10 | 2332.2 ± 0.35 | 53% | 11% | Diabetes negative |
| 108 | 1129 | 44.5 ± 3.08 | 2345.6 ± 0.46 | 75% | 34% | Diabetes negative |
| 109 | 1146 | 25.7 ± 5.16 | 2384.5 ± 0.63 | 65% | 21% | Diabetes negative |
| 110 | 3592 | 38.5 ± 3.62 | 2423.9 ± 0.41 | 88% | 29% | Diabetes negative |
| 111 | 3595 | 34.2 ± 2.92 | 2429.9 ± 0.51 | 65% | 18% | Diabetes negative |
| 112 | 3398 | 23.3 ± 2.54 | 2443.3 ± 0.46 | 66% | 5% | Diabetes negative |
| 113 | 3446 | 41.7 ± 3.72 | 2548.1 ± 0.57 | 69% | 15% | Diabetes negative |
| 114 | 1215 | 27.3 ± 4.77 | 2548.3 ± 0.66 | 83% | 35% | Diabetes negative |
| 115 | 5421 | 43.6 ± 2.08 | 2548.3 ± 0.23 | 95% | 41% | Diabetes negative |
| 116 | 1227 | 24.0 ± 3.11 | 2581.5 ± 0.47 | 60% | 13% | Diabetes negative |
| 117 | 1230 | 24.0 ± 2.70 | 2587.4 ± 0.40 | 80% | 26% | Diabetes negative |
| 118 | 1238 | 41.7 ± 3.06 | 2606.8 ± 0.55 | 78% | 35% | Diabetes negative |
| 119 | 1237 | 31.3 ± 4.92 | 2636.4 ± 0.48 | 72% | 12% | Diabetes negative |
| 120 | 1253 | 25.5 ± 3.62 | 2644.2 ± 0.41 | 88% | 33% | Diabetes negative |
| 121 | 1244 | 29.2 ± 1.07 | 2654.0 ± 0.37 | 66% | 0% | Diabetes negative |
| 122 | 1272 | 29.8 ± 3.50 | 2698.2 ± 0.63 | 90% | 29% | Diabetes negative |
| 123 | 1266 | 43.0 ± 2.26 | 2710.5 ± 0.37 | 79% | 5% | Diabetes negative |
| 124 | 3749 | 25.1 ± 1.64 | 2761.3 ± 0.35 | 88% | 44% | Diabetes negative |
| 125 | 1301 | 31.3 ± 2.79 | 2808.5 ± 0.56 | 79% | 22% | Diabetes negative |
| 126 | 1326 | 42.0 ± 3.22 | 2876.5 ± 0.48 | 62% | 7% | Diabetes negative |
| 127 | 1342 | 33.7 ± 3.34 | 2898.7 ± 0.50 | 85% | 43% | Diabetes negative |
| 128 | 3595 | 42.2 ± 2.68 | 2908.1 ± 0.53 | 72% | 17% | Diabetes negative |
| 129 | 3598 | 35.4 ± 2.63 | 2917.6 ± 0.58 | 72% | 12% | Diabetes negative |
| 130 | 3843 | 35.4 ± 0.77 | 2978.1 ± 0.49 | 85% | 35% | Diabetes negative |
| 131 | 3849 | 36.1 ± 1.42 | 2994.6 ± 0.80 | 83% | 24% | Diabetes negative |
| 132 | 1380 | 43.5 ± 2.99 | 3023.4 ± 0.65 | 93% | 34% | Diabetes negative |
| 133 | 1388 | 44.4 ± 3.35 | 3045.2 ± 0.61 | 69% | 12% | Diabetes negative |
| 134 | 1398 | 22.9 ± 3.47 | 3076.4 ± 0.96 | 66% | 7% | Diabetes negative |
| 135 | 1404 | 35.7 ± 1.99 | 3082.3 ± 0.43 | 73% | 22% | Diabetes negative |
| 136 | 1419 | 33.6 ± 3.53 | 3136.8 ± 0.61 | 95% | 47% | Diabetes negative |
| 137 | 1425 | 21.7 ± 3.14 | 3154.8 ± 0.44 | 55% | 10% | Diabetes negative |
| 138 | 1437 | 26.5 ± 1.92 | 3193.7 ± 0.53 | 78% | 32% | Diabetes negative |
| 139 | 1441 | 24.4 ± 3.02 | 3206.3 ± 0.72 | 66% | 7% | Diabetes negative |
| 140 | 1454 | 28.2 ± 2.80 | 3250.9 ± 0.71 | 63% | 18% | Diabetes negative |
| 141 | 1469 | 48.2 ± 3.46 | 3293.2 ± 0.74 | 93% | 39% | Diabetes negative |
| 142 | 1467 | 31.4 ± 1.60 | 3295.7 ± 0.33 | 95% | 40% | Diabetes negative |
| 143 | 1479 | 27.2 ± 3.58 | 3338.4 ± 0.79 | 80% | 34% | Diabetes negative |
| 144 | 1495 | 37.3 ± 2.11 | 3381.6 ± 0.63 | 78% | 26% | Diabetes negative |
| 145 | 1517 | 27.6 ± 2.49 | 3452.1 ± 0.49 | 58% | 15% | Diabetes negative |
| 146 | 1523 | 37.3 ± 1.50 | 3463.0 ± 0.83 | 72% | 15% | Diabetes negative |
| 147 | 1556 | 19.6 ± 2.89 | 3583.4 ± 0.75 | 79% | 20% | Diabetes negative |
| 148 | 1571 | 34.0 ± 2.55 | 3634.4 ± 0.74 | 86% | 29% | Diabetes negative |
| 149 | 4086 | 37.7 ± 2.61 | 3681.8 ± 1.38 | 55% | 14% | Diabetes negative |
| 150 | 1586 | 25.5 ± 2.25 | 3686.2 ± 0.60 | 86% | 20% | Diabetes negative |
| 151 | 1602 | 36.0 ± 3.89 | 3735.7 ± 0.57 | 70% | 28% | Diabetes negative |
| 152 | 1634 | 30.3 ± 1.58 | 3852.3 ± 0.56 | 83% | 41% | Diabetes negative |
| 153 | 3920 | 29.6 ± 1.46 | 4098.4 ± 0.59 | 93% | 20% | Diabetes negative |
| 154 | 1942 | 28.8 ± 1.18 | 5428.8 ± 0.67 | 70% | 19% | Diabetes negative |
| 155 | 1995 | 33.1 ± 0.69 | 6187.5 ± 1.13 | 83% | 10% | Diabetes negative |
| 156 | 4309 | 26.0 ± 4.82 | 6212.0 ± 1.41 | 75% | 26% | Diabetes negative |
| 157 | 2160 | 23.3 ± 2.19 | 9868.8 ± 1.33 | 66% | 0% | Diabetes negative |

20. The process according to claim 18, wherein for the diagnosis “kidney damage” at least one, a subset, or all data records of the polypeptides according to the following Table are used for comparison:

| No. | ID | Time [min] | Mass [Da] | % healthy | % diseased | Type |
|---|---|---|---|---|---|---|
| 158 | 32 | 21.7 ± 5.12 | 830.5 ± 0.11 | 4% | 40% | Nephropathy positive |
| 159 | 69 | 32.4 ± 1.83 | 866.4 ± 0.11 | 0% | 40% | Nephropathy positive |
| 160 | 111 | 30.6 ± 3.07 | 909.5 ± 0.13 | 11% | 40% | Nephropathy positive |
| 161 | 152 | 32.8 ± 3.14 | 937.5 ± 0.11 | 14% | 73% | Nephropathy positive |
| 162 | 155 | 24.9 ± 2.97 | 952.5 ± 0.16 | 11% | 40% | Nephropathy positive |
| 163 | 238 | 32.1 ± 2.44 | 1033.5 ± 0.11 | 5% | 40% | Nephropathy positive |
| 164 | 280 | 24.4 ± 2.87 | 1060.6 ± 0.16 | 17% | 68% | Nephropathy positive |
| 165 | 353 | 27.5 ± 2.86 | 1131.6 ± 0.16 | 20% | 68% | Nephropathy positive |
| 166 | 402 | 33.4 ± 3.48 | 1181.6 ± 0.15 | 22% | 73% | Nephropathy positive |
| 167 | 424 | 33.0 ± 2.52 | 1203.6 ± 0.14 | 9% | 50% | Nephropathy positive |
| 168 | 2586 | 26.5 ± 3.68 | 1211.6 ± 0.14 | 14% | 40% | Nephropathy positive |
| 169 | 2595 | 33.1 ± 0.91 | 1219.6 ± 0.15 | 18% | 40% | Nephropathy positive |
| 170 | 2601 | 32.8 ± 3.30 | 1225.6 ± 0.13 | 12% | 40% | Nephropathy positive |
| 171 | 510 | 30.7 ± 3.18 | 1297.7 ± 0.20 | 31% | 82% | Nephropathy positive |
| 172 | 526 | 34.1 ± 2.05 | 1333.7 ± 0.23 | 9% | 40% | Nephropathy positive |
| 173 | 2898 | 44.7 ± 4.06 | 1337.5 ± 0.20 | 19% | 59% | Nephropathy positive |
| 174 | 2955 | 27.9 ± 4.19 | 1398.8 ± 0.36 | 29% | 77% | Nephropathy positive |
| 175 | 2975 | 21.3 ± 5.08 | 1423.7 ± 0.49 | 6% | 50% | Nephropathy positive |
| 176 | 633 | 28.1 ± 4.95 | 1439.8 ± 0.19 | 19% | 68% | Nephropathy positive |
| 177 | 651 | 24.5 ± 2.42 | 1466.0 ± 0.27 | 9% | 77% | Nephropathy positive |
| 178 | 641 | 27.5 ± 4.93 | 1482.0 ± 0.42 | 33% | 40% | Nephropathy positive |
| 179 | 642 | 29.8 ± 4.43 | 1482.9 ± 0.28 | 18% | 40% | Nephropathy positive |
| 180 | 662 | 24.3 ± 2.65 | 1483.7 ± 0.28 | 26% | 91% | Nephropathy positive |
| 181 | 675 | 24.6 ± 1.98 | 1500.0 ± 0.20 | 38% | 86% | Nephropathy positive |
| 182 | 711 | 24.6 ± 2.90 | 1553.1 ± 0.28 | 14% | 64% | Nephropathy positive |
| 183 | 713 | 29.0 ± 4.83 | 1556.7 ± 0.45 | 26% | 73% | Nephropathy positive |
| 184 | 720 | 24.2 ± 2.48 | 1567.0 ± 0.22 | 26% | 86% | Nephropathy positive |
| 185 | 740 | 28.8 ± 4.53 | 1596.9 ± 0.31 | 21% | 86% | Nephropathy positive |
| 186 | 777 | 24.5 ± 2.43 | 1652.8 ± 0.25 | 14% | 59% | Nephropathy positive |
| 187 | 787 | 26.3 ± 2.63 | 1669.8 ± 0.37 | 20% | 64% | Nephropathy positive |
| 188 | 3200 | 33.1 ± 3.22 | 1729.2 ± 0.36 | 6% | 45% | Nephropathy positive |
| 189 | 3210 | 30.5 ± 4.11 | 1744.4 ± 0.46 | 16% | 59% | Nephropathy positive |
| 190 | 6963 | 25.1 ± 3.42 | 1754.4 ± 0.41 | 53% | 95% | Nephropathy positive |
| 191 | 3230 | 24.2 ± 1.56 | 1776.0 ± 0.27 | 9% | 50% | Nephropathy positive |
| 192 | 3036 | 18.5 ± 3.55 | 1791.0 ± 0.38 | 7% | 40% | Nephropathy positive |
| 193 | 843 | 32.2 ± 5.38 | 1792.9 ± 0.31 | 28% | 40% | Nephropathy positive |
| 194 | 3043 | 9.7 ± 2.54 | 1799.8 ± 0.29 | 0% | 40% | Nephropathy positive |
| 195 | 870 | 25.3 ± 2.89 | 1810.9 ± 0.38 | 43% | 91% | Nephropathy positive |
| 196 | 895 | 24.6 ± 2.34 | 1851.1 ± 0.21 | 43% | 95% | Nephropathy positive |
| 197 | 903 | 27.2 ± 4.46 | 1867.3 ± 0.42 | 38% | 91% | Nephropathy positive |
| 198 | 939 | 25.0 ± 3.97 | 1966.0 ± 0.53 | 16% | 40% | Nephropathy positive |
| 199 | 947 | 28.7 ± 3.08 | 1982.8 ± 0.57 | 11% | 40% | Nephropathy positive |
| 200 | 965 | 29.5 ± 5.53 | 1986.3 ± 0.36 | 15% | 64% | Nephropathy positive |
| 201 | 979 | 23.3 ± 4.46 | 2045.9 ± 0.32 | 32% | 40% | Nephropathy positive |
| 202 | 1013 | 33.7 ± 3.16 | 2115.1 ± 0.53 | 30% | 40% | Nephropathy positive |
| 203 | 3263 | 20.5 ± 2.78 | 2177.1 ± 0.37 | 9% | 40% | Nephropathy positive |
| 204 | 1083 | 18.1 ± 4.24 | 2241.6 ± 0.41 | 9% | 59% | Nephropathy positive |
| 205 | 1087 | 21.2 ± 2.49 | 2250.7 ± 0.38 | 23% | 64% | Nephropathy positive |
| 206 | 1091 | 27.5 ± 2.53 | 2258.7 ± 0.49 | 9% | 59% | Nephropathy positive |
| 207 | 1135 | 20.0 ± 3.30 | 2356.4 ± 0.41 | 13% | 59% | Nephropathy positive |
| 208 | 1149 | 28.1 ± 3.95 | 2391.4 ± 0.42 | 13% | 64% | Nephropathy positive |
| 209 | 1156 | 25.7 ± 4.85 | 2406.1 ± 0.57 | 20% | 77% | Nephropathy positive |
| 210 | 1163 | 22.8 ± 4.28 | 2423.2 ± 0.53 | 14% | 64% | Nephropathy positive |
| 211 | 1165 | 21.9 ± 4.45 | 2427.3 ± 0.40 | 31% | 91% | Nephropathy positive |
| 212 | 1182 | 19.2 ± 4.24 | 2465.1 ± 0.62 | 9% | 77% | Nephropathy positive |
| 213 | 5398 | 25.4 ± 5.25 | 2493.0 ± 0.38 | 9% | 50% | Nephropathy positive |
| 214 | 3627 | 19.5 ± 4.66 | 2494.0 ± 0.66 | 12% | 77% | Nephropathy positive |
| 215 | 5610 | 23.7 ± 4.27 | 2494.9 ± 0.49 | 7% | 40% | Nephropathy positive |
| 216 | 3640 | 24.4 ± 5.51 | 2522.0 ± 0.67 | 17% | 82% | Nephropathy positive |
| 217 | 1212 | 20.1 ± 3.61 | 2540.5 ± 0.54 | 14% | 68% | Nephropathy positive |
| 218 | 3673 | 22.3 ± 4.72 | 2593.5 ± 0.30 | 7% | 55% | Nephropathy positive |
| 219 | 1241 | 20.0 ± 4.87 | 2613.9 ± 0.83 | 14% | 55% | Nephropathy positive |
| 220 | 1272 | 35.1 ± 1.62 | 2726.5 ± 0.67 | 61% | 20% | Nephropathy positive |
| 221 | 1289 | 25.0 ± 4.39 | 2775.1 ± 0.56 | 12% | 40% | Nephropathy positive |
| 222 | 1303 | 21.8 ± 3.78 | 2790.7 ± 0.55 | 19% | 86% | Nephropathy positive |
| 223 | 1339 | 25.9 ± 3.30 | 2892.2 ± 0.50 | 9% | 50% | Nephropathy positive |
| 224 | 3819 | 16.8 ± 2.72 | 2919.0 ± 0.26 | 2% | 50% | Nephropathy positive |
| 225 | 1355 | 21.9 ± 3.23 | 2937.0 ± 0.49 | 13% | 86% | Nephropathy positive |
| 226 | 1362 | 20.0 ± 4.81 | 2958.8 ± 0.80 | 5% | 59% | Nephropathy positive |
| 227 | 1358 | 34.4 ± 2.72 | 2962.0 ± 0.54 | 12% | 20% | Nephropathy positive |
| 228 | 1393 | 28.9 ± 3.56 | 3059.7 ± 0.78 | 30% | 40% | Nephropathy positive |
| 229 | 1402 | 28.3 ± 5.96 | 3088.0 ± 0.79 | 7% | 20% | Nephropathy positive |
| 230 | 1494 | 26.1 ± 2.72 | 3369.2 ± 0.73 | 21% | 40% | Nephropathy positive |
| 231 | 1528 | 26.0 ± 2.89 | 3483.4 ± 0.95 | 30% | 40% | Nephropathy positive |
| 232 | 1719 | 24.5 ± 3.92 | 4183.3 ± 1.44 | 4% | 40% | Nephropathy positive |
| 233 | 1734 | 21.0 ± 5.35 | 4241.0 ± 0.62 | 29% | 73% | Nephropathy positive |
| 234 | 1761 | 23.4 ± 4.09 | 4370.2 ± 1.01 | 11% | 40% | Nephropathy positive |
| 235 | 1793 | 22.8 ± 2.94 | 4527.6 ± 0.67 | 1% | 45% | Nephropathy positive |
| 236 | 1825 | 21.7 ± 3.00 | 4713.6 ± 0.44 | 7% | 64% | Nephropathy positive |
| 237 | 2060 | 24.6 ± 3.73 | 7556.6 ± 1.55 | 2% | 40% | Nephropathy positive |
| 238 | 3994 | 16.7 ± 5.54 | 8055.1 ± 2.10 | 12% | 40% | Nephropathy positive |
| 239 | 2229 | 13.2 ± 5.19 | 8765.8 ± 0.96 | 37% | 82% | Nephropathy positive |
| 240 | 2252 | 15.3 ± 4.97 | 9181.0 ± 1.28 | 10% | 64% | Nephropathy positive |
| 241 | 2302 | 14.0 ± 4.20 | 10046.1 ± 0.96 | 21% | 77% | Nephropathy positive |
| 242 | 2180 | 18.7 ± 5.50 | 10208.0 ± 1.24 | 2% | 40% | Nephropathy positive |
| 243 | 2323 | 17.4 ± 4.02 | 10518.2 ± 1.10 | 23% | 64% | Nephropathy positive |
| 244 | 138 | 35.3 ± 5.04 | 924.5 ± 0.12 | 50% | 0% | Nephropathy negative |
| 245 | 142 | 43.1 ± 2.61 | 928.4 ± 0.08 | 65% | 14% | Nephropathy negative |
| 246 | 2541 | 45.7 ± 2.25 | 955.5 ± 0.14 | 60% | 5% | Nephropathy negative |
| 247 | 2594 | 23.8 ± 2.94 | 1010.6 ± 0.09 | 67% | 5% | Nephropathy negative |
| 248 | 248 | 31.2 ± 1.53 | 1028.5 ± 0.09 | 84% | 32% | Nephropathy negative |
| 249 | 2622 | 45.9 ± 2.27 | 1041.4 ± 0.10 | 57% | 0% | Nephropathy negative |
| 250 | 266 | 31.5 ± 1.98 | 1046.5 ± 0.09 | 87% | 32% | Nephropathy negative |
| 251 | 2440 | 43.4 ± 2.24 | 1047.5 ± 0.12 | 68% | 0% | Nephropathy negative |
| 252 | 2442 | 18.1 ± 4.34 | 1050.7 ± 0.12 | 60% | 0% | Nephropathy negative |
| 253 | 304 | 32.9 ± 3.03 | 1084.4 ± 0.11 | 69% | 18% | Nephropathy negative |
| 254 | 347 | 46.7 ± 2.63 | 1125.5 ± 0.12 | 63% | 9% | Nephropathy negative |
| 255 | 2731 | 46.3 ± 2.70 | 1157.5 ± 0.10 | 83% | 32% | Nephropathy negative |
| 256 | 2733 | 43.7 ± 1.70 | 1160.5 ± 0.07 | 72% | 18% | Nephropathy negative |
| 257 | 400 | 44.5 ± 3.67 | 1179.5 ± 0.09 | 97% | 36% | Nephropathy negative |
| 258 | 412 | 45.0 ± 2.24 | 1191.6 ± 0.09 | 60% | 9% | Nephropathy negative |
| 259 | 416 | 46.2 ± 2.59 | 1195.5 ± 0.10 | 98% | 32% | Nephropathy negative |
| 260 | 2575 | 44.2 ± 1.83 | 1200.6 ± 0.13 | 86% | 0% | Nephropathy negative |
| 261 | 442 | 45.9 ± 2.04 | 1223.5 ± 0.10 | 80% | 9% | Nephropathy negative |
| 262 | 441 | 44.5 ± 2.15 | 1239.6 ± 0.08 | 89% | 0% | Nephropathy negative |
| 263 | 2814 | 47.8 ± 3.08 | 1246.6 ± 0.11 | 60% | 5% | Nephropathy negative |
| 264 | 2821 | 46.8 ± 2.20 | 1254.7 ± 0.19 | 56% | 5% | Nephropathy negative |
| 265 | 478 | 43.2 ± 2.90 | 1261.5 ± 0.16 | 91% | 36% | Nephropathy negative |
| 266 | 479 | 48.6 ± 2.90 | 1262.5 ± 0.09 | 65% | 0% | Nephropathy negative |
| 267 | 476 | 43.9 ± 2.16 | 1277.6 ± 0.11 | 67% | 0% | Nephropathy negative |
| 268 | 502 | 36.7 ± 3.04 | 1288.7 ± 0.18 | 72% | 23% | Nephropathy negative |
| 269 | 2856 | 47.2 ± 3.17 | 1292.5 ± 0.14 | 67% | 18% | Nephropathy negative |
| 270 | 521 | 47.8 ± 2.58 | 1308.5 ± 0.09 | 66% | 0% | Nephropathy negative |
| 271 | 4687 | 48.2 ± 2.67 | 1321.6 ± 0.11 | 53% | 0% | Nephropathy negative |
| 272 | 533 | 34.8 ± 1.81 | 1321.7 ± 0.23 | 98% | 41% | Nephropathy negative |
| 273 | 559 | 46.0 ± 4.93 | 1351.7 ± 0.15 | 63% | 9% | Nephropathy negative |
| 274 | 2925 | 47.7 ± 2.99 | 1367.6 ± 0.14 | 97% | 23% | Nephropathy negative |
| 275 | 582 | 37.8 ± 2.93 | 1378.6 ± 0.16 | 87% | 36% | Nephropathy negative |
| 276 | 2946 | 47.5 ± 2.59 | 1389.7 ± 0.15 | 86% | 18% | Nephropathy negative |
| 277 | 2961 | 46.5 ± 2.28 | 1407.8 ± 0.20 | 79% | 9% | Nephropathy negative |
| 278 | 2768 | 44.6 ± 4.84 | 1422.1 ± 0.33 | 70% | 0% | Nephropathy negative |
| 279 | 598 | 45.4 ± 3.62 | 1423.8 ± 0.19 | 75% | 0% | Nephropathy negative |
| 280 | 2976 | 48.0 ± 2.97 | 1424.7 ± 0.16 | 95% | 18% | Nephropathy negative |
| 281 | 638 | 47.6 ± 3.40 | 1446.7 ± 0.16 | 92% | 23% | Nephropathy negative |
| 282 | 2998 | 46.5 ± 2.95 | 1450.4 ± 0.25 | 62% | 9% | Nephropathy negative |
| 283 | 3008 | 48.0 ± 2.95 | 1462.6 ± 0.17 | 97% | 9% | Nephropathy negative |
| 284 | 665 | 35.7 ± 1.90 | 1487.7 ± 0.15 | 70% | 18% | Nephropathy negative |
| 285 | 3031 | 47.8 ± 2.35 | 1490.6 ± 0.12 | 72% | 9% | Nephropathy negative |
| 286 | 3032 | 49.2 ± 2.77 | 1491.7 ± 0.12 | 81% | 14% | Nephropathy negative |
| 287 | 3043 | 49.0 ± 3.14 | 1507.8 ± 0.17 | 99% | 32% | Nephropathy negative |
| 288 | 3055 | 49.2 ± 2.86 | 1523.7 ± 0.11 | 97% | 18% | Nephropathy negative |
| 289 | 3059 | 48.6 ± 2.70 | 1529.7 ± 0.19 | 83% | 9% | Nephropathy negative |
| 290 | 3065 | 49.2 ± 3.26 | 1539.7 ± 0.19 | 98% | 23% | Nephropathy negative |
| 291 | 3070 | 49.0 ± 3.19 | 1545.7 ± 0.13 | 99% | 23% | Nephropathy negative |
| 292 | 3081 | 49.8 ± 2.76 | 1561.6 ± 0.19 | 90% | 18% | Nephropathy negative |
| 293 | 3085 | 48.4 ± 3.12 | 1567.7 ± 0.20 | 65% | 9% | Nephropathy negative |
| 294 | 3089 | 48.1 ± 2.66 | 1573.7 ± 0.27 | 63% | 5% | Nephropathy negative |
| 295 | 3092 | 48.5 ± 4.03 | 1577.8 ± 0.35 | 94% | 9% | Nephropathy negative |
| 296 | 2900 | 50.6 ± 3.40 | 1587.1 ± 0.34 | 65% | 0% | Nephropathy negative |
| 297 | 735 | 48.6 ± 2.68 | 1589.7 ± 0.14 | 86% | 18% | Nephropathy negative |
| 298 | 736 | 45.9 ± 3.83 | 1591.7 ± 0.30 | 79% | 18% | Nephropathy negative |
| 299 | 3105 | 49.3 ± 3.22 | 1594.8 ± 0.14 | 88% | 14% | Nephropathy negative |
| 300 | 3111 | 48.8 ± 2.78 | 1605.7 ± 0.13 | 73% | 18% | Nephropathy negative |
| 301 | 750 | 48.5 ± 2.81 | 1611.7 ± 0.14 | 73% | 5% | Nephropathy negative |
| 302 | 3134 | 46.3 ± 5.12 | 1636.4 ± 0.39 | 79% | 23% | Nephropathy negative |
| 303 | 3145 | 49.5 ± 3.37 | 1651.8 ± 0.19 | 99% | 23% | Nephropathy negative |
| 304 | 780 | 45.2 ± 5.96 | 1657.7 ± 0.23 | 60% | 5% | Nephropathy negative |
| 305 | 790 | 49.5 ± 3.33 | 1673.8 ± 0.14 | 95% | 23% | Nephropathy negative |
| 306 | 2969 | 49.6 ± 3.05 | 1689.8 ± 0.18 | 86% | 0% | Nephropathy negative |
| 307 | 810 | 26.9 ± 3.18 | 1706.8 ± 0.30 | 78% | 27% | Nephropathy negative |
| 308 | 3203 | 49.4 ± 2.84 | 1734.4 ± 0.40 | 65% | 5% | Nephropathy negative |
| 309 | 4983 | 49.2 ± 3.17 | 1739.7 ± 0.22 | 59% | 5% | Nephropathy negative |
| 310 | 3212 | 45.1 ± 4.21 | 1748.0 ± 0.28 | 55% | 5% | Nephropathy negative |
| 311 | 5032 | 44.2 ± 4.71 | 1813.6 ± 0.38 | 58% | 5% | Nephropathy negative |
| 312 | 874 | 39.1 ± 3.48 | 1817.0 ± 0.29 | 85% | 18% | Nephropathy negative |
| 313 | 3272 | 51.7 ± 3.48 | 1841.0 ± 0.23 | 59% | 9% | Nephropathy negative |
| 314 | 3277 | 50.4 ± 4.56 | 1848.2 ± 0.43 | 58% | 0% | Nephropathy negative |
| 315 | 5059 | 51.5 ± 2.94 | 1856.8 ± 0.24 | 59% | 5% | Nephropathy negative |
| 316 | 3285 | 52.7 ± 4.24 | 1863.8 ± 0.31 | 88% | 14% | Nephropathy negative |
| 317 | 914 | 52.7 ± 3.92 | 1885.8 ± 0.20 | 70% | 5% | Nephropathy negative |
| 318 | 3108 | 47.7 ± 4.69 | 1902.1 ± 0.33 | 75% | 0% | Nephropathy negative |
| 319 | 3120 | 50.6 ± 3.95 | 1924.0 ± 0.48 | 68% | 0% | Nephropathy negative |
| 320 | 981 | 26.6 ± 1.76 | 2048.5 ± 0.44 | 86% | 20% | Nephropathy negative |
| 321 | 3415 | 25.8 ± 1.39 | 2085.9 ± 0.24 | 83% | 32% | Nephropathy negative |
| 322 | 3416 | 39.9 ± 1.45 | 2087.8 ± 0.34 | 72% | 23% | Nephropathy negative |
| 323 | 5214 | 52.8 ± 4.09 | 2117.1 ± 0.17 | 78% | 9% | Nephropathy negative |
| 324 | 1020 | 28.3 ± 3.90 | 2129.7 ± 0.42 | 63% | 0% | Nephropathy negative |
| 325 | 3456 | 40.4 ± 1.53 | 2158.9 ± 0.26 | 86% | 32% | Nephropathy negative |
| 326 | 3465 | 39.7 ± 1.71 | 2174.9 ± 0.36 | 97% | 45% | Nephropathy negative |
| 327 | 3491 | 32.6 ± 1.79 | 2227.1 ± 0.41 | 81% | 23% | Nephropathy negative |
| 328 | 1086 | 29.3 ± 3.50 | 2249.0 ± 0.41 | 92% | 41% | Nephropathy negative |
| 329 | 3506 | 40.6 ± 1.25 | 2257.1 ± 0.35 | 94% | 45% | Nephropathy negative |
| 330 | 1097 | 46.2 ± 5.11 | 2273.5 ± 0.38 | 71% | 18% | Nephropathy negative |
| 331 | 1094 | 40.8 ± 2.66 | 2296.0 ± 0.40 | 63% | 20% | Nephropathy negative |
| 332 | 1121 | 40.9 ± 3.32 | 2327.6 ± 0.52 | 85% | 36% | Nephropathy negative |
| 333 | 3551 | 41.8 ± 2.45 | 2343.3 ± 0.43 | 77% | 27% | Nephropathy negative |
| 334 | 3574 | 40.8 ± 1.31 | 2385.3 ± 0.32 | 95% | 45% | Nephropathy negative |
| 335 | 1185 | 40.9 ± 2.68 | 2471.5 ± 0.52 | 69% | 14% | Nephropathy negative |
| 336 | 1193 | 41.5 ± 2.64 | 2493.5 ± 0.48 | 74% | 18% | Nephropathy negative |
| 337 | 5432 | 52.9 ± 3.98 | 2570.4 ± 0.27 | 71% | 5% | Nephropathy negative |
| 338 | 3697 | 34.1 ± 0.72 | 2642.8 ± 0.40 | 86% | 36% | Nephropathy negative |
| 339 | 1268 | 36.1 ± 2.56 | 2687.1 ± 0.49 | 84% | 23% | Nephropathy negative |
| 340 | 1276 | 42.8 ± 2.33 | 2710.6 ± 0.46 | 88% | 18% | Nephropathy negative |
| 341 | 5506 | 50.6 ± 4.73 | 2748.6 ± 0.36 | 64% | 0% | Nephropathy negative |
| 342 | 1371 | 37.8 ± 1.92 | 2986.6 ± 0.55 | 74% | 23% | Nephropathy negative |
| 343 | 1379 | 23.3 ± 2.07 | 3007.4 ± 0.50 | 65% | 9% | Nephropathy negative |
| 344 | 1385 | 25.9 ± 2.35 | 3038.3 ± 0.70 | 46% | 0% | Nephropathy negative |
| 345 | 3868 | 46.0 ± 2.91 | 3045.4 ± 0.36 | 59% | 5% | Nephropathy negative |
| 346 | 5624 | 53.3 ± 4.05 | 3057.2 ± 0.64 | 76% | 9% | Nephropathy negative |
| 347 | 1411 | 38.9 ± 2.57 | 3109.0 ± 0.57 | 88% | 14% | Nephropathy negative |
| 348 | 1435 | 41.9 ± 3.55 | 3187.6 ± 0.47 | 71% | 14% | Nephropathy negative |
| 349 | 1437 | 26.6 ± 1.15 | 3193.6 ± 0.41 | 61% | 0% | Nephropathy negative |
| 350 | 5681 | 48.3 ± 3.69 | 3223.8 ± 0.41 | 88% | 18% | Nephropathy negative |
| 351 | 1458 | 31.7 ± 3.65 | 3265.1 ± 0.64 | 93% | 41% | Nephropathy negative |
| 352 | 1465 | 29.5 ± 1.76 | 3291.0 ± 0.52 | 81% | 23% | Nephropathy negative |
| 353 | 1466 | 49.2 ± 3.70 | 3293.1 ± 0.43 | 91% | 14% | Nephropathy negative |
| 354 | 3968 | 49.9 ± 3.57 | 3315.0 ± 0.45 | 67% | 5% | Nephropathy negative |
| 355 | 3969 | 43.3 ± 2.04 | 3319.9 ± 0.66 | 86% | 23% | Nephropathy negative |
| 356 | 3976 | 49.1 ± 3.35 | 3336.7 ± 0.38 | 63% | 9% | Nephropathy negative |
| 357 | 1486 | 38.5 ± 2.05 | 3359.9 ± 0.42 | 98% | 41% | Nephropathy negative |
| 358 | 1491 | 38.5 ± 1.92 | 3360.1 ± 0.65 | 98% | 20% | Nephropathy negative |
| 359 | 1505 | 38.5 ± 2.03 | 3417.1 ± 0.48 | 95% | 45% | Nephropathy negative |
| 360 | 1510 | 38.5 ± 1.09 | 3433.3 ± 0.43 | 92% | 41% | Nephropathy negative |
| 361 | 1525 | 51.6 ± 3.50 | 3478.9 ± 0.48 | 74% | 5% | Nephropathy negative |
| 362 | 1558 | 31.7 ± 2.29 | 3589.7 ± 0.48 | 73% | 18% | Nephropathy negative |
| 363 | 1570 | 33.2 ± 3.71 | 3633.4 ± 0.95 | 80% | 18% | Nephropathy negative |
| 364 | 1571 | 36.0 ± 3.18 | 3636.6 ± 0.73 | 58% | 0% | Nephropathy negative |
| 365 | 1597 | 37.9 ± 2.69 | 3719.5 ± 0.61 | 67% | 9% | Nephropathy negative |
| 366 | 1603 | 42.0 ± 3.21 | 3739.7 ± 0.99 | 73% | 14% | Nephropathy negative |
| 367 | 1659 | 25.8 ± 1.20 | 3947.3 ± 0.67 | 92% | 32% | Nephropathy negative |
| 368 | 4169 | 39.4 ± 1.13 | 4006.6 ± 0.49 | 62% | 5% | Nephropathy negative |
| 369 | 1685 | 26.0 ± 3.97 | 4044.9 ± 0.56 | 78% | 14% | Nephropathy negative |
| 370 | 1693 | 30.5 ± 2.17 | 4070.4 ± 0.48 | 57% | 5% | Nephropathy negative |
| 371 | 1701 | 29.5 ± 0.93 | 4098.6 ± 0.52 | 86% | 32% | Nephropathy negative |
| 372 | 1702 | 34.3 ± 2.08 | 4102.5 ± 0.50 | 77% | 14% | Nephropathy negative |
| 373 | 1747 | 34.7 ± 0.63 | 4290.7 ± 0.52 | 76% | 18% | Nephropathy negative |
| 374 | 1771 | 23.5 ± 1.61 | 4405.8 ± 0.54 | 51% | 0% | Nephropathy negative |
| 375 | 1841 | 30.4 ± 1.31 | 4801.5 ± 1.06 | 65% | 0% | Nephropathy negative |
| 376 | 1856 | 32.4 ± 1.31 | 4863.8 ± 0.64 | 67% | 5% | Nephropathy negative |
| 377 | 1909 | 29.5 ± 2.25 | 5214.0 ± 1.29 | 51% | 0% | Nephropathy negative |
| 378 | 1994 | 33.0 ± 0.99 | 6172.0 ± 1.57 | 65% | 0% | Nephropathy negative |
| 379 | 2039 | 33.2 ± 0.75 | 6187.8 ± 0.75 | 95% | 45% | Nephropathy negative |
| 380 | 2292 | 23.8 ± 1.86 | 9869.7 ± 1.06 | 69% | 14% | Nephropathy negative |

21. A marker database for recognizing at least one pathological condition, the marker database comprising data records of a plurality of polypeptides linked with information about probabilities of occurrence and/or concentration of polypeptides for a pathological condition in samples of healthy and diseased subjects.

22. The marker database according to claim 21, wherein the polypeptides are defined by stating their related mass and their related retention time in capillary electrophoresis as can be established in capillary electrophoresis coupled to a mass spectrometer.

23. The marker database according to claim 22, wherein the data base for the diagnosis “diabetes” includes at least one, a subset, or all data records of the polypeptides according to the following Table:

| No. | ID | Time [min] | Mass [Da] | % healthy | % diseased | Type |
|---|---|---|---|---|---|---|
| 1 | 36 | 22.9 ± 3.05 | 834.5 ± 0.10 | 3% | 54% | Diabetes positive |
| 2 | 73 | 22.9 ± 3.03 | 869.4 ± 0.17 | 14% | 63% | Diabetes positive |
| 3 | 2295 | 24.2 ± 1.89 | 874.5 ± 0.09 | 28% | 66% | Diabetes positive |
| 4 | 109 | 22.2 ± 2.19 | 907.5 ± 0.13 | 0% | 41% | Diabetes positive |
| 5 | 122 | 29.0 ± 2.35 | 910.5 ± 0.09 | 15% | 47% | Diabetes positive |
| 6 | 150 | 22.9 ± 3.18 | 947.6 ± 0.22 | 17% | 51% | Diabetes positive |
| 7 | 165 | 26.8 ± 2.98 | 950.5 ± 0.12 | 0% | 24% | Diabetes positive |
| 8 | 215 | 23.2 ± 4.87 | 995.6 ± 0.14 | 23% | 50% | Diabetes positive |
| 9 | 287 | 27.4 ± 3.59 | 1082.6 ± 0.16 | 0% | 44% | Diabetes positive |
| 10 | 301 | 32.3 ± 1.99 | 1096.5 ± 0.14 | 10% | 51% | Diabetes positive |
| 11 | 381 | 26.8 ± 3.85 | 1176.6 ± 0.13 | 21% | 59% | Diabetes positive |
| 12 | 2598 | 22.3 ± 3.45 | 1222.8 ± 0.22 | 17% | 56% | Diabetes positive |
| 13 | 438 | 30.6 ± 3.31 | 1236.6 ± 0.11 | 24% | 59% | Diabetes positive |
| 14 | 4246 | 52.6 ± 4.80 | 1285.0 ± 0.09 | 14% | 54% | Diabetes positive |
| 15 | 543 | 28.8 ± 3.98 | 1332.7 ± 0.20 | 23% | 55% | Diabetes positive |
| 16 | 4694 | 49.8 ± 4.72 | 1332.8 ± 0.16 | 8% | 38% | Diabetes positive |
| 17 | 544 | 26.7 ± 2.79 | 1355.8 ± 0.15 | 17% | 56% | Diabetes positive |
| 18 | 589 | 24.6 ± 2.84 | 1386.8 ± 0.14 | 53% | 77% | Diabetes positive |
| 19 | 602 | 26.8 ± 3.26 | 1403.7 ± 0.21 | 8% | 46% | Diabetes positive |
| 20 | 584 | 17.8 ± 4.12 | 1405.9 ± 0.15 | 14% | 56% | Diabetes positive |
| 21 | 635 | 31.5 ± 3.71 | 1442.7 ± 0.27 | 15% | 55% | Diabetes positive |
| 22 | 618 | 32.1 ± 3.38 | 1449.8 ± 0.14 | 41% | 85% | Diabetes positive |
| 23 | 722 | 31.3 ± 5.27 | 1592.4 ± 0.38 | 3% | 46% | Diabetes positive |
| 24 | 3234 | 43.4 ± 4.41 | 1783.4 ± 0.30 | 33% | 63% | Diabetes positive |
| 25 | 858 | 29.4 ± 3.08 | 1789.2 ± 0.39 | 28% | 75% | Diabetes positive |
| 26 | 3259 | 38.4 ± 1.09 | 1818.9 ± 0.21 | 28% | 67% | Diabetes positive |
| 27 | 3058 | 37.7 ± 1.04 | 1821.4 ± 0.39 | 14% | 56% | Diabetes positive |
| 28 | 882 | 24.4 ± 2.55 | 1829.2 ± 0.23 | 45% | 81% | Diabetes positive |
| 29 | 5462 | 51.1 ± 4.11 | 1854.7 ± 0.41 | 14% | 54% | Diabetes positive |
| 30 | 3281 | 37.6 ± 3.30 | 1856.8 ± 0.48 | 33% | 56% | Diabetes positive |
| 31 | 906 | 24.7 ± 2.63 | 1872.9 ± 0.35 | 43% | 72% | Diabetes positive |
| 32 | 930 | 28.3 ± 3.47 | 1949.5 ± 0.32 | 17% | 73% | Diabetes positive |
| 33 | 949 | 31.6 ± 2.90 | 1955.1 ± 0.32 | 55% | 79% | Diabetes positive |
| 34 | 957 | 31.3 ± 3.00 | 1971.0 ± 0.45 | 20% | 54% | Diabetes positive |
| 35 | 988 | 37.8 ± 2.40 | 2032.0 ± 0.30 | 25% | 60% | Diabetes positive |
| 36 | 1001 | 30.9 ± 4.69 | 2061.4 ± 0.58 | 10% | 38% | Diabetes positive |
| 37 | 1016 | 33.8 ± 3.76 | 2092.2 ± 0.46 | 18% | 45% | Diabetes positive |
| 38 | 1059 | 27.7 ± 4.43 | 2185.6 ± 0.46 | 10% | 36% | Diabetes positive |
| 39 | 3271 | 32.9 ± 1.48 | 2189.4 ± 0.34 | 14% | 54% | Diabetes positive |
| 40 | 3492 | 39.6 ± 5.31 | 2229.4 ± 0.48 | 5% | 39% | Diabetes positive |
| 41 | 1078 | 24.5 ± 5.14 | 2229.9 ± 0.33 | 25% | 63% | Diabetes positive |
| 42 | 1197 | 28.3 ± 3.30 | 2502.9 ± 0.56 | 20% | 48% | Diabetes positive |
| 43 | 1243 | 24.9 ± 4.84 | 2621.6 ± 0.97 | 20% | 45% | Diabetes positive |
| 44 | 3710 | 37.5 ± 4.52 | 2669.8 ± 0.39 | 23% | 67% | Diabetes positive |
| 45 | 5507 | 20.8 ± 4.47 | 2752.2 ± 0.76 | 35% | 64% | Diabetes positive |
| 46 | 1304 | 24.9 ± 4.31 | 2795.7 ± 0.96 | 13% | 40% | Diabetes positive |
| 47 | 5687 | 48.2 ± 3.61 | 3246.1 ± 0.43 | 0% | 30% | Diabetes positive |
| 48 | 1629 | 20.9 ± 3.33 | 3844.0 ± 0.52 | 3% | 54% | Diabetes positive |
| 49 | 1869 | 21.9 ± 2.62 | 4961.5 ± 0.89 | 10% | 40% | Diabetes positive |
| 50 | 1950 | 18.6 ± 2.91 | 5497.0 ± 0.66 | 18% | 42% | Diabetes positive |
| 51 | 12 | 20.4 ± 2.20 | 808.4 ± 0.10 | 58% | 9% | Diabetes negative |
| 52 | 108 | 45.3 ± 2.03 | 897.5 ± 0.09 | 48% | 7% | Diabetes negative |
| 53 | 143 | 31.4 ± 1.08 | 929.5 ± 0.11 | 98% | 46% | Diabetes negative |
| 54 | 2533 | 41.2 ± 1.41 | 946.4 ± 0.10 | 85% | 36% | Diabetes negative |
| 55 | 2565 | 28.0 ± 1.04 | 980.5 ± 0.07 | 85% | 31% | Diabetes negative |
| 56 | 220 | 26.7 ± 2.26 | 1000.5 ± 0.09 | 83% | 41% | Diabetes negative |
| 57 | 228 | 27.8 ± 1.51 | 1008.5 ± 0.10 | 95% | 41% | Diabetes negative |
| 58 | 232 | 29.3 ± 2.55 | 1012.5 ± 0.10 | 63% | 17% | Diabetes negative |
| 59 | 2627 | 43.6 ± 2.03 | 1047.5 ± 0.11 | 90% | 26% | Diabetes negative |
| 60 | 5947 | 25.0 ± 3.91 | 1052.6 ± 0.08 | 45% | 4% | Diabetes negative |
| 61 | 286 | 37.4 ± 5.63 | 1066.5 ± 0.14 | 58% | 13% | Diabetes negative |
| 62 | 295 | 22.8 ± 1.78 | 1075.5 ± 0.13 | 68% | 26% | Diabetes negative |
| 63 | 309 | 28.9 ± 3.89 | 1088.6 ± 0.15 | 65% | 21% | Diabetes negative |
| 64 | 2681 | 44.4 ± 2.06 | 1106.5 ± 0.11 | 80% | 18% | Diabetes negative |
| 65 | 328 | 34.1 ± 1.80 | 1107.5 ± 0.10 | 88% | 35% | Diabetes negative |
| 66 | 342 | 42.8 ± 3.26 | 1120.5 ± 0.06 | 60% | 14% | Diabetes negative |
| 67 | 356 | 29.1 ± 2.26 | 1134.6 ± 0.10 | 95% | 49% | Diabetes negative |
| 68 | 359 | 28.2 ± 3.00 | 1137.7 ± 0.11 | 70% | 24% | Diabetes negative |
| 69 | 344 | 45.5 ± 2.34 | 1139.5 ± 0.20 | 83% | 22% | Diabetes negative |
| 70 | 381 | 32.9 ± 1.25 | 1159.6 ± 0.11 | 80% | 27% | Diabetes negative |
| 71 | 401 | 23.3 ± 4.17 | 1180.5 ± 0.16 | 50% | 9% | Diabetes negative |
| 72 | 421 | 43.8 ± 2.08 | 1200.6 ± 0.11 | 95% | 50% | Diabetes negative |
| 73 | 425 | 27.2 ± 3.22 | 1204.6 ± 0.17 | 60% | 17% | Diabetes negative |
| 74 | 6860 | 44.9 ± 2.53 | 1209.5 ± 0.09 | 83% | 17% | Diabetes negative |
| 75 | 2793 | 47.8 ± 2.73 | 1224.6 ± 0.12 | 75% | 19% | Diabetes negative |
| 76 | 464 | 25.6 ± 2.43 | 1246.7 ± 0.15 | 73% | 30% | Diabetes negative |
| 77 | 2833 | 47.9 ± 2.66 | 1268.6 ± 0.09 | 68% | 25% | Diabetes negative |
| 78 | 2840 | 43.9 ± 1.80 | 1277.5 ± 0.10 | 70% | 28% | Diabetes negative |
| 79 | 2841 | 46.0 ± 2.69 | 1278.5 ± 0.09 | 58% | 10% | Diabetes negative |
| 80 | 2651 | 33.1 ± 1.82 | 1282.6 ± 0.13 | 62% | 7% | Diabetes negative |
| 81 | 2893 | 29.3 ± 3.88 | 1331.7 ± 0.18 | 65% | 12% | Diabetes negative |
| 82 | 2959 | 45.9 ± 4.78 | 1405.5 ± 0.33 | 93% | 45% | Diabetes negative |
| 83 | 620 | 44.4 ± 3.90 | 1423.6 ± 0.16 | 60% | 20% | Diabetes negative |
| 84 | 663 | 19.2 ± 3.40 | 1484.8 ± 0.19 | 68% | 13% | Diabetes negative |
| 85 | 3114 | 36.9 ± 2.02 | 1609.6 ± 0.13 | 85% | 13% | Diabetes negative |
| 86 | 3136 | 38.9 ± 3.78 | 1639.7 ± 0.27 | 63% | 19% | Diabetes negative |
| 87 | 769 | 33.2 ± 3.34 | 1662.9 ± 0.21 | 62% | 5% | Diabetes negative |
| 88 | 770 | 35.8 ± 2.19 | 1664.6 ± 0.29 | 66% | 10% | Diabetes negative |
| 89 | 785 | 36.2 ± 4.78 | 1666.6 ± 0.34 | 75% | 29% | Diabetes negative |
| 90 | 3165 | 35.9 ± 2.98 | 1678.1 ± 0.44 | 60% | 18% | Diabetes negative |
| 91 | 3192 | 37.3 ± 2.99 | 1716.8 ± 0.23 | 73% | 19% | Diabetes negative |
| 92 | 2988 | 46.5 ± 4.38 | 1717.5 ± 0.37 | 79% | 15% | Diabetes negative |
| 93 | 832 | 37.9 ± 4.18 | 1746.0 ± 0.33 | 83% | 34% | Diabetes negative |
| 94 | 3258 | 25.1 ± 2.25 | 1817.6 ± 0.27 | 65% | 8% | Diabetes negative |
| 95 | 878 | 34.2 ± 3.95 | 1823.4 ± 0.47 | 73% | 30% | Diabetes negative |
| 96 | 894 | 29.1 ± 3.59 | 1849.8 ± 0.30 | 100% | 56% | Diabetes negative |
| 97 | 3314 | 49.3 ± 4.49 | 1914.1 ± 0.36 | 88% | 38% | Diabetes negative |
| 98 | 3117 | 44.2 ± 4.23 | 1916.7 ± 0.33 | 69% | 10% | Diabetes negative |
| 99 | 3383 | 39.8 ± 2.19 | 2030.8 ± 0.35 | 93% | 38% | Diabetes negative |
| 100 | 5215 | 31.9 ± 1.61 | 2118.9 ± 0.21 | 73% | 14% | Diabetes negative |
| 101 | 1056 | 41.2 ± 2.45 | 2179.3 ± 0.42 | 58% | 17% | Diabetes negative |
| 102 | 5269 | 20.1 ± 2.78 | 2219.0 ± 0.26 | 53% | 13% | Diabetes negative |
| 103 | 1090 | 25.8 ± 2.70 | 2256.9 ± 0.47 | 85% | 26% | Diabetes negative |
| 104 | 3314 | 45.1 ± 5.23 | 2273.4 ± 0.42 | 79% | 22% | Diabetes negative |
| 105 | 3317 | 40.7 ± 1.90 | 2279.0 ± 0.33 | 90% | 20% | Diabetes negative |
| 106 | 1117 | 26.8 ± 3.73 | 2320.2 ± 0.55 | 78% | 34% | Diabetes negative |
| 107 | 1123 | 23.6 ± 3.10 | 2332.2 ± 0.35 | 53% | 11% | Diabetes negative |
| 108 | 1129 | 44.5 ± 3.08 | 2345.6 ± 0.46 | 75% | 34% | Diabetes negative |
| 109 | 1146 | 25.7 ± 5.16 | 2384.5 ± 0.63 | 65% | 21% | Diabetes negative |
| 110 | 3592 | 38.5 ± 3.62 | 2423.9 ± 0.41 | 88% | 29% | Diabetes negative |
| 111 | 3595 | 34.2 ± 2.92 | 2429.9 ± 0.51 | 65% | 18% | Diabetes negative |
| 112 | 3398 | 23.3 ± 2.54 | 2443.3 ± 0.46 | 66% | 5% | Diabetes negative |
| 113 | 3446 | 41.7 ± 3.72 | 2548.1 ± 0.57 | 69% | 15% | Diabetes negative |
| 114 | 1215 | 27.3 ± 4.77 | 2548.3 ± 0.66 | 83% | 35% | Diabetes negative |
| 115 | 5421 | 43.6 ± 2.08 | 2548.3 ± 0.23 | 95% | 41% | Diabetes negative |
| 116 | 1227 | 24.0 ± 3.11 | 2581.5 ± 0.47 | 60% | 13% | Diabetes negative |
| 117 | 1230 | 24.0 ± 2.70 | 2587.4 ± 0.40 | 80% | 26% | Diabetes negative |
| 118 | 1238 | 41.7 ± 3.06 | 2606.8 ± 0.55 | 78% | 35% | Diabetes negative |
| 119 | 1237 | 31.3 ± 4.92 | 2636.4 ± 0.48 | 72% | 12% | Diabetes negative |
| 120 | 1253 | 25.5 ± 3.62 | 2644.2 ± 0.41 | 88% | 33% | Diabetes negative |
| 121 | 1244 | 29.2 ± 1.07 | 2654.0 ± 0.37 | 66% | 0% | Diabetes negative |
| 122 | 1272 | 29.8 ± 3.50 | 2698.2 ± 0.63 | 90% | 29% | Diabetes negative |
| 123 | 1266 | 43.0 ± 2.26 | 2710.5 ± 0.37 | 79% | 5% | Diabetes negative |
| 124 | 3749 | 25.1 ± 1.64 | 2761.3 ± 0.35 | 88% | 44% | Diabetes negative |
| 125 | 1301 | 31.3 ± 2.79 | 2808.5 ± 0.56 | 79% | 22% | Diabetes negative |
| 126 | 1326 | 42.0 ± 3.22 | 2876.5 ± 0.48 | 62% | 7% | Diabetes negative |
| 127 | 1342 | 33.7 ± 3.34 | 2898.7 ± 0.50 | 85% | 43% | Diabetes negative |
| 128 | 3595 | 42.2 ± 2.68 | 2908.1 ± 0.53 | 72% | 17% | Diabetes negative |
| 129 | 3598 | 35.4 ± 2.63 | 2917.6 ± 0.58 | 72% | 12% | Diabetes negative |
| 130 | 3843 | 35.4 ± 0.77 | 2978.1 ± 0.49 | 85% | 35% | Diabetes negative |
| 131 | 3849 | 36.1 ± 1.42 | 2994.6 ± 0.80 | 83% | 24% | Diabetes negative |
| 132 | 1380 | 43.5 ± 2.99 | 3023.4 ± 0.65 | 93% | 34% | Diabetes negative |
| 133 | 1388 | 44.4 ± 3.35 | 3045.2 ± 0.61 | 69% | 12% | Diabetes negative |
| 134 | 1398 | 22.9 ± 3.47 | 3076.4 ± 0.96 | 66% | 7% | Diabetes negative |
| 135 | 1404 | 35.7 ± 1.99 | 3082.3 ± 0.43 | 73% | 22% | Diabetes negative |
| 136 | 1419 | 33.6 ± 3.53 | 3136.8 ± 0.61 | 95% | 47% | Diabetes negative |
| 137 | 1425 | 21.7 ± 3.14 | 3154.8 ± 0.44 | 55% | 10% | Diabetes negative |
| 138 | 1437 | 26.5 ± 1.92 | 3193.7 ± 0.53 | 78% | 32% | Diabetes negative |
| 139 | 1441 | 24.4 ± 3.02 | 3206.3 ± 0.72 | 66% | 7% | Diabetes negative |
| 140 | 1454 | 28.2 ± 2.80 | 3250.9 ± 0.71 | 63% | 18% | Diabetes negative |
| 141 | 1469 | 48.2 ± 3.46 | 3293.2 ± 0.74 | 93% | 39% | Diabetes negative |
| 142 | 1467 | 31.4 ± 1.60 | 3295.7 ± 0.33 | 95% | 40% | Diabetes negative |
| 143 | 1479 | 27.2 ± 3.58 | 3338.4 ± 0.79 | 80% | 34% | Diabetes negative |
| 144 | 1495 | 37.3 ± 2.11 | 3381.6 ± 0.63 | 78% | 26% | Diabetes negative |
| 145 | 1517 | 27.6 ± 2.49 | 3452.1 ± 0.49 | 58% | 15% | Diabetes negative |
| 146 | 1523 | 37.3 ± 1.50 | 3463.0 ± 0.83 | 72% | 15% | Diabetes negative |
| 147 | 1556 | 19.6 ± 2.89 | 3583.4 ± 0.75 | 79% | 20% | Diabetes negative |
| 148 | 1571 | 34.0 ± 2.55 | 3634.4 ± 0.74 | 86% | 29% | Diabetes negative |
| 149 | 4086 | 37.7 ± 2.61 | 3681.8 ± 1.38 | 55% | 14% | Diabetes negative |
| 150 | 1586 | 25.5 ± 2.25 | 3686.2 ± 0.60 | 86% | 20% | Diabetes negative |
| 151 | 1602 | 36.0 ± 3.89 | 3735.7 ± 0.57 | 70% | 28% | Diabetes negative |
| 152 | 1634 | 30.3 ± 1.58 | 3852.3 ± 0.56 | 83% | 41% | Diabetes negative |
| 153 | 3920 | 29.6 ± 1.46 | 4098.4 ± 0.59 | 93% | 20% | Diabetes negative |
| 154 | 1942 | 28.8 ± 1.18 | 5428.8 ± 0.67 | 70% | 19% | Diabetes negative |
| 155 | 1995 | 33.1 ± 0.69 | 6187.5 ± 1.13 | 83% | 10% | Diabetes negative |
| 156 | 4309 | 26.0 ± 4.82 | 6212.0 ± 1.41 | 75% | 26% | Diabetes negative |
| 157 | 2160 | 23.3 ± 2.19 | 9868.8 ± 1.33 | 66% | 0% | Diabetes negative |

24. The marker database according to claim 22, wherein the data base for the diagnosis “kidney damage” includes at least one, a subset, or all data records of the polypeptides according to the following Table:

| No. | ID | Time [min] | Mass [Da] | % healthy | % diseased | Type |
|---|---|---|---|---|---|---|
| 158 | 32 | 21.7 ± 5.12 | 830.5 ± 0.11 | 4% | 40% | Nephropathy positive |
| 159 | 69 | 32.4 ± 1.83 | 866.4 ± 0.11 | 0% | 40% | Nephropathy positive |
| 160 | 111 | 30.6 ± 3.07 | 909.5 ± 0.13 | 11% | 40% | Nephropathy positive |
| 161 | 152 | 32.8 ± 3.14 | 937.5 ± 0.11 | 14% | 73% | Nephropathy positive |
| 162 | 155 | 24.9 ± 2.97 | 952.5 ± 0.16 | 11% | 40% | Nephropathy positive |
| 163 | 238 | 32.1 ± 2.44 | 1033.5 ± 0.11 | 5% | 40% | Nephropathy positive |
| 164 | 280 | 24.4 ± 2.87 | 1060.6 ± 0.16 | 17% | 68% | Nephropathy positive |
| 165 | 353 | 27.5 ± 2.86 | 1131.6 ± 0.16 | 20% | 68% | Nephropathy positive |
| 166 | 402 | 33.4 ± 3.48 | 1181.6 ± 0.15 | 22% | 73% | Nephropathy positive |
| 167 | 424 | 33.0 ± 2.52 | 1203.6 ± 0.14 | 9% | 50% | Nephropathy positive |
| 168 | 2586 | 26.5 ± 3.68 | 1211.6 ± 0.14 | 14% | 40% | Nephropathy positive |
| 169 | 2595 | 33.1 ± 0.91 | 1219.6 ± 0.15 | 18% | 40% | Nephropathy positive |
| 170 | 2601 | 32.8 ± 3.30 | 1225.6 ± 0.13 | 12% | 40% | Nephropathy positive |
| 171 | 510 | 30.7 ± 3.18 | 1297.7 ± 0.20 | 31% | 82% | Nephropathy positive |
| 172 | 526 | 34.1 ± 2.05 | 1333.7 ± 0.23 | 9% | 40% | Nephropathy positive |
| 173 | 2898 | 44.7 ± 4.06 | 1337.5 ± 0.20 | 19% | 59% | Nephropathy positive |
| 174 | 2955 | 27.9 ± 4.19 | 1398.8 ± 0.36 | 29% | 77% | Nephropathy positive |
| 175 | 2975 | 21.3 ± 5.08 | 1423.7 ± 0.49 | 6% | 50% | Nephropathy positive |
| 176 | 633 | 28.1 ± 4.95 | 1439.8 ± 0.19 | 19% | 68% | Nephropathy positive |
| 177 | 651 | 24.5 ± 2.42 | 1466.0 ± 0.27 | 9% | 77% | Nephropathy positive |
| 178 | 641 | 27.5 ± 4.93 | 1482.0 ± 0.42 | 33% | 40% | Nephropathy positive |
| 179 | 642 | 29.8 ± 4.43 | 1482.9 ± 0.28 | 18% | 40% | Nephropathy positive |
| 180 | 662 | 24.3 ± 2.65 | 1483.7 ± 0.28 | 26% | 91% | Nephropathy positive |
| 181 | 675 | 24.6 ± 1.98 | 1500.0 ± 0.20 | 38% | 86% | Nephropathy positive |
| 182 | 711 | 24.6 ± 2.90 | 1553.1 ± 0.28 | 14% | 64% | Nephropathy positive |
| 183 | 713 | 29.0 ± 4.83 | 1556.7 ± 0.45 | 26% | 73% | Nephropathy positive |
| 184 | 720 | 24.2 ± 2.48 | 1567.0 ± 0.22 | 26% | 86% | Nephropathy positive |
| 185 | 740 | 28.8 ± 4.53 | 1596.9 ± 0.31 | 21% | 86% | Nephropathy positive |
| 186 | 777 | 24.5 ± 2.43 | 1652.8 ± 0.25 | 14% | 59% | Nephropathy positive |
| 187 | 787 | 26.3 ± 2.63 | 1669.8 ± 0.37 | 20% | 64% | Nephropathy positive |
| 188 | 3200 | 33.1 ± 3.22 | 1729.2 ± 0.36 | 6% | 45% | Nephropathy positive |
| 189 | 3210 | 30.5 ± 4.11 | 1744.4 ± 0.46 | 16% | 59% | Nephropathy positive |
| 190 | 6963 | 25.1 ± 3.42 | 1754.4 ± 0.41 | 53% | 95% | Nephropathy positive |
| 191 | 3230 | 24.2 ± 1.56 | 1776.0 ± 0.27 | 9% | 50% | Nephropathy positive |
| 192 | 3036 | 18.5 ± 3.55 | 1791.0 ± 0.38 | 7% | 40% | Nephropathy positive |
| 193 | 843 | 32.2 ± 5.38 | 1792.9 ± 0.31 | 28% | 40% | Nephropathy positive |
| 194 | 3043 | 9.7 ± 2.54 | 1799.8 ± 0.29 | 0% | 40% | Nephropathy positive |
| 195 | 870 | 25.3 ± 2.89 | 1810.9 ± 0.38 | 43% | 91% | Nephropathy positive |
| 196 | 895 | 24.6 ± 2.34 | 1851.1 ± 0.21 | 43% | 95% | Nephropathy positive |
| 197 | 903 | 27.2 ± 4.46 | 1867.3 ± 0.42 | 38% | 91% | Nephropathy positive |
| 198 | 939 | 25.0 ± 3.97 | 1966.0 ± 0.53 | 16% | 40% | Nephropathy positive |
| 199 | 947 | 28.7 ± 3.08 | 1982.8 ± 0.57 | 11% | 40% | Nephropathy positive |
| 200 | 965 | 29.5 ± 5.53 | 1986.3 ± 0.36 | 15% | 64% | Nephropathy positive |
| 201 | 979 | 23.3 ± 4.46 | 2045.9 ± 0.32 | 32% | 40% | Nephropathy positive |
| 202 | 1013 | 33.7 ± 3.16 | 2115.1 ± 0.53 | 30% | 40% | Nephropathy positive |
| 203 | 3263 | 20.5 ± 2.78 | 2177.1 ± 0.37 | 9% | 40% | Nephropathy positive |
| 204 | 1083 | 18.1 ± 4.24 | 2241.6 ± 0.41 | 9% | 59% | Nephropathy positive |
| 205 | 1087 | 21.2 ± 2.49 | 2250.7 ± 0.38 | 23% | 64% | Nephropathy positive |
| 206 | 1091 | 27.5 ± 2.53 | 2258.7 ± 0.49 | 9% | 59% | Nephropathy positive |
| 207 | 1135 | 20.0 ± 3.30 | 2356.4 ± 0.41 | 13% | 59% | Nephropathy positive |
| 208 | 1149 | 28.1 ± 3.95 | 2391.4 ± 0.42 | 13% | 64% | Nephropathy positive |
| 209 | 1156 | 25.7 ± 4.85 | 2406.1 ± 0.57 | 20% | 77% | Nephropathy positive |
| 210 | 1163 | 22.8 ± 4.28 | 2423.2 ± 0.53 | 14% | 64% | Nephropathy positive |
| 211 | 1165 | 21.9 ± 4.45 | 2427.3 ± 0.40 | 31% | 91% | Nephropathy positive |
| 212 | 1182 | 19.2 ± 4.24 | 2465.1 ± 0.62 | 9% | 77% | Nephropathy positive |
| 213 | 5398 | 25.4 ± 5.25 | 2493.0 ± 0.38 | 9% | 50% | Nephropathy positive |
| 214 | 3627 | 19.5 ± 4.66 | 2494.0 ± 0.66 | 12% | 77% | Nephropathy positive |
| 215 | 5610 | 23.7 ± 4.27 | 2494.9 ± 0.49 | 7% | 40% | Nephropathy positive |
| 216 | 3640 | 24.4 ± 5.51 | 2522.0 ± 0.67 | 17% | 82% | Nephropathy positive |
| 217 | 1212 | 20.1 ± 3.61 | 2540.5 ± 0.54 | 14% | 68% | Nephropathy positive |
| 218 | 3673 | 22.3 ± 4.72 | 2593.5 ± 0.30 | 7% | 55% | Nephropathy positive |
| 219 | 1241 | 20.0 ± 4.87 | 2613.9 ± 0.83 | 14% | 55% | Nephropathy positive |
| 220 | 1272 | 35.1 ± 1.62 | 2726.5 ± 0.67 | 61% | 20% | Nephropathy positive |
| 221 | 1289 | 25.0 ± 4.39 | 2775.1 ± 0.56 | 12% | 40% | Nephropathy positive |
| 222 | 1303 | 21.8 ± 3.78 | 2790.7 ± 0.55 | 19% | 86% | Nephropathy positive |
| 223 | 1339 | 25.9 ± 3.30 | 2892.2 ± 0.50 | 9% | 50% | Nephropathy positive |
| 224 | 3819 | 16.8 ± 2.72 | 2919.0 ± 0.26 | 2% | 50% | Nephropathy positive |
| 225 | 1355 | 21.9 ± 3.23 | 2937.0 ± 0.49 | 13% | 86% | Nephropathy positive |
| 226 | 1362 | 20.0 ± 4.81 | 2958.8 ± 0.80 | 5% | 59% | Nephropathy positive |
| 227 | 1358 | 34.4 ± 2.72 | 2962.0 ± 0.54 | 12% | 20% | Nephropathy positive |
| 228 | 1393 | 28.9 ± 3.56 | 3059.7 ± 0.78 | 30% | 40% | Nephropathy positive |
| 229 | 1402 | 28.3 ± 5.96 | 3088.0 ± 0.79 | 7% | 20% | Nephropathy positive |
| 230 | 1494 | 26.1 ± 2.72 | 3369.2 ± 0.73 | 21% | 40% | Nephropathy positive |
| 231 | 1528 | 26.0 ± 2.89 | 3483.4 ± 0.95 | 30% | 40% | Nephropathy positive |
| 232 | 1719 | 24.5 ± 3.92 | 4183.3 ± 1.44 | 4% | 40% | Nephropathy positive |
| 233 | 1734 | 21.0 ± 5.35 | 4241.0 ± 0.62 | 29% | 73% | Nephropathy positive |
| 234 | 1761 | 23.4 ± 4.09 | 4370.2 ± 1.01 | 11% | 40% | Nephropathy positive |
| 235 | 1793 | 22.8 ± 2.94 | 4527.6 ± 0.67 | 1% | 45% | Nephropathy positive |
| 236 | 1825 | 21.7 ± 3.00 | 4713.6 ± 0.44 | 7% | 64% | Nephropathy positive |
| 237 | 2060 | 24.6 ± 3.73 | 7556.6 ± 1.55 | 2% | 40% | Nephropathy positive |
| 238 | 3994 | 16.7 ± 5.54 | 8055.1 ± 2.10 | 12% | 40% | Nephropathy positive |
| 239 | 2229 | 13.2 ± 5.19 | 8765.8 ± 0.96 | 37% | 82% | Nephropathy positive |
| 240 | 2252 | 15.3 ± 4.97 | 9181.0 ± 1.28 | 10% | 64% | Nephropathy positive |
| 241 | 2302 | 14.0 ± 4.20 | 10046.1 ± 0.96 | 21% | 77% | Nephropathy positive |
| 242 | 2180 | 18.7 ± 5.50 | 10208.0 ± 1.24 | 2% | 40% | Nephropathy positive |
| 243 | 2323 | 17.4 ± 4.02 | 10518.2 ± 1.10 | 23% | 64% | Nephropathy positive |
| 244 | 138 | 35.3 ± 5.04 | 924.5 ± 0.12 | 50% | 0% | Nephropathy negative |
| 245 | 142 | 43.1 ± 2.61 | 928.4 ± 0.08 | 65% | 14% | Nephropathy negative |
| 246 | 2541 | 45.7 ± 2.25 | 955.5 ± 0.14 | 60% | 5% | Nephropathy negative |
| 247 | 2594 | 23.8 ± 2.94 | 1010.6 ± 0.09 | 67% | 5% | Nephropathy negative |
| 248 | 248 | 31.2 ± 1.53 | 1028.5 ± 0.09 | 84% | 32% | Nephropathy negative |
| 249 | 2622 | 45.9 ± 2.27 | 1041.4 ± 0.10 | 57% | 0% | Nephropathy negative |
| 250 | 266 | 31.5 ± 1.98 | 1046.5 ± 0.09 | 87% | 32% | Nephropathy negative |
| 251 | 2440 | 43.4 ± 2.24 | 1047.5 ± 0.12 | 68% | 0% | Nephropathy negative |
| 252 | 2442 | 18.1 ± 4.34 | 1050.7 ± 0.12 | 60% | 0% | Nephropathy negative |
| 253 | 304 | 32.9 ± 3.03 | 1084.4 ± 0.11 | 69% | 18% | Nephropathy negative |
| 254 | 347 | 46.7 ± 2.63 | 1125.5 ± 0.12 | 63% | 9% | Nephropathy negative |
| 255 | 2731 | 46.3 ± 2.70 | 1157.5 ± 0.10 | 83% | 32% | Nephropathy negative |
| 256 | 2733 | 43.7 ± 1.70 | 1160.5 ± 0.07 | 72% | 18% | Nephropathy negative |
| 257 | 400 | 44.5 ± 3.67 | 1179.5 ± 0.09 | 97% | 36% | Nephropathy negative |
| 258 | 412 | 45.0 ± 2.24 | 1191.6 ± 0.09 | 60% | 9% | Nephropathy negative |
| 259 | 416 | 46.2 ± 2.59 | 1195.5 ± 0.10 | 98% | 32% | Nephropathy negative |
| 260 | 2575 | 44.2 ± 1.83 | 1200.6 ± 0.13 | 86% | 0% | Nephropathy negative |
| 261 | 442 | 45.9 ± 2.04 | 1223.5 ± 0.10 | 80% | 9% | Nephropathy negative |
| 262 | 441 | 44.5 ± 2.15 | 1239.6 ± 0.08 | 89% | 0% | Nephropathy negative |
| 263 | 2814 | 47.8 ± 3.08 | 1246.6 ± 0.11 | 60% | 5% | Nephropathy negative |
| 264 | 2821 | 46.8 ± 2.20 | 1254.7 ± 0.19 | 56% | 5% | Nephropathy negative |
| 265 | 478 | 43.2 ± 2.90 | 1261.5 ± 0.16 | 91% | 36% | Nephropathy negative |
| 266 | 479 | 48.6 ± 2.90 | 1262.5 ± 0.09 | 65% | 0% | Nephropathy negative |
| 267 | 476 | 43.9 ± 2.16 | 1277.6 ± 0.11 | 67% | 0% | Nephropathy negative |
| 268 | 502 | 36.7 ± 3.04 | 1288.7 ± 0.18 | 72% | 23% | Nephropathy negative |
| 269 | 2856 | 47.2 ± 3.17 | 1292.5 ± 0.14 | 67% | 18% | Nephropathy negative |
| 270 | 521 | 47.8 ± 2.58 | 1308.5 ± 0.09 | 66% | 0% | Nephropathy negative |
| 271 | 4687 | 48.2 ± 2.67 | 1321.6 ± 0.11 | 53% | 0% | Nephropathy negative |
| 272 | 533 | 34.8 ± 1.81 | 1321.7 ± 0.23 | 98% | 41% | Nephropathy negative |
| 273 | 559 | 46.0 ± 4.93 | 1351.7 ± 0.15 | 63% | 9% | Nephropathy negative |
| 274 | 2925 | 47.7 ± 2.99 | 1367.6 ± 0.14 | 97% | 23% | Nephropathy negative |
| 275 | 582 | 37.8 ± 2.93 | 1378.6 ± 0.16 | 87% | 36% | Nephropathy negative |
| 276 | 2946 | 47.5 ± 2.59 | 1389.7 ± 0.15 | 86% | 18% | Nephropathy negative |
| 277 | 2961 | 46.5 ± 2.28 | 1407.8 ± 0.20 | 79% | 9% | Nephropathy negative |
| 278 | 2768 | 44.6 ± 4.84 | 1422.1 ± 0.33 | 70% | 0% | Nephropathy negative |
| 279 | 598 | 45.4 ± 3.62 | 1423.8 ± 0.19 | 75% | 0% | Nephropathy negative |
| 280 | 2976 | 48.0 ± 2.97 | 1424.7 ± 0.16 | 95% | 18% | Nephropathy negative |
| 281 | 638 | 47.6 ± 3.40 | 1446.7 ± 0.16 | 92% | 23% | Nephropathy negative |
| 282 | 2998 | 46.5 ± 2.95 | 1450.4 ± 0.25 | 62% | 9% | Nephropathy negative |
| 283 | 3008 | 48.0 ± 2.95 | 1462.6 ± 0.17 | 97% | 9% | Nephropathy negative |
| 284 | 665 | 35.7 ± 1.90 | 1487.7 ± 0.15 | 70% | 18% | Nephropathy negative |
| 285 | 3031 | 47.8 ± 2.35 | 1490.6 ± 0.12 | 72% | 9% | Nephropathy negative |
| 286 | 3032 | 49.2 ± 2.77 | 1491.7 ± 0.12 | 81% | 14% | Nephropathy negative |
| 287 | 3043 | 49.0 ± 3.14 | 1507.8 ± 0.17 | 99% | 32% | Nephropathy negative |
| 288 | 3055 | 49.2 ± 2.86 | 1523.7 ± 0.11 | 97% | 18% | Nephropathy negative |
| 289 | 3059 | 48.6 ± 2.70 | 1529.7 ± 0.19 | 83% | 9% | Nephropathy negative |
| 290 | 3065 | 49.2 ± 3.26 | 1539.7 ± 0.19 | 98% | 23% | Nephropathy negative |
| 291 | 3070 | 49.0 ± 3.19 | 1545.7 ± 0.13 | 99% | 23% | Nephropathy negative |
| 292 | 3081 | 49.8 ± 2.76 | 1561.6 ± 0.19 | 90% | 18% | Nephropathy negative |
| 293 | 3085 | 48.4 ± 3.12 | 1567.7 ± 0.20 | 65% | 9% | Nephropathy negative |
| 294 | 3089 | 48.1 ± 2.66 | 1573.7 ± 0.27 | 63% | 5% | Nephropathy negative |
| 295 | 3092 | 48.5 ± 4.03 | 1577.8 ± 0.35 | 94% | 9% | Nephropathy negative |
| 296 | 2900 | 50.6 ± 3.40 | 1587.1 ± 0.34 | 65% | 0% | Nephropathy negative |
| 297 | 735 | 48.6 ± 2.68 | 1589.7 ± 0.14 | 86% | 18% | Nephropathy negative |
| 298 | 736 | 45.9 ± 3.83 | 1591.7 ± 0.30 | 79% | 18% | Nephropathy negative |
| 299 | 3105 | 49.3 ± 3.22 | 1594.8 ± 0.14 | 88% | 14% | Nephropathy negative |
| 300 | 3111 | 48.8 ± 2.78 | 1605.7 ± 0.13 | 73% | 18% | Nephropathy negative |
| 301 | 750 | 48.5 ± 2.81 | 1611.7 ± 0.14 | 73% | 5% | Nephropathy negative |
| 302 | 3134 | 46.3 ± 5.12 | 1636.4 ± 0.39 | 79% | 23% | Nephropathy negative |
| 303 | 3145 | 49.5 ± 3.37 | 1651.8 ± 0.19 | 99% | 23% | Nephropathy negative |
| 304 | 780 | 45.2 ± 5.96 | 1657.7 ± 0.23 | 60% | 5% | Nephropathy negative |
| 305 | 790 | 49.5 ± 3.33 | 1673.8 ± 0.14 | 95% | 23% | Nephropathy negative |
| 306 | 2969 | 49.6 ± 3.05 | 1689.8 ± 0.18 | 86% | 0% | Nephropathy negative |
| 307 | 810 | 26.9 ± 3.18 | 1706.8 ± 0.30 | 78% | 27% | Nephropathy negative |
| 308 | 3203 | 49.4 ± 2.84 | 1734.4 ± 0.40 | 65% | 5% | Nephropathy negative |
| 309 | 4983 | 49.2 ± 3.17 | 1739.7 ± 0.22 | 59% | 5% | Nephropathy negative |
| 310 | 3212 | 45.1 ± 4.21 | 1748.0 ± 0.28 | 55% | 5% | Nephropathy negative |
| 311 | 5032 | 44.2 ± 4.71 | 1813.6 ± 0.38 | 58% | 5% | Nephropathy negative |
| 312 | 874 | 39.1 ± 3.48 | 1817.0 ± 0.29 | 85% | 18% | Nephropathy negative |
| 313 | 3272 | 51.7 ± 3.48 | 1841.0 ± 0.23 | 59% | 9% | Nephropathy negative |
| 314 | 3277 | 50.4 ± 4.56 | 1848.2 ± 0.43 | 58% | 0% | Nephropathy negative |
| 315 | 5059 | 51.5 ± 2.94 | 1856.8 ± 0.24 | 59% | 5% | Nephropathy negative |
| 316 | 3285 | 52.7 ± 4.24 | 1863.8 ± 0.31 | 88% | 14% | Nephropathy negative |
| 317 | 914 | 52.7 ± 3.92 | 1885.8 ± 0.20 | 70% | 5% | Nephropathy negative |
| 318 | 3108 | 47.7 ± 4.69 | 1902.1 ± 0.33 | 75% | 0% | Nephropathy negative |
| 319 | 3120 | 50.6 ± 3.95 | 1924.0 ± 0.48 | 68% | 0% | Nephropathy negative |
| 320 | 981 | 26.6 ± 1.76 | 2048.5 ± 0.44 | 86% | 20% | Nephropathy negative |
| 321 | 3415 | 25.8 ± 1.39 | 2085.9 ± 0.24 | 83% | 32% | Nephropathy negative |
| 322 | 3416 | 39.9 ± 1.45 | 2087.8 ± 0.34 | 72% | 23% | Nephropathy negative |
| 323 | 5214 | 52.8 ± 4.09 | 2117.1 ± 0.17 | 78% | 9% | Nephropathy negative |
| 324 | 1020 | 28.3 ± 3.90 | 2129.7 ± 0.42 | 63% | 0% | Nephropathy negative |
| 325 | 3456 | 40.4 ± 1.53 | 2158.9 ± 0.26 | 86% | 32% | Nephropathy negative |
| 326 | 3465 | 39.7 ± 1.71 | 2174.9 ± 0.36 | 97% | 45% | Nephropathy negative |
| 327 | 3491 | 32.6 ± 1.79 | 2227.1 ± 0.41 | 81% | 23% | Nephropathy negative |
| 328 | 1086 | 29.3 ± 3.50 | 2249.0 ± 0.41 | 92% | 41% | Nephropathy negative |
| 329 | 3506 | 40.6 ± 1.25 | 2257.1 ± 0.35 | 94% | 45% | Nephropathy negative |
| 330 | 1097 | 46.2 ± 5.11 | 2273.5 ± 0.38 | 71% | 18% | Nephropathy negative |
| 331 | 1094 | 40.8 ± 2.66 | 2296.0 ± 0.40 | 63% | 20% | Nephropathy negative |
| 332 | 1121 | 40.9 ± 3.32 | 2327.6 ± 0.52 | 85% | 36% | Nephropathy negative |
| 333 | 3551 | 41.8 ± 2.45 | 2343.3 ± 0.43 | 77% | 27% | Nephropathy negative |
| 334 | 3574 | 40.8 ± 1.31 | 2385.3 ± 0.32 | 95% | 45% | Nephropathy negative |
| 335 | 1185 | 40.9 ± 2.68 | 2471.5 ± 0.52 | 69% | 14% | Nephropathy negative |
| 336 | 1193 | 41.5 ± 2.64 | 2493.5 ± 0.48 | 74% | 18% | Nephropathy negative |
| 337 | 5432 | 52.9 ± 3.98 | 2570.4 ± 0.27 | 71% | 5% | Nephropathy negative |
| 338 | 3697 | 34.1 ± 0.72 | 2642.8 ± 0.40 | 86% | 36% | Nephropathy negative |
| 339 | 1268 | 36.1 ± 2.56 | 2687.1 ± 0.49 | 84% | 23% | Nephropathy negative |
| 340 | 1276 | 42.8 ± 2.33 | 2710.6 ± 0.46 | 88% | 18% | Nephropathy negative |
| 341 | 5506 | 50.6 ± 4.73 | 2748.6 ± 0.36 | 64% | 0% | Nephropathy negative |
| 342 | 1371 | 37.8 ± 1.92 | 2986.6 ± 0.55 | 74% | 23% | Nephropathy negative |
| 343 | 1379 | 23.3 ± 2.07 | 3007.4 ± 0.50 | 65% | 9% | Nephropathy negative |
| 344 | 1385 | 25.9 ± 2.35 | 3038.3 ± 0.70 | 46% | 0% | Nephropathy negative |
| 345 | 3868 | 46.0 ± 2.91 | 3045.4 ± 0.36 | 59% | 5% | Nephropathy negative |
| 346 | 5624 | 53.3 ± 4.05 | 3057.2 ± 0.64 | 76% | 9% | Nephropathy negative |
| 347 | 1411 | 38.9 ± 2.57 | 3109.0 ± 0.57 | 88% | 14% | Nephropathy negative |
| 348 | 1435 | 41.9 ± 3.55 | 3187.6 ± 0.47 | 71% | 14% | Nephropathy negative |
| 349 | 1437 | 26.6 ± 1.15 | 3193.6 ± 0.41 | 61% | 0% | Nephropathy negative |
| 350 | 5681 | 48.3 ± 3.69 | 3223.8 ± 0.41 | 88% | 18% | Nephropathy negative |
| 351 | 1458 | 31.7 ± 3.65 | 3265.1 ± 0.64 | 93% | 41% | Nephropathy negative |
| 352 | 1465 | 29.5 ± 1.76 | 3291.0 ± 0.52 | 81% | 23% | Nephropathy negative |
| 353 | 1466 | 49.2 ± 3.70 | 3293.1 ± 0.43 | 91% | 14% | Nephropathy negative |
| 354 | 3968 | 49.9 ± 3.57 | 3315.0 ± 0.45 | 67% | 5% | Nephropathy negative |
| 355 | 3969 | 43.3 ± 2.04 | 3319.9 ± 0.66 | 86% | 23% | Nephropathy negative |
| 356 | 3976 | 49.1 ± 3.35 | 3336.7 ± 0.38 | 63% | 9% | Nephropathy negative |
| 357 | 1486 | 38.5 ± 2.05 | 3359.9 ± 0.42 | 98% | 41% | Nephropathy negative |
| 358 | 1491 | 38.5 ± 1.92 | 3360.1 ± 0.65 | 98% | 20% | Nephropathy negative |
| 359 | 1505 | 38.5 ± 2.03 | 3417.1 ± 0.48 | 95% | 45% | Nephropathy negative |
| 360 | 1510 | 38.5 ± 1.09 | 3433.3 ± 0.43 | 92% | 41% | Nephropathy negative |
| 361 | 1525 | 51.6 ± 3.50 | 3478.9 ± 0.48 | 74% | 5% | Nephropathy negative |
| 362 | 1558 | 31.7 ± 2.29 | 3589.7 ± 0.48 | 73% | 18% | Nephropathy negative |
| 363 | 1570 | 33.2 ± 3.71 | 3633.4 ± 0.95 | 80% | 18% | Nephropathy negative |
| 364 | 1571 | 36.0 ± 3.18 | 3636.6 ± 0.73 | 58% | 0% | Nephropathy negative |
| 365 | 1597 | 37.9 ± 2.69 | 3719.5 ± 0.61 | 67% | 9% | Nephropathy negative |
| 366 | 1603 | 42.0 ± 3.21 | 3739.7 ± 0.99 | 73% | 14% | Nephropathy negative |
| 367 | 1659 | 25.8 ± 1.20 | 3947.3 ± 0.67 | 92% | 32% | Nephropathy negative |
| 368 | 4169 | 39.4 ± 1.13 | 4006.6 ± 0.49 | 62% | 5% | Nephropathy negative |
| 369 | 1685 | 26.0 ± 3.97 | 4044.9 ± 0.56 | 78% | 14% | Nephropathy negative |
| 370 | 1693 | 30.5 ± 2.17 | 4070.4 ± 0.48 | 57% | 5% | Nephropathy negative |
| 371 | 1701 | 29.5 ± 0.93 | 4098.6 ± 0.52 | 86% | 32% | Nephropathy negative |
| 372 | 1702 | 34.3 ± 2.08 | 4102.5 ± 0.50 | 77% | 14% | Nephropathy negative |
| 373 | 1747 | 34.7 ± 0.63 | 4290.7 ± 0.52 | 76% | 18% | Nephropathy negative |
| 374 | 1771 | 23.5 ± 1.61 | 4405.8 ± 0.54 | 51% | 0% | Nephropathy negative |
| 375 | 1841 | 30.4 ± 1.31 | 4801.5 ± 1.06 | 65% | 0% | Nephropathy negative |
| 376 | 1856 | 32.4 ± 1.31 | 4863.8 ± 0.64 | 67% | 5% | Nephropathy negative |
| 377 | 1909 | 29.5 ± 2.25 | 5214.0 ± 1.29 | 51% | 0% | Nephropathy negative |
| 378 | 1994 | 33.0 ± 0.99 | 6172.0 ± 1.57 | 65% | 0% | Nephropathy negative |
| 379 | 2039 | 33.2 ± 0.75 | 6187.8 ± 0.75 | 95% | 45% | Nephropathy negative |
| 380 | 2292 | 23.8 ± 1.86 | 9869.7 ± 1.06 | 69% | 14% | Nephropathy negative |

25. At least one marker selected from the following table:

| No. | ID | Time [min] | Mass [Da] | % healthy | % diseased | Type |
|---|---|---|---|---|---|---|
| 1 | 36 | 22.9 ± 3.05 | 834.5 ± 0.10 | 3% | 54% | Diabetes positive |
| 2 | 73 | 22.9 ± 3.03 | 869.4 ± 0.17 | 14% | 63% | Diabetes positive |
| 3 | 2295 | 24.2 ± 1.89 | 874.5 ± 0.09 | 28% | 66% | Diabetes positive |
| 4 | 109 | 22.2 ± 2.19 | 907.5 ± 0.13 | 0% | 41% | Diabetes positive |
| 5 | 122 | 29.0 ± 2.35 | 910.5 ± 0.09 | 15% | 47% | Diabetes positive |
| 6 | 150 | 22.9 ± 3.18 | 947.6 ± 0.22 | 17% | 51% | Diabetes positive |
| 7 | 165 | 26.8 ± 2.98 | 950.5 ± 0.12 | 0% | 24% | Diabetes positive |
| 8 | 215 | 23.2 ± 4.87 | 995.6 ± 0.14 | 23% | 50% | Diabetes positive |
| 9 | 287 | 27.4 ± 3.59 | 1082.6 ± 0.16 | 0% | 44% | Diabetes positive |
| 10 | 301 | 32.3 ± 1.99 | 1096.5 ± 0.14 | 10% | 51% | Diabetes positive |
| 11 | 381 | 26.8 ± 3.85 | 1176.6 ± 0.13 | 21% | 59% | Diabetes positive |
| 12 | 2598 | 22.3 ± 3.45 | 1222.8 ± 0.22 | 17% | 56% | Diabetes positive |
| 13 | 438 | 30.6 ± 3.31 | 1236.6 ± 0.11 | 24% | 59% | Diabetes positive |
| 14 | 4246 | 52.6 ± 4.80 | 1285.0 ± 0.09 | 14% | 54% | Diabetes positive |
| 15 | 543 | 28.8 ± 3.98 | 1332.7 ± 0.20 | 23% | 55% | Diabetes positive |
| 16 | 4694 | 49.8 ± 4.72 | 1332.8 ± 0.16 | 8% | 38% | Diabetes positive |
| 17 | 544 | 26.7 ± 2.79 | 1355.8 ± 0.15 | 17% | 56% | Diabetes positive |
| 18 | 589 | 24.6 ± 2.84 | 1386.8 ± 0.14 | 53% | 77% | Diabetes positive |
| 19 | 602 | 26.8 ± 3.26 | 1403.7 ± 0.21 | 8% | 46% | Diabetes positive |
| 20 | 584 | 17.8 ± 4.12 | 1405.9 ± 0.15 | 14% | 56% | Diabetes positive |
| 21 | 635 | 31.5 ± 3.71 | 1442.7 ± 0.27 | 15% | 55% | Diabetes positive |
| 22 | 618 | 32.1 ± 3.38 | 1449.8 ± 0.14 | 41% | 85% | Diabetes positive |
| 23 | 722 | 31.3 ± 5.27 | 1592.4 ± 0.38 | 3% | 46% | Diabetes positive |
| 24 | 3234 | 43.4 ± 4.41 | 1783.4 ± 0.30 | 33% | 63% | Diabetes positive |
| 25 | 858 | 29.4 ± 3.08 | 1789.2 ± 0.39 | 28% | 75% | Diabetes positive |
| 26 | 3259 | 38.4 ± 1.09 | 1818.9 ± 0.21 | 28% | 67% | Diabetes positive |
| 27 | 3058 | 37.7 ± 1.04 | 1821.4 ± 0.39 | 14% | 56% | Diabetes positive |
| 28 | 882 | 24.4 ± 2.55 | 1829.2 ± 0.23 | 45% | 81% | Diabetes positive |
| 29 | 5462 | 51.1 ± 4.11 | 1854.7 ± 0.41 | 14% | 54% | Diabetes positive |
| 30 | 3281 | 37.6 ± 3.30 | 1856.8 ± 0.48 | 33% | 56% | Diabetes positive |
| 31 | 906 | 24.7 ± 2.63 | 1872.9 ± 0.35 | 43% | 72% | Diabetes positive |
| 32 | 930 | 28.3 ± 3.47 | 1949.5 ± 0.32 | 17% | 73% | Diabetes positive |
| 33 | 949 | 31.6 ± 2.90 | 1955.1 ± 0.32 | 55% | 79% | Diabetes positive |
| 34 | 957 | 31.3 ± 3.00 | 1971.0 ± 0.45 | 20% | 54% | Diabetes positive |
| 35 | 988 | 37.8 ± 2.40 | 2032.0 ± 0.30 | 25% | 60% | Diabetes positive |
| 36 | 1001 | 30.9 ± 4.69 | 2061.4 ± 0.58 | 10% | 38% | Diabetes positive |
| 37 | 1016 | 33.8 ± 3.76 | 2092.2 ± 0.46 | 18% | 45% | Diabetes positive |
| 38 | 1059 | 27.7 ± 4.43 | 2185.6 ± 0.46 | 10% | 36% | Diabetes positive |
| 39 | 3271 | 32.9 ± 1.48 | 2189.4 ± 0.34 | 14% | 54% | Diabetes positive |
| 40 | 3492 | 39.6 ± 5.31 | 2229.4 ± 0.48 | 5% | 39% | Diabetes positive |
| 41 | 1078 | 24.5 ± 5.14 | 2229.9 ± 0.33 | 25% | 63% | Diabetes positive |
| 42 | 1197 | 28.3 ± 3.30 | 2502.9 ± 0.56 | 20% | 48% | Diabetes positive |
| 43 | 1243 | 24.9 ± 4.84 | 2621.6 ± 0.97 | 20% | 45% | Diabetes positive |
| 44 | 3710 | 37.5 ± 4.52 | 2669.8 ± 0.39 | 23% | 67% | Diabetes positive |
| 45 | 5507 | 20.8 ± 4.47 | 2752.2 ± 0.76 | 35% | 64% | Diabetes positive |
| 46 | 1304 | 24.9 ± 4.31 | 2795.7 ± 0.96 | 13% | 40% | Diabetes positive |
| 47 | 5687 | 48.2 ± 3.61 | 3246.1 ± 0.43 | 0% | 30% | Diabetes positive |
| 48 | 1629 | 20.9 ± 3.33 | 3844.0 ± 0.52 | 3% | 54% | Diabetes positive |
| 49 | 1869 | 21.9 ± 2.62 | 4961.5 ± 0.89 | 10% | 40% | Diabetes positive |
| 50 | 1950 | 18.6 ± 2.91 | 5497.0 ± 0.66 | 18% | 42% | Diabetes positive |
| 51 | 12 | 20.4 ± 2.20 | 808.4 ± 0.10 | 58% | 9% | Diabetes negative |
| 52 | 108 | 45.3 ± 2.03 | 897.5 ± 0.09 | 48% | 7% | Diabetes negative |
| 53 | 143 | 31.4 ± 1.08 | 929.5 ± 0.11 | 98% | 46% | Diabetes negative |
| 54 | 2533 | 41.2 ± 1.41 | 946.4 ± 0.10 | 85% | 36% | Diabetes negative |
| 55 | 2565 | 28.0 ± 1.04 | 980.5 ± 0.07 | 85% | 31% | Diabetes negative |
| 56 | 220 | 26.7 ± 2.26 | 1000.5 ± 0.09 | 83% | 41% | Diabetes negative |
| 57 | 228 | 27.8 ± 1.51 | 1008.5 ± 0.10 | 95% | 41% | Diabetes negative |
| 58 | 232 | 29.3 ± 2.55 | 1012.5 ± 0.10 | 63% | 17% | Diabetes negative |
| 59 | 2627 | 43.6 ± 2.03 | 1047.5 ± 0.11 | 90% | 26% | Diabetes negative |
| 60 | 5947 | 25.0 ± 3.91 | 1052.6 ± 0.08 | 45% | 4% | Diabetes negative |
| 61 | 286 | 37.4 ± 5.63 | 1066.5 ± 0.14 | 58% | 13% | Diabetes negative |
| 62 | 295 | 22.8 ± 1.78 | 1075.5 ± 0.13 | 68% | 26% | Diabetes negative |
| 63 | 309 | 28.9 ± 3.89 | 1088.6 ± 0.15 | 65% | 21% | Diabetes negative |
| 64 | 2681 | 44.4 ± 2.06 | 1106.5 ± 0.11 | 80% | 18% | Diabetes negative |
| 65 | 328 | 34.1 ± 1.80 | 1107.5 ± 0.10 | 88% | 35% | Diabetes negative |
| 66 | 342 | 42.8 ± 3.26 | 1120.5 ± 0.06 | 60% | 14% | Diabetes negative |
| 67 | 356 | 29.1 ± 2.26 | 1134.6 ± 0.10 | 95% | 49% | Diabetes negative |
| 68 | 359 | 28.2 ± 3.00 | 1137.7 ± 0.11 | 70% | 24% | Diabetes negative |
| 69 | 344 | 45.5 ± 2.34 | 1139.5 ± 0.20 | 83% | 22% | Diabetes negative |
| 70 | 381 | 32.9 ± 1.25 | 1159.6 ± 0.11 | 80% | 27% | Diabetes negative |
| 71 | 401 | 23.3 ± 4.17 | 1180.5 ± 0.16 | 50% | 9% | Diabetes negative |
| 72 | 421 | 43.8 ± 2.08 | 1200.6 ± 0.11 | 95% | 50% | Diabetes negative |
| 73 | 425 | 27.2 ± 3.22 | 1204.6 ± 0.17 | 60% | 17% | Diabetes negative |
| 74 | 6860 | 44.9 ± 2.53 | 1209.5 ± 0.09 | 83% | 17% | Diabetes negative |
| 75 | 2793 | 47.8 ± 2.73 | 1224.6 ± 0.12 | 75% | 19% | Diabetes negative |
| 76 | 464 | 25.6 ± 2.43 | 1246.7 ± 0.15 | 73% | 30% | Diabetes negative |
| 77 | 2833 | 47.9 ± 2.66 | 1268.6 ± 0.09 | 68% | 25% | Diabetes negative |
| 78 | 2840 | 43.9 ± 1.80 | 1277.5 ± 0.10 | 70% | 28% | Diabetes negative |
| 79 | 2841 | 46.0 ± 2.69 | 1278.5 ± 0.09 | 58% | 10% | Diabetes negative |
| 80 | 2651 | 33.1 ± 1.82 | 1282.6 ± 0.13 | 62% | 7% | Diabetes negative |
| 81 | 2893 | 29.3 ± 3.88 | 1331.7 ± 0.18 | 65% | 12% | Diabetes negative |
| 82 | 2959 | 45.9 ± 4.78 | 1405.5 ± 0.33 | 93% | 45% | Diabetes negative |
| 83 | 620 | 44.4 ± 3.90 | 1423.6 ± 0.16 | 60% | 20% | Diabetes negative |
| 84 | 663 | 19.2 ± 3.40 | 1484.8 ± 0.19 | 68% | 13% | Diabetes negative |
| 85 | 3114 | 36.9 ± 2.02 | 1609.6 ± 0.13 | 85% | 13% | Diabetes negative |
| 86 | 3136 | 38.9 ± 3.78 | 1639.7 ± 0.27 | 63% | 19% | Diabetes negative |
| 87 | 769 | 33.2 ± 3.34 | 1662.9 ± 0.21 | 62% | 5% | Diabetes negative |
| 88 | 770 | 35.8 ± 2.19 | 1664.6 ± 0.29 | 66% | 10% | Diabetes negative |
| 89 | 785 | 36.2 ± 4.78 | 1666.6 ± 0.34 | 75% | 29% | Diabetes negative |
| 90 | 3165 | 35.9 ± 2.98 | 1678.1 ± 0.44 | 60% | 18% | Diabetes negative |
| 91 | 3192 | 37.3 ± 2.99 | 1716.8 ± 0.23 | 73% | 19% | Diabetes negative |
| 92 | 2988 | 46.5 ± 4.38 | 1717.5 ± 0.37 | 79% | 15% | Diabetes negative |
| 93 | 832 | 37.9 ± 4.18 | 1746.0 ± 0.33 | 83% | 34% | Diabetes negative |
| 94 | 3258 | 25.1 ± 2.25 | 1817.6 ± 0.27 | 65% | 8% | Diabetes negative |
| 95 | 878 | 34.2 ± 3.95 | 1823.4 ± 0.47 | 73% | 30% | Diabetes negative |
| 96 | 894 | 29.1 ± 3.59 | 1849.8 ± 0.30 | 100% | 56% | Diabetes negative |
| 97 | 3314 | 49.3 ± 4.49 | 1914.1 ± 0.36 | 88% | 38% | Diabetes negative |
| 98 | 3117 | 44.2 ± 4.23 | 1916.7 ± 0.33 | 69% | 10% | Diabetes negative |
| 99 | 3383 | 39.8 ± 2.19 | 2030.8 ± 0.35 | 93% | 38% | Diabetes negative |
| 100 | 5215 | 31.9 ± 1.61 | 2118.9 ± 0.21 | 73% | 14% | Diabetes negative |
| 101 | 1056 | 41.2 ± 2.45 | 2179.3 ± 0.42 | 58% | 17% | Diabetes negative |
| 102 | 5269 | 20.1 ± 2.78 | 2219.0 ± 0.26 | 53% | 13% | Diabetes negative |
| 103 | 1090 | 25.8 ± 2.70 | 2256.9 ± 0.47 | 85% | 26% | Diabetes negative |
| 104 | 3314 | 45.1 ± 5.23 | 2273.4 ± 0.42 | 79% | 22% | Diabetes negative |
| 105 | 3317 | 40.7 ± 1.90 | 2279.0 ± 0.33 | 90% | 20% | Diabetes negative |
| 106 | 1117 | 26.8 ± 3.73 | 2320.2 ± 0.55 | 78% | 34% | Diabetes negative |
| 107 | 1123 | 23.6 ± 3.10 | 2332.2 ± 0.35 | 53% | 11% | Diabetes negative |
| 108 | 1129 | 44.5 ± 3.08 | 2345.6 ± 0.46 | 75% | 34% | Diabetes negative |
| 109 | 1146 | 25.7 ± 5.16 | 2384.5 ± 0.63 | 65% | 21% | Diabetes negative |
| 110 | 3592 | 38.5 ± 3.62 | 2423.9 ± 0.41 | 88% | 29% | Diabetes negative |
| 111 | 3595 | 34.2 ± 2.92 | 2429.9 ± 0.51 | 65% | 18% | Diabetes negative |
| 112 | 3398 | 23.3 ± 2.54 | 2443.3 ± 0.46 | 66% | 5% | Diabetes negative |
| 113 | 3446 | 41.7 ± 3.72 | 2548.1 ± 0.57 | 69% | 15% | Diabetes negative |
| 114 | 1215 | 27.3 ± 4.77 | 2548.3 ± 0.66 | 83% | 35% | Diabetes negative |
| 115 | 5421 | 43.6 ± 2.08 | 2548.3 ± 0.23 | 95% | 41% | Diabetes negative |
| 116 | 1227 | 24.0 ± 3.11 | 2581.5 ± 0.47 | 60% | 13% | Diabetes negative |
| 117 | 1230 | 24.0 ± 2.70 | 2587.4 ± 0.40 | 80% | 26% | Diabetes negative |
| 118 | 1238 | 41.7 ± 3.06 | 2606.8 ± 0.55 | 78% | 35% | Diabetes negative |
| 119 | 1237 | 31.3 ± 4.92 | 2636.4 ± 0.48 | 72% | 12% | Diabetes negative |
| 120 | 1253 | 25.5 ± 3.62 | 2644.2 ± 0.41 | 88% | 33% | Diabetes negative |
| 121 | 1244 | 29.2 ± 1.07 | 2654.0 ± 0.37 | 66% | 0% | Diabetes negative |
| 122 | 1272 | 29.8 ± 3.50 | 2698.2 ± 0.63 | 90% | 29% | Diabetes negative |
| 123 | 1266 | 43.0 ± 2.26 | 2710.5 ± 0.37 | 79% | 5% | Diabetes negative |
| 124 | 3749 | 25.1 ± 1.64 | 2761.3 ± 0.35 | 88% | 44% | Diabetes negative |
| 125 | 1301 | 31.3 ± 2.79 | 2808.5 ± 0.56 | 79% | 22% | Diabetes negative |
| 126 | 1326 | 42.0 ± 3.22 | 2876.5 ± 0.48 | 62% | 7% | Diabetes negative |
| 127 | 1342 | 33.7 ± 3.34 | 2898.7 ± 0.50 | 85% | 43% | Diabetes negative |
| 128 | 3595 | 42.2 ± 2.68 | 2908.1 ± 0.53 | 72% | 17% | Diabetes negative |
| 129 | 3598 | 35.4 ± 2.63 | 2917.6 ± 0.58 | 72% | 12% | Diabetes negative |
| 130 | 3843 | 35.4 ± 0.77 | 2978.1 ± 0.49 | 85% | 35% | Diabetes negative |
| 131 | 3849 | 36.1 ± 1.42 | 2994.6 ± 0.80 | 83% | 24% | Diabetes negative |
| 132 | 1380 | 43.5 ± 2.99 | 3023.4 ± 0.65 | 93% | 34% | Diabetes negative |
| 133 | 1388 | 44.4 ± 3.35 | 3045.2 ± 0.61 | 69% | 12% | Diabetes negative |
| 134 | 1398 | 22.9 ± 3.47 | 3076.4 ± 0.96 | 66% | 7% | Diabetes negative |
| 135 | 1404 | 35.7 ± 1.99 | 3082.3 ± 0.43 | 73% | 22% | Diabetes negative |
| 136 | 1419 | 33.6 ± 3.53 | 3136.8 ± 0.61 | 95% | 47% | Diabetes negative |
| 137 | 1425 | 21.7 ± 3.14 | 3154.8 ± 0.44 | 55% | 10% | Diabetes negative |
| 138 | 1437 | 26.5 ± 1.92 | 3193.7 ± 0.53 | 78% | 32% | Diabetes negative |
| 139 | 1441 | 24.4 ± 3.02 | 3206.3 ± 0.72 | 66% | 7% | Diabetes negative |
| 140 | 1454 | 28.2 ± 2.80 | 3250.9 ± 0.71 | 63% | 18% | Diabetes negative |
| 141 | 1469 | 48.2 ± 3.46 | 3293.2 ± 0.74 | 93% | 39% | Diabetes negative |
| 142 | 1467 | 31.4 ± 1.60 | 3295.7 ± 0.33 | 95% | 40% | Diabetes negative |
| 143 | 1479 | 27.2 ± 3.58 | 3338.4 ± 0.79 | 80% | 34% | Diabetes negative |
| 144 | 1495 | 37.3 ± 2.11 | 3381.6 ± 0.63 | 78% | 26% | Diabetes negative |
| 145 | 1517 | 27.6 ± 2.49 | 3452.1 ± 0.49 | 58% | 15% | Diabetes negative |
| 146 | 1523 | 37.3 ± 1.50 | 3463.0 ± 0.83 | 72% | 15% | Diabetes negative |
| 147 | 1556 | 19.6 ± 2.89 | 3583.4 ± 0.75 | 79% | 20% | Diabetes negative |
| 148 | 1571 | 34.0 ± 2.55 | 3634.4 ± 0.74 | 86% | 29% | Diabetes negative |
| 149 | 4086 | 37.7 ± 2.61 | 3681.8 ± 1.38 | 55% | 14% | Diabetes negative |
| 150 | 1586 | 25.5 ± 2.25 | 3686.2 ± 0.60 | 86% | 20% | Diabetes negative |
| 151 | 1602 | 36.0 ± 3.89 | 3735.7 ± 0.57 | 70% | 28% | Diabetes negative |
| 152 | 1634 | 30.3 ± 1.58 | 3852.3 ± 0.56 | 83% | 41% | Diabetes negative |
| 153 | 3920 | 29.6 ± 1.46 | 4098.4 ± 0.59 | 93% | 20% | Diabetes negative |
| 154 | 1942 | 28.8 ± 1.18 | 5428.8 ± 0.67 | 70% | 19% | Diabetes negative |
| 155 | 1995 | 33.1 ± 0.69 | 6187.5 ± 1.13 | 83% | 10% | Diabetes negative |
| 156 | 4309 | 26.0 ± 4.82 | 6212.0 ± 1.41 | 75% | 26% | Diabetes negative |
| 157 | 2160 | 23.3 ± 2.19 | 9868.8 ± 1.33 | 66% | 0% | Diabetes negative |

26. At least one marker selected from the following table:

| No. | ID | Time [min] | Mass [Da] | % healthy | % diseased | Type |
|---|---|---|---|---|---|---|
| 158 | 32 | 21.7 ± 5.12 | 830.5 ± 0.11 | 4% | 40% | Nephropathy positive |
| 159 | 69 | 32.4 ± 1.83 | 866.4 ± 0.11 | 0% | 40% | Nephropathy positive |
| 160 | 111 | 30.6 ± 3.07 | 909.5 ± 0.13 | 11% | 40% | Nephropathy positive |
| 161 | 152 | 32.8 ± 3.14 | 937.5 ± 0.11 | 14% | 73% | Nephropathy positive |
| 162 | 155 | 24.9 ± 2.97 | 952.5 ± 0.16 | 11% | 40% | Nephropathy positive |
| 163 | 238 | 32.1 ± 2.44 | 1033.5 ± 0.11 | 5% | 40% | Nephropathy positive |
| 164 | 280 | 24.4 ± 2.87 | 1060.6 ± 0.16 | 17% | 68% | Nephropathy positive |
| 165 | 353 | 27.5 ± 2.86 | 1131.6 ± 0.16 | 20% | 68% | Nephropathy positive |
| 166 | 402 | 33.4 ± 3.48 | 1181.6 ± 0.15 | 22% | 73% | Nephropathy positive |
| 167 | 424 | 33.0 ± 2.52 | 1203.6 ± 0.14 | 9% | 50% | Nephropathy positive |
| 168 | 2586 | 26.5 ± 3.68 | 1211.6 ± 0.14 | 14% | 40% | Nephropathy positive |
| 169 | 2595 | 33.1 ± 0.91 | 1219.6 ± 0.15 | 18% | 40% | Nephropathy positive |
| 170 | 2601 | 32.8 ± 3.30 | 1225.6 ± 0.13 | 12% | 40% | Nephropathy positive |
| 171 | 510 | 30.7 ± 3.18 | 1297.7 ± 0.20 | 31% | 82% | Nephropathy positive |
| 172 | 526 | 34.1 ± 2.05 | 1333.7 ± 0.23 | 9% | 40% | Nephropathy positive |
| 173 | 2898 | 44.7 ± 4.06 | 1337.5 ± 0.20 | 19% | 59% | Nephropathy positive |
| 174 | 2955 | 27.9 ± 4.19 | 1398.8 ± 0.36 | 29% | 77% | Nephropathy positive |
| 175 | 2975 | 21.3 ± 5.08 | 1423.7 ± 0.49 | 6% | 50% | Nephropathy positive |
| 176 | 633 | 28.1 ± 4.95 | 1439.8 ± 0.19 | 19% | 68% | Nephropathy positive |
| 177 | 651 | 24.5 ± 2.42 | 1466.0 ± 0.27 | 9% | 77% | Nephropathy positive |
| 178 | 641 | 27.5 ± 4.93 | 1482.0 ± 0.42 | 33% | 40% | Nephropathy positive |
| 179 | 642 | 29.8 ± 4.43 | 1482.9 ± 0.28 | 18% | 40% | Nephropathy positive |
| 180 | 662 | 24.3 ± 2.65 | 1483.7 ± 0.28 | 26% | 91% | Nephropathy positive |
| 181 | 675 | 24.6 ± 1.98 | 1500.0 ± 0.20 | 38% | 86% | Nephropathy positive |
| 182 | 711 | 24.6 ± 2.90 | 1553.1 ± 0.28 | 14% | 64% | Nephropathy positive |
| 183 | 713 | 29.0 ± 4.83 | 1556.7 ± 0.45 | 26% | 73% | Nephropathy positive |
| 184 | 720 | 24.2 ± 2.48 | 1567.0 ± 0.22 | 26% | 86% | Nephropathy positive |
| 185 | 740 | 28.8 ± 4.53 | 1596.9 ± 0.31 | 21% | 86% | Nephropathy positive |
| 186 | 777 | 24.5 ± 2.43 | 1652.8 ± 0.25 | 14% | 59% | Nephropathy positive |
| 187 | 787 | 26.3 ± 2.63 | 1669.8 ± 0.37 | 20% | 64% | Nephropathy positive |
| 188 | 3200 | 33.1 ± 3.22 | 1729.2 ± 0.36 | 6% | 45% | Nephropathy positive |
| 189 | 3210 | 30.5 ± 4.11 | 1744.4 ± 0.46 | 16% | 59% | Nephropathy positive |
| 190 | 6963 | 25.1 ± 3.42 | 1754.4 ± 0.41 | 53% | 95% | Nephropathy positive |
| 191 | 3230 | 24.2 ± 1.56 | 1776.0 ± 0.27 | 9% | 50% | Nephropathy positive |
| 192 | 3036 | 18.5 ± 3.55 | 1791.0 ± 0.38 | 7% | 40% | Nephropathy positive |
| 193 | 843 | 32.2 ± 5.38 | 1792.9 ± 0.31 | 28% | 40% | Nephropathy positive |
| 194 | 3043 | 9.7 ± 2.54 | 1799.8 ± 0.29 | 0% | 40% | Nephropathy positive |
| 195 | 870 | 25.3 ± 2.89 | 1810.9 ± 0.38 | 43% | 91% | Nephropathy positive |
| 196 | 895 | 24.6 ± 2.34 | 1851.1 ± 0.21 | 43% | 95% | Nephropathy positive |
| 197 | 903 | 27.2 ± 4.46 | 1867.3 ± 0.42 | 38% | 91% | Nephropathy positive |
| 198 | 939 | 25.0 ± 3.97 | 1966.0 ± 0.53 | 16% | 40% | Nephropathy positive |
| 199 | 947 | 28.7 ± 3.08 | 1982.8 ± 0.57 | 11% | 40% | Nephropathy positive |
| 200 | 965 | 29.5 ± 5.53 | 1986.3 ± 0.36 | 15% | 64% | Nephropathy positive |
| 201 | 979 | 23.3 ± 4.46 | 2045.9 ± 0.32 | 32% | 40% | Nephropathy positive |
| 202 | 1013 | 33.7 ± 3.16 | 2115.1 ± 0.53 | 30% | 40% | Nephropathy positive |
| 203 | 3263 | 20.5 ± 2.78 | 2177.1 ± 0.37 | 9% | 40% | Nephropathy positive |
| 204 | 1083 | 18.1 ± 4.24 | 2241.6 ± 0.41 | 9% | 59% | Nephropathy positive |
| 205 | 1087 | 21.2 ± 2.49 | 2250.7 ± 0.38 | 23% | 64% | Nephropathy positive |
| 206 | 1091 | 27.5 ± 2.53 | 2258.7 ± 0.49 | 9% | 59% | Nephropathy positive |
| 207 | 1135 | 20.0 ± 3.30 | 2356.4 ± 0.41 | 13% | 59% | Nephropathy positive |
| 208 | 1149 | 28.1 ± 3.95 | 2391.4 ± 0.42 | 13% | 64% | Nephropathy positive |
| 209 | 1156 | 25.7 ± 4.85 | 2406.1 ± 0.57 | 20% | 77% | Nephropathy positive |
| 210 | 1163 | 22.8 ± 4.28 | 2423.2 ± 0.53 | 14% | 64% | Nephropathy positive |
| 211 | 1165 | 21.9 ± 4.45 | 2427.3 ± 0.40 | 31% | 91% | Nephropathy positive |
| 212 | 1182 | 19.2 ± 4.24 | 2465.1 ± 0.62 | 9% | 77% | Nephropathy positive |
| 213 | 5398 | 25.4 ± 5.25 | 2493.0 ± 0.38 | 9% | 50% | Nephropathy positive |
| 214 | 3627 | 19.5 ± 4.66 | 2494.0 ± 0.66 | 12% | 77% | Nephropathy positive |
| 215 | 5610 | 23.7 ± 4.27 | 2494.9 ± 0.49 | 7% | 40% | Nephropathy positive |
| 216 | 3640 | 24.4 ± 5.51 | 2522.0 ± 0.67 | 17% | 82% | Nephropathy positive |
| 217 | 1212 | 20.1 ± 3.61 | 2540.5 ± 0.54 | 14% | 68% | Nephropathy positive |
| 218 | 3673 | 22.3 ± 4.72 | 2593.5 ± 0.30 | 7% | 55% | Nephropathy positive |
| 219 | 1241 | 20.0 ± 4.87 | 2613.9 ± 0.83 | 14% | 55% | Nephropathy positive |
| 220 | 1272 | 35.1 ± 1.62 | 2726.5 ± 0.67 | 61% | 20% | Nephropathy positive |
| 221 | 1289 | 25.0 ± 4.39 | 2775.1 ± 0.56 | 12% | 40% | Nephropathy positive |
| 222 | 1303 | 21.8 ± 3.78 | 2790.7 ± 0.55 | 19% | 86% | Nephropathy positive |
| 223 | 1339 | 25.9 ± 3.30 | 2892.2 ± 0.50 | 9% | 50% | Nephropathy positive |
| 224 | 3819 | 16.8 ± 2.72 | 2919.0 ± 0.26 | 2% | 50% | Nephropathy positive |
| 225 | 1355 | 21.9 ± 3.23 | 2937.0 ± 0.49 | 13% | 86% | Nephropathy positive |
| 226 | 1362 | 20.0 ± 4.81 | 2958.8 ± 0.80 | 5% | 59% | Nephropathy positive |
| 227 | 1358 | 34.4 ± 2.72 | 2962.0 ± 0.54 | 12% | 20% | Nephropathy positive |
| 228 | 1393 | 28.9 ± 3.56 | 3059.7 ± 0.78 | 30% | 40% | Nephropathy positive |
| 229 | 1402 | 28.3 ± 5.96 | 3088.0 ± 0.79 | 7% | 20% | Nephropathy positive |
| 230 | 1494 | 26.1 ± 2.72 | 3369.2 ± 0.73 | 21% | 40% | Nephropathy positive |
| 231 | 1528 | 26.0 ± 2.89 | 3483.4 ± 0.95 | 30% | 40% | Nephropathy positive |
| 232 | 1719 | 24.5 ± 3.92 | 4183.3 ± 1.44 | 4% | 40% | Nephropathy positive |
| 233 | 1734 | 21.0 ± 5.35 | 4241.0 ± 0.62 | 29% | 73% | Nephropathy positive |
| 234 | 1761 | 23.4 ± 4.09 | 4370.2 ± 1.01 | 11% | 40% | Nephropathy positive |
| 235 | 1793 | 22.8 ± 2.94 | 4527.6 ± 0.67 | 1% | 45% | Nephropathy positive |
| 236 | 1825 | 21.7 ± 3.00 | 4713.6 ± 0.44 | 7% | 64% | Nephropathy positive |
| 237 | 2060 | 24.6 ± 3.73 | 7556.6 ± 1.55 | 2% | 40% | Nephropathy positive |
| 238 | 3994 | 16.7 ± 5.54 | 8055.1 ± 2.10 | 12% | 40% | Nephropathy positive |
| 239 | 2229 | 13.2 ± 5.19 | 8765.8 ± 0.96 | 37% | 82% | Nephropathy positive |
| 240 | 2252 | 15.3 ± 4.97 | 9181.0 ± 1.28 | 10% | 64% | Nephropathy positive |
| 241 | 2302 | 14.0 ± 4.20 | 10046.1 ± 0.96 | 21% | 77% | Nephropathy positive |
| 242 | 2180 | 18.7 ± 5.50 | 10208.0 ± 1.24 | 2% | 40% | Nephropathy positive |
| 243 | 2323 | 17.4 ± 4.02 | 10518.2 ± 1.10 | 23% | 64% | Nephropathy positive |
| 244 | 138 | 35.3 ± 5.04 | 924.5 ± 0.12 | 50% | 0% | Nephropathy negative |
| 245 | 142 | 43.1 ± 2.61 | 928.4 ± 0.08 | 65% | 14% | Nephropathy negative |
| 246 | 2541 | 45.7 ± 2.25 | 955.5 ± 0.14 | 60% | 5% | Nephropathy negative |
| 247 | 2594 | 23.8 ± 2.94 | 1010.6 ± 0.09 | 67% | 5% | Nephropathy negative |
| 248 | 248 | 31.2 ± 1.53 | 1028.5 ± 0.09 | 84% | 32% | Nephropathy negative |
| 249 | 2622 | 45.9 ± 2.27 | 1041.4 ± 0.10 | 57% | 0% | Nephropathy negative |
| 250 | 266 | 31.5 ± 1.98 | 1046.5 ± 0.09 | 87% | 32% | Nephropathy negative |
| 251 | 2440 | 43.4 ± 2.24 | 1047.5 ± 0.12 | 68% | 0% | Nephropathy negative |
| 252 | 2442 | 18.1 ± 4.34 | 1050.7 ± 0.12 | 60% | 0% | Nephropathy negative |
| 253 | 304 | 32.9 ± 3.03 | 1084.4 ± 0.11 | 69% | 18% | Nephropathy negative |
| 254 | 347 | 46.7 ± 2.63 | 1125.5 ± 0.12 | 63% | 9% | Nephropathy negative |
| 255 | 2731 | 46.3 ± 2.70 | 1157.5 ± 0.10 | 83% | 32% | Nephropathy negative |
| 256 | 2733 | 43.7 ± 1.70 | 1160.5 ± 0.07 | 72% | 18% | Nephropathy negative |
| 257 | 400 | 44.5 ± 3.67 | 1179.5 ± 0.09 | 97% | 36% | Nephropathy negative |
| 258 | 412 | 45.0 ± 2.24 | 1191.6 ± 0.09 | 60% | 9% | Nephropathy negative |
| 259 | 416 | 46.2 ± 2.59 | 1195.5 ± 0.10 | 98% | 32% | Nephropathy negative |
| 260 | 2575 | 44.2 ± 1.83 | 1200.6 ± 0.13 | 86% | 0% | Nephropathy negative |
| 261 | 442 | 45.9 ± 2.04 | 1223.5 ± 0.10 | 80% | 9% | Nephropathy negative |
| 262 | 441 | 44.5 ± 2.15 | 1239.6 ± 0.08 | 89% | 0% | Nephropathy negative |
| 263 | 2814 | 47.8 ± 3.08 | 1246.6 ± 0.11 | 60% | 5% | Nephropathy negative |
| 264 | 2821 | 46.8 ± 2.20 | 1254.7 ± 0.19 | 56% | 5% | Nephropathy negative |
| 265 | 478 | 43.2 ± 2.90 | 1261.5 ± 0.16 | 91% | 36% | Nephropathy negative |
| 266 | 479 | 48.6 ± 2.90 | 1262.5 ± 0.09 | 65% | 0% | Nephropathy negative |
| 267 | 476 | 43.9 ± 2.16 | 1277.6 ± 0.11 | 67% | 0% | Nephropathy negative |
| 268 | 502 | 36.7 ± 3.04 | 1288.7 ± 0.18 | 72% | 23% | Nephropathy negative |
| 269 | 2856 | 47.2 ± 3.17 | 1292.5 ± 0.14 | 67% | 18% | Nephropathy negative |
| 270 | 521 | 47.8 ± 2.58 | 1308.5 ± 0.09 | 66% | 0% | Nephropathy negative |
| 271 | 4687 | 48.2 ± 2.67 | 1321.6 ± 0.11 | 53% | 0% | Nephropathy negative |
| 272 | 533 | 34.8 ± 1.81 | 1321.7 ± 0.23 | 98% | 41% | Nephropathy negative |
| 273 | 559 | 46.0 ± 4.93 | 1351.7 ± 0.15 | 63% | 9% | Nephropathy negative |
| 274 | 2925 | 47.7 ± 2.99 | 1367.6 ± 0.14 | 97% | 23% | Nephropathy negative |
| 275 | 582 | 37.8 ± 2.93 | 1378.6 ± 0.16 | 87% | 36% | Nephropathy negative |
| 276 | 2946 | 47.5 ± 2.59 | 1389.7 ± 0.15 | 86% | 18% | Nephropathy negative |
| 277 | 2961 | 46.5 ± 2.28 | 1407.8 ± 0.20 | 79% | 9% | Nephropathy negative |
| 278 | 2768 | 44.6 ± 4.84 | 1422.1 ± 0.33 | 70% | 0% | Nephropathy negative |
| 279 | 598 | 45.4 ± 3.62 | 1423.8 ± 0.19 | 75% | 0% | Nephropathy negative |
| 280 | 2976 | 48.0 ± 2.97 | 1424.7 ± 0.16 | 95% | 18% | Nephropathy negative |
| 281 | 638 | 47.6 ± 3.40 | 1446.7 ± 0.16 | 92% | 23% | Nephropathy negative |
| 282 | 2998 | 46.5 ± 2.95 | 1450.4 ± 0.25 | 62% | 9% | Nephropathy negative |
| 283 | 3008 | 48.0 ± 2.95 | 1462.6 ± 0.17 | 97% | 9% | Nephropathy negative |
| 284 | 665 | 35.7 ± 1.90 | 1487.7 ± 0.15 | 70% | 18% | Nephropathy negative |
| 285 | 3031 | 47.8 ± 2.35 | 1490.6 ± 0.12 | 72% | 9% | Nephropathy negative |
| 286 | 3032 | 49.2 ± 2.77 | 1491.7 ± 0.12 | 81% | 14% | Nephropathy negative |
| 287 | 3043 | 49.0 ± 3.14 | 1507.8 ± 0.17 | 99% | 32% | Nephropathy negative |
| 288 | 3055 | 49.2 ± 2.86 | 1523.7 ± 0.11 | 97% | 18% | Nephropathy negative |
| 289 | 3059 | 48.6 ± 2.70 | 1529.7 ± 0.19 | 83% | 9% | Nephropathy negative |
| 290 | 3065 | 49.2 ± 3.26 | 1539.7 ± 0.19 | 98% | 23% | Nephropathy negative |
| 291 | 3070 | 49.0 ± 3.19 | 1545.7 ± 0.13 | 99% | 23% | Nephropathy negative |
| 292 | 3081 | 49.8 ± 2.76 | 1561.6 ± 0.19 | 90% | 18% | Nephropathy negative |
| 293 | 3085 | 48.4 ± 3.12 | 1567.7 ± 0.20 | 65% | 9% | Nephropathy negative |
| 294 | 3089 | 48.1 ± 2.66 | 1573.7 ± 0.27 | 63% | 5% | Nephropathy negative |
| 295 | 3092 | 48.5 ± 4.03 | 1577.8 ± 0.35 | 94% | 9% | Nephropathy negative |
| 296 | 2900 | 50.6 ± 3.40 | 1587.1 ± 0.34 | 65% | 0% | Nephropathy negative |
| 297 | 735 | 48.6 ± 2.68 | 1589.7 ± 0.14 | 86% | 18% | Nephropathy negative |
| 298 | 736 | 45.9 ± 3.83 | 1591.7 ± 0.30 | 79% | 18% | Nephropathy negative |
| 299 | 3105 | 49.3 ± 3.22 | 1594.8 ± 0.14 | 88% | 14% | Nephropathy negative |
| 300 | 3111 | 48.8 ± 2.78 | 1605.7 ± 0.13 | 73% | 18% | Nephropathy negative |
| 301 | 750 | 48.5 ± 2.81 | 1611.7 ± 0.14 | 73% | 5% | Nephropathy negative |
| 302 | 3134 | 46.3 ± 5.12 | 1636.4 ± 0.39 | 79% | 23% | Nephropathy negative |
| 303 | 3145 | 49.5 ± 3.37 | 1651.8 ± 0.19 | 99% | 23% | Nephropathy negative |
| 304 | 780 | 45.2 ± 5.96 | 1657.7 ± 0.23 | 60% | 5% | Nephropathy negative |
| 305 | 790 | 49.5 ± 3.33 | 1673.8 ± 0.14 | 95% | 23% | Nephropathy negative |
| 306 | 2969 | 49.6 ± 3.05 | 1689.8 ± 0.18 | 86% | 0% | Nephropathy negative |
| 307 | 810 | 26.9 ± 3.18 | 1706.8 ± 0.30 | 78% | 27% | Nephropathy negative |
| 308 | 3203 | 49.4 ± 2.84 | 1734.4 ± 0.40 | 65% | 5% | Nephropathy negative |
| 309 | 4983 | 49.2 ± 3.17 | 1739.7 ± 0.22 | 59% | 5% | Nephropathy negative |
| 310 | 3212 | 45.1 ± 4.21 | 1748.0 ± 0.28 | 55% | 5% | Nephropathy negative |
| 311 | 5032 | 44.2 ± 4.71 | 1813.6 ± 0.38 | 58% | 5% | Nephropathy negative |
| 312 | 874 | 39.1 ± 3.48 | 1817.0 ± 0.29 | 85% | 18% | Nephropathy negative |
| 313 | 3272 | 51.7 ± 3.48 | 1841.0 ± 0.23 | 59% | 9% | Nephropathy negative |
| 314 | 3277 | 50.4 ± 4.56 | 1848.2 ± 0.43 | 58% | 0% | Nephropathy negative |
| 315 | 5059 | 51.5 ± 2.94 | 1856.8 ± 0.24 | 59% | 5% | Nephropathy negative |
| 316 | 3285 | 52.7 ± 4.24 | 1863.8 ± 0.31 | 88% | 14% | Nephropathy negative |
| 317 | 914 | 52.7 ± 3.92 | 1885.8 ± 0.20 | 70% | 5% | Nephropathy negative |
| 318 | 3108 | 47.7 ± 4.69 | 1902.1 ± 0.33 | 75% | 0% | Nephropathy negative |
| 319 | 3120 | 50.6 ± 3.95 | 1924.0 ± 0.48 | 68% | 0% | Nephropathy negative |
| 320 | 981 | 26.6 ± 1.76 | 2048.5 ± 0.44 | 86% | 20% | Nephropathy negative |
| 321 | 3415 | 25.8 ± 1.39 | 2085.9 ± 0.24 | 83% | 32% | Nephropathy negative |
| 322 | 3416 | 39.9 ± 1.45 | 2087.8 ± 0.34 | 72% | 23% | Nephropathy negative |
| 323 | 5214 | 52.8 ± 4.09 | 2117.1 ± 0.17 | 78% | 9% | Nephropathy negative |
| 324 | 1020 | 28.3 ± 3.90 | 2129.7 ± 0.42 | 63% | 0% | Nephropathy negative |
| 325 | 3456 | 40.4 ± 1.53 | 2158.9 ± 0.26 | 86% | 32% | Nephropathy negative |
| 326 | 3465 | 39.7 ± 1.71 | 2174.9 ± 0.36 | 97% | 45% | Nephropathy negative |
| 327 | 3491 | 32.6 ± 1.79 | 2227.1 ± 0.41 | 81% | 23% | Nephropathy negative |
| 328 | 1086 | 29.3 ± 3.50 | 2249.0 ± 0.41 | 92% | 41% | Nephropathy negative |
| 329 | 3506 | 40.6 ± 1.25 | 2257.1 ± 0.35 | 94% | 45% | Nephropathy negative |
| 330 | 1097 | 46.2 ± 5.11 | 2273.5 ± 0.38 | 71% | 18% | Nephropathy negative |
| 331 | 1094 | 40.8 ± 2.66 | 2296.0 ± 0.40 | 63% | 20% | Nephropathy negative |
| 332 | 1121 | 40.9 ± 3.32 | 2327.6 ± 0.52 | 85% | 36% | Nephropathy negative |
| 333 | 3551 | 41.8 ± 2.45 | 2343.3 ± 0.43 | 77% | 27% | Nephropathy negative |
| 334 | 3574 | 40.8 ± 1.31 | 2385.3 ± 0.32 | 95% | 45% | Nephropathy negative |
| 335 | 1185 | 40.9 ± 2.68 | 2471.5 ± 0.52 | 69% | 14% | Nephropathy negative |
| 336 | 1193 | 41.5 ± 2.64 | 2493.5 ± 0.48 | 74% | 18% | Nephropathy negative |
| 337 | 5432 | 52.9 ± 3.98 | 2570.4 ± 0.27 | 71% | 5% | Nephropathy negative |
| 338 | 3697 | 34.1 ± 0.72 | 2642.8 ± 0.40 | 86% | 36% | Nephropathy negative |
| 339 | 1268 | 36.1 ± 2.56 | 2687.1 ± 0.49 | 84% | 23% | Nephropathy negative |
| 340 | 1276 | 42.8 ± 2.33 | 2710.6 ± 0.46 | 88% | 18% | Nephropathy negative |
| 341 | 5506 | 50.6 ± 4.73 | 2748.6 ± 0.36 | 64% | 0% | Nephropathy negative |
| 342 | 1371 | 37.8 ± 1.92 | 2986.6 ± 0.55 | 74% | 23% | Nephropathy negative |
| 343 | 1379 | 23.3 ± 2.07 | 3007.4 ± 0.50 | 65% | 9% | Nephropathy negative |
| 344 | 1385 | 25.9 ± 2.35 | 3038.3 ± 0.70 | 46% | 0% | Nephropathy negative |
| 345 | 3868 | 46.0 ± 2.91 | 3045.4 ± 0.36 | 59% | 5% | Nephropathy negative |
| 346 | 5624 | 53.3 ± 4.05 | 3057.2 ± 0.64 | 76% | 9% | Nephropathy negative |
| 347 | 1411 | 38.9 ± 2.57 | 3109.0 ± 0.57 | 88% | 14% | Nephropathy negative |
| 348 | 1435 | 41.9 ± 3.55 | 3187.6 ± 0.47 | 71% | 14% | Nephropathy negative |
| 349 | 1437 | 26.6 ± 1.15 | 3193.6 ± 0.41 | 61% | 0% | Nephropathy negative |
| 350 | 5681 | 48.3 ± 3.69 | 3223.8 ± 0.41 | 88% | 18% | Nephropathy negative |
| 351 | 1458 | 31.7 ± 3.65 | 3265.1 ± 0.64 | 93% | 41% | Nephropathy negative |
| 352 | 1465 | 29.5 ± 1.76 | 3291.0 ± 0.52 | 81% | 23% | Nephropathy negative |
| 353 | 1466 | 49.2 ± 3.70 | 3293.1 ± 0.43 | 91% | 14% | Nephropathy negative |
| 354 | 3968 | 49.9 ± 3.57 | 3315.0 ± 0.45 | 67% | 5% | Nephropathy negative |
| 355 | 3969 | 43.3 ± 2.04 | 3319.9 ± 0.66 | 86% | 23% | Nephropathy negative |
| 356 | 3976 | 49.1 ± 3.35 | 3336.7 ± 0.38 | 63% | 9% | Nephropathy negative |
| 357 | 1486 | 38.5 ± 2.05 | 3359.9 ± 0.42 | 98% | 41% | Nephropathy negative |
| 358 | 1491 | 38.5 ± 1.92 | 3360.1 ± 0.65 | 98% | 20% | Nephropathy negative |
| 359 | 1505 | 38.5 ± 2.03 | 3417.1 ± 0.48 | 95% | 45% | Nephropathy negative |
| 360 | 1510 | 38.5 ± 1.09 | 3433.3 ± 0.43 | 92% | 41% | Nephropathy negative |
| 361 | 1525 | 51.6 ± 3.50 | 3478.9 ± 0.48 | 74% | 5% | Nephropathy negative |
| 362 | 1558 | 31.7 ± 2.29 | 3589.7 ± 0.48 | 73% | 18% | Nephropathy negative |
| 363 | 1570 | 33.2 ± 3.71 | 3633.4 ± 0.95 | 80% | 18% | Nephropathy negative |
| 364 | 1571 | 36.0 ± 3.18 | 3636.6 ± 0.73 | 58% | 0% | Nephropathy negative |
| 365 | 1597 | 37.9 ± 2.69 | 3719.5 ± 0.61 | 67% | 9% | Nephropathy negative |
| 366 | 1603 | 42.0 ± 3.21 | 3739.7 ± 0.99 | 73% | 14% | Nephropathy negative |
| 367 | 1659 | 25.8 ± 1.20 | 3947.3 ± 0.67 | 92% | 32% | Nephropathy negative |
| 368 | 4169 | 39.4 ± 1.13 | 4006.6 ± 0.49 | 62% | 5% | Nephropathy negative |
| 369 | 1685 | 26.0 ± 3.97 | 4044.9 ± 0.56 | 78% | 14% | Nephropathy negative |
| 370 | 1693 | 30.5 ± 2.17 | 4070.4 ± 0.48 | 57% | 5% | Nephropathy negative |
| 371 | 1701 | 29.5 ± 0.93 | 4098.6 ± 0.52 | 86% | 32% | Nephropathy negative |
| 372 | 1702 | 34.3 ± 2.08 | 4102.5 ± 0.50 | 77% | 14% | Nephropathy negative |
| 373 | 1747 | 34.7 ± 0.63 | 4290.7 ± 0.52 | 76% | 18% | Nephropathy negative |
| 374 | 1771 | 23.5 ± 1.61 | 4405.8 ± 0.54 | 51% | 0% | Nephropathy negative |
| 375 | 1841 | 30.4 ± 1.31 | 4801.5 ± 1.06 | 65% | 0% | Nephropathy negative |
| 376 | 1856 | 32.4 ± 1.31 | 4863.8 ± 0.64 | 67% | 5% | Nephropathy negative |
| 377 | 1909 | 29.5 ± 2.25 | 5214.0 ± 1.29 | 51% | 0% | Nephropathy negative |
| 378 | 1994 | 33.0 ± 0.99 | 6172.0 ± 1.57 | 65% | 0% | Nephropathy negative |
| 379 | 2039 | 33.2 ± 0.75 | 6187.8 ± 0.75 | 95% | 45% | Nephropathy negative |
| 380 | 2292 | 23.8 ± 1.86 | 9869.7 ± 1.06 | 69% | 14% | Nephropathy negative |
